(19) United States
(12) Patent Application Publication
(10) Pub. No.: US 2024/0049749 A1
(43) Pub. Date: Feb. 15, 2024

(54) PLANT-BASED CONNECTIVE TISSUE ANALOGS

(71) Applicant: Motif Foodworks, Inc., Boston, MA (US)

(72) Inventor: STEFAN BAIER, Boston, MA (US)

(21) Appl. No.: 18/270,642

(22) PCT Filed: Dec. 31, 2021
(86) PCT No.: PCT/US21/65833

§ 371 Date: Jun. 30, 2023

Related U.S. Application Data
(60) Provisional application No. 63/133,055, filed on Dec. 31, 2020.

(51) Int. Cl. A23J 3/22; A23L 33/185; A23L 33/21; A23L 29/206

(52) U.S. Cl. CPC A23J 3/227; A23L 33/185; A23L 33/21; A23L 29/206

(57) ABSTRACT

The present disclosure provides plant-based connective tissue analogs, plant-based meat substitutes containing them, and methods of making them without relying on extrusion or fiber spinning The disclosed connective tissue analogs mimic the texture, chewiness, and mouthfeel of naturally occurring connective tissue found in meat and can be combined with other plant-based compositions to provide an authentic meat-like texture and mouthfeel in plant-based meat substitutes.

### CROSS-REFERENCE TO RELATED APPLICATION

This application claims the benefit of U.S. Provisional Application No. 63/133,055, filed Dec. 31, 2020 the disclosure of which is hereby incorporated by reference in its entirety.

### FIELD OF THE INVENTION

The present disclosure relates generally to plant-based food compositions and products, and related methods of making and using them. Additionally, the present disclosure relates to compositions and methods of making plant-based connective tissue analogs that can be incorporated into these plant-based food compositions.

### BACKGROUND OF THE INVENTION

Plant-based food products and compositions as alternatives to animal food products have drawn great attention and research interest over the past two decades. The market has recently been driven by multiple factors such as the growing global interest in vegan and vegetarian diets for health and environmental reasons. Most options for plant-based meat substitutes are homogeneous compositions made by extruding plant materials, such as soy, vegetables, or grains. In contrast to their animal-derived counterparts, plant-based meat substitutes are less satisfying to eat because they do not convincingly reproduce the texture, mouthfeel, chewing experience and appearance of real animal meat. Plant-based meat substitutes lack these desirable qualities at least in part because they lack connective tissue components, such as perimysium.

A need exists for plant-based meat-like connective tissue analogs/mimics, to provide a more authentically meat-like appearance, flavor, texture, mouthfeel and chewing experience. Currently available connective tissue analogs are produced using spun protein fibers and use extrusion processes. These methods are tedious, hard to scale up and do not recapitulate the desirable texture of connective tissues. There is therefore a need to develop alternates to these processes and connective tissue analogs. A related need exists for products incorporating such analogs, and methods of making the analogs and related plant-based meat substitutes containing them.

### SUMMARY OF THE INVENTION

In one aspect, the present disclosure encompasses a method of preparing a connective tissue analog. The method comprises the steps of combining ingredients comprising a hydrocolloid base and a dietary fiber additive to form a substantially homogenous mixture; hydrating the substantially homogenous mixture to form a hydrated gel; and at least partially dehydrating the gel to obtain an at least partially dehydrated gel comprising a non-covalently cross-linked polymer network , thereby forming the connective tissue analog. The method may further comprise combining at least one of a protein, a crosslinking agent, a flavoring agent, a dietary fat, or a combination thereof with the hydrocolloid base and dietary fiber additive. In one aspect of the method, the at least partially dehydrated gel is rehydrated. Rehydration of the gel can be performed before, or because of, combining the gel with a plant-based meat-like base as described further below, to form a meat analog composition.

In a method of preparing a connective tissue analog, the hydrated gel may be cast into a sheet form, block form and/or may be comminuted to form gel particles. The gel particles may be comminuted to form the gel before or after dehydrating the gel. Comminuting may comprise grinding, milling, rolling, chopping, cutting, pulverizing, breaking, pounding, abrading, rasping or any combination thereof. The gel particles may have an average width or average diameter of about 0.1 to about 10 mm, about 0.2 mm to about 10 mm, about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.5 mm, about 0.1 to about 0.3 mm, about 0.5 to about 2 mm, about 0.75 to about 2 mm, about 0.75 to about 2.5 mm, about 0.75 to about 3 mm, about 1 mm to about 2 mm, about 2 mm to about 3 mm, about 3 mm to about 4 mm, about 4 mm to about 5 mm, about 5 mm to about 6 mm, about 6 mm to about 7 mm, about 7 mm to about 8 mm, about 8 mm to about 9 mm, about 9 mm to about 10 mm, less than about 10 mm, less than about 9 mm, less than about 8 mm, less than about 7 mm, less than about 6 mm, less than about 5 mm, less than about 4 mm, less than about 3 mm, less than about 2 mm, less than about 1.5 mm, less than about 1 mm, less than about 0.5 mm, about 0.25 mm. about 0.5 mm, about 0.75 mm, about 1 mm, about 1.25 mm, about 1.5 mm, about 1.75 mm, about 2 mm, about 2.5 mm, about 3 mm, about 4 mm, about 5 mm, about 6 mm, about 7 mm, about 8 mm, about 9 mm, or about 10 mm.

In one aspect of a method of preparing a connective tissue analog, the hydrating of the substantially homogeneous mixture of the hydrocolloid base and a dietary fiber additive may comprise adding a hydration agent, mixing, heating, cooling, setting, or any combination thereof. The hydration agent may be water, steam, a buffered water, a non-aqueous solvent, a gelling agent, or any combination thereof. The gelling agent may comprise an inorganic ion, an organic ion, a crosslinking agent, a sugar, a salt, an acid, a base, or any combination thereof.

In another aspect of a method of preparing a connective tissue analog, the dehydrating may comprise subjecting the hydrated gel to a dehydration condition for a time sufficient to achieve about 10% up to about 100% dehydration of the gel. The dehydrating may comprise placing the hydrated gel in an oven, a dryer, a microwave oven, a freeze dryer, a smoker, a stove, a range, a desiccator, or any combination thereof. In one aspect, the dehydrating comprises subjecting the hydrated gel to convective drying in a temperature range from about 40° C. to about 50° C., and for a time period of about 4 hours to about 24 hours.

Another aspect of the methods described herein is that they can be performed devoid of extrusion. In another aspect of the method, the substantially homogenous mixture in the methods is substantially devoid of any spun protein fibers.

In another aspect of a method of preparing a connective tissue analog, the hydrocolloid base may comprise a carrageenan, carrageenan, agar-agar, pectin, alginate, gellan gum, glucomannan, a modified starch, methyl cellulose, hydroxypropyl methyl cellulose, carboxymethyl cellulose, methyl cellulose, gelatin, guar gum, locust bean gum, tara gum, gum tragacanth, gum ghatt, gum Arabic, analogs or derivatives thereof, or any combination thereof.

In another aspect of the methods, the connective tissue obtained upon rehydrating the at least partially dehydrated gel, exhibits rheological properties with a storage modulus (G′) which is greater than the loss modulus (G″) across a linear viscoelastic region and with G′ and G″ increasing with decreasing gaps and/or decreasing water content. The connective tissue obtained by the method in some aspects upon rehydrating the at least partially dehydrated gel exhibit hydrogel-like mechanical properties. In some aspects the connective tissue obtained by the method upon rehydrating the at least partially dehydrated gel, has a Young's modulus ranging from about 50 kPa to about 500 kPa and demonstrates hydrogel-like mechanical properties outlined herein.

In yet another aspect of a method of preparing a connective tissue analog, the dietary fiber additive may comprise one or more of structured polysaccharides, non-structured polysaccharides, structural non-polysaccharides and/or biopolymers. Some examples include but are not limited to glucomannan, guar gum, gum Arabic, xanthan gum, a psyllium, a chitin, an inulin, a pectin, a dextrin, a starch, a cellulose, a hemicellulose, a lignin, a citrus fiber extract, analogs or derivatives thereof, or any combination thereof. In some aspect the dietary fiber additive is water soluble. In some aspect the dietary fiber additive is not water soluble.

In still another aspect of a method of preparing a connective tissue analog, the ingredients comprise in weight ratio: 10 parts hydrocolloid base such as but not limited to a carrageenan, and 2 parts dietary fiber additive. The 2 parts dietary fiber additive may comprise 1 part of a first dietary fiber additive and 1 part of a second dietary fiber additive, such as by way of non-limiting example, 1 part glucomannan, and 1 part gum Arabic.

In yet another aspect of a method of preparing a connective tissue analog, the ingredients may further comprise a protein. The protein may be derived from wheat, pea, soy, potato, chickpea, rice, corn, bean, sorghum, quinoa, vegetables, fruits, seaweed, bacteria, yeast, mushrooms, any flour thereof, or any combination thereof.

In still another aspect of a method of preparing a connective tissue analog, the ingredients further comprise a crosslinking agent. The crosslinking agent may comprise a dietary enzyme, a transglutaminase, a laccase, or any combination thereof.

In still another aspect of a method of preparing a connective tissue analog comprising a protein, the ingredients are combined in a weight ratio of 1-20 parts protein, 0.1-10 parts hydrocolloid base such as, but not limited to a carrageenan, and 0.1-10 part dietary fiber additive such as but not limited to gum Arabic or glucomannan.

Another aspect of the present disclosure encompasses a connective tissue analog obtained from any of the disclosed preparation methods for a connective tissue analog as described herein. A connective tissue analog may include only ingredients suitable for human or animal consumption and be devoid of ingredients unsuitable for human or animal consumption. The connective tissue analog composition may for example also be devoid of any animal-derived tissue or cells. A connective tissue analog composition may comprise an at least partially dehydrated and comminuted gel obtained by dehydrating a gel formed from the hydration and then dehydration of a substantially homogeneous mixture of any hydrocolloid base and any dietary fiber additive as disclosed herein. The at least partially dehydrated and comminuted gel may be in the form of gel particles. The gel particles may have an average width or diameter in a range from about 0.5 mm to about 3.0 mm, or any particle size disclosed herein. The at least partially dehydrated and comminuted gel may comprise, in non-limiting example, a carrageenan, glucomannan, and gum Arabic. These ingredients may be present, for example, in weight ratio: 1-10 parts carrageenan, 0.1-10 part glucomannan, and 0.1-10 part gum Arabic.

The connective tissue analog composition may further comprise a protein, a crosslinking agent, a flavoring agent, a dietary fat, or any combination thereof, as disclosed herein. The protein may be any protein, such as but not limited to soy protein, pea protein, rice protein, or any combination thereof. A crosslinking agent may comprise a dietary enzyme, a transglutaminase, a laccase, or a combination thereof. In one aspect, a connective tissue analog composition comprises a protein, a carrageenan, and gum Arabic. In some aspect a connective tissue analog composition may comprise a protein, a carrageenan, glucomannan. In some other aspect the connective tissue analog composition may comprise a protein, a carrageenan, glucomannan and gum Arabic. A connective tissue analog composition may comprise, in non-limiting example, rice protein, kappa-carrageenan, and glucomannan. In yet another aspect, a connective tissue analog composition comprises, in weight ratio: 1-20 parts protein, 0.1-10 part any carrageenan, and optionally 0.1-10 part gum Arabic and optionally 0.1-10 part glucomannan.

In another aspect, a connective tissue analog composition as disclosed herein is substantially devoid of spun protein fibers, and/or devoid of extruded gel.

In another aspect, the present disclosure encompasses a method of preparing a meat analog composition for human or animal consumption. The method comprises obtaining a connective tissue analog comprising an at least partially dehydrated and comminuted gel obtained by hydration of a substantially homogeneous mixture comprising a hydrocolloid base and a dietary fiber additive, followed by at least partial dehydration of the gel, and combining the resulting connective tissue analog with a plant-based meat formulation to form the meat analog composition. In one aspect, both the connective tissue analog and the plant-based meat-like base are devoid of any animal tissues or cells. In another aspect, the connective tissue analog and/or the plant-based meat-like base further comprise a protein, a crosslinking agent, a flavoring agent, a dietary fat, or any combination thereof. In the meat analog composition, the connective tissue analog may contribute about 0.5 wt % to about 3 wt % of meat analog composition. The combining of the connective tissue analog with the plant-based meat-like base may further comprise at least partially rehydrating the at least partially dehydrated gel forming the connective tissue analog, in the plant-based meat—like base. In yet another aspect, the method of preparing the meat analog may comprise at least partially rehydrating the gel forming the connective tissue analog before combining the connective tissue analog with the plant-based meat-like base. In the method of preparing a meat analog, the connective tissue analog may comprise any of the ingredients, in any weight ratio as disclosed herein. The connective tissue analog may take any of the forms or particle sizes as disclosed herein.

Still another aspect of the present disclosure encompasses a meat analog comprising a connective tissue analog, wherein the meat analog is prepared by any of the methods disclosed herein.

In another aspect, the present disclosure encompasses a meat analog composition for human or animal consumption, which comprises a plant-based meat-like base and connective tissue analog. The connective tissue analog may be any of the connective tissue analogs described herein, made by any method described herein.

Yet another aspect of the present disclosure encompasses a meat analog composition for human or animal consumption, comprising a plant-based meat-like base and any connective tissue analog as disclosed herein, made by any method as disclosed herein.

Another aspect of the present disclosure encompasses a plant-based connective tissue cartilage-like or connective tissue perimysium-like analog comprising, in weight ratio, 1-10 parts kappa-carrageenan, 0.1-10 part glucomannan and 0.1-10 part gum Arabic. In some particular aspect the connective tissue cartilage-like or connective tissue perimysium-like analog may comprise 1 part kappa carrageenan, 0.1 part glucomannan and 0.1 part gum Arabic. Another aspect of the present disclosure is a plant-based connective tissue elastin-like analog comprising, in weight ratio, 1-20 parts protein, 0.1-10 part carrageenan, and 0.1-10 part of gum Arabic; wherein the protein is soy protein, pea protein, or a mixture of soy protein and pea protein. In some aspect the elastin-like analog may comprise 20 parts pea or soy protein or combination thereof, 1 part carrageenan and 1 part gum Arabic. Another aspect of the present disclosure is a plant-based connective tissue tendon-like analog comprising, in weight ratio, 1-20 part rice protein, 0.1-1 part carrageenan, 0.1-1 part glucomannan. In some aspect the tendon-like analog may comprise 1 part each of carrageenan, rice protein and konjac glucomannan. The rice protein may comprise a protein selected from the group consisting of Oryzatein 80, Oryzatein Silk 80, Oryzatein Silk 90, and any combinations thereof. In yet another aspect, the plant-based cartilage or perimysium analog, the plant-based connective tissue elastin-like analog, or the plant-based tendon analog, each is in particle form. In one aspect, the particles have an average maximum diameter of about 2.0 mm, about 2.5 mm, or about 3.0 mm.

Yet another aspect of the present disclosure encompasses a meat analog composition comprising particles of any plant-based cartilage, perimysium, elastin or tendon analog as disclosed herein, wherein the particles are incorporated in a plant-based meat-like base. In some aspects the meat analog may comprise about 0.5-3% plant based connective tissue.

In another aspect, any meat analog composition disclosed herein may take the form of a burger patty, ground meat, meatball, sausage, meat jerky, bacon or hot-dog analogous to meat containing products in market. In any of the plant-based connective tissue analogs, including any cartilage-like, perimysium-like or elastin-like analog as described herein, the analog may have a Young's modulus ranging from about 50 kPa to about 500 kPa and demonstrate hydrogel-like mechanical and rheological properties outlined herein.

### BRIEF DESCRIPTION OF THE FIGURES

FIG. 1 illustrates the general process and steps of making the connective tissue analogs.

FIG. 2 are photos taken during the process of making elastin-type connective tissue analog and the final meat analog in the form of a burger patty. The elastin-type connective tissue analog made from soy protein, carrageenan, and gum Arabic. The photos include microscope pictures of the surface and the internal parts of the analogs to provide details.

FIG. 3 are photos taken during the process of making elastin-type connective tissue analog and the final meat analog in the form of a burger patty. The elastin-type connective tissue analog made from pea protein, carrageenan, and gum Arabic. The photos include microscope pictures of the surface and the internal parts of the analogs to provide details.

FIG. 4 are photos taken during the process of making collagen-type connective tissue analog and the final meat analog in the form of a burger patty. The collagen-type connective tissue analog made from using carrageenan, glucomannan, and gum Arabic. The photos include microscope pictures of the surface and the internal parts of the analogs to provide details.

FIG. 5 are photos taken during the process of making perimysium-type connective tissue analog and the final meat analog in the form of a burger patty. The perimysium-type connective tissue analog made from using carrageenan, glucomannan, and gum Arabic. The photos include microscope pictures of the surface and the internal part of the analogs to provide details.

FIG. 6 shows the custom-made compression measurement rig setup, designed to simultaneously measure force and distance using the calipers.

FIG. 7 are the photos of samples (5 each) used in comparison test, and later measured for compression force.

FIG. 8A is a plot comparing results of compression force measurements for plant-based cartilage and the cartilage from real beef in a sample size of 5 mm×5 mm. Data from all replicates are combined and a trend-line is drawn for each sample.

FIG. 8B is a plot comparing results of compression force measurements for plant-based perimysium and perimysium from real beef in a sample size of 5 mm×5 mm. Data from all replicates are combined and a trend-line is drawn for each sample.

FIG. 8C is a plot comparing results of compression force measurements for plant-based tendon and tendon from real beef in a sample size of 5 mm×5 mm. Data from all replicates are combined and a trend-line is drawn for each sample.

FIG. 9 are photos of particles of tendon analogs, obtained after sifting through a 0.75 mm mesh and a 3.0 mm mesh, sequentially.

FIG. 10 are photos of cartilage analogs with maximum sizes of 2.0 mm and 2.5 mm, and the final burger patty analogs obtained by combining these cartilage analogs into commercially available plant-based meat-like patties.

FIG. 11 are photos of meshes with different pore sizes, and the perimysium analogs obtained after sifting through these meshes.

FIG. 12 are photos of perimysium analog samples with sizes between 0.75 to 1.5 mm, between 0.75 to 2.0 mm, and between 0.75 mm to 2.5 mm, as well as the pictures of the burger patty analogs obtained by combining these perimysium analogs into commercially available plant-based meat-like patties.

FIG. 13 are photos of tendon analog samples with sizes between 0.75 to 1.5 mm, between 0.75 to 2.0 mm, and between 0.75 mm to 2.5 mm, as well as the pictures of the final burger patty analogs obtained by combining these tendon analogs into commercially available plant-based meat-like patties.

FIG. 14 are photos of tendon analogs made from rice protein Original 80 (Conventional Oryzatein® 80, Oryzatein® Silk 80 and Oryzatein® Silk 90 respectively, and the pictures of the final burger patty analogs obtained by combining these tendon analogs into commercially available plant-based meat-like patties.

FIG. 15 is an illustrated flow diagram of the bulk gel dehydration/rehydration procedure for the three exemplary connective tissue analogs.

FIG. 16 is a series of photographs taken at different time points (T) in the rehydration process for bench-scale connective tissue samples. In each photograph, the samples from left to right respectively, correspond to the cartilage analog, the perimysium analog and the tendon analog of connective tissues.

FIG. 17 is a graph of the log average rehydration % from original versus log time (min) for each of three plant based connective tissue samples (PBCT): cartilage (♦) perimysium (▪) and tendon (▴) made at bench scale. The rehydration follows a power law distribution as seen in the plot.

FIG. 18A is a plot of the results from constant speed compression experiments on rehydrated plant based connective tissues.

FIG. 18B is a plot of tensile strength characteristics of the rehydrated plant based connective tissues.

FIG. 19 is a series of photographs showing the Intron testing machine and results of compression experiments. The left-most photograph shows the apparatus stage From right to left, the photographs show resulting deformation of samples when subjected to slow (upper row at 0.1 mm/s) and fast (bottom row at 50 mm/s) compression for, respectively cartilage, perimysium and tendon analogs samples.

FIG. 20A is a plot of the results from constant speed compression experiments conducted on fresh bench-scale cartilage, perimysium and tendon analog gels and shown as compressive stress versus strain curves.

FIG. 20B is a plot of the results of constant speed compression experiments conducted on dehydrated/rehydrated bench-scale cartilage, perimysium and tendon analog gels and shown as compressive stress versus strain curves.

FIG. 20C is a plot of the results of constant speed compression experiments conducted on fresh pilot-scale cartilage, perimysium and tendon analog gels and shown as compressive stress versus strain curves.

FIG. 20D is a plot of the results of constant speed compression experiments conducted on dehydrated/rehydrated pilot-scale cartilage, perimysium and tendon analog gels and shown as compressive stress versus strain curves.

FIG. 21(A) shows the Instron compression set-up with oil coated platens.

FIG. 21(B) is a plot of the results of constant rate compression experiments conducted on bench-scale fresh gels when the platen shown in FIG. 21(A) is lubricated with oil and depicted as compressive stress versus strain curves. In the Figure, A refers to strain rate of 6.67%/s with oil, B refers to a strain rate of 12.12%/s with oil and C refers to strain of 6.67%/s with sandpaper.

FIG. 22A are the results of low-speed compression test experiments conducted on the three exemplary PBCTs at 85% H₂O depicted as compressive stress vs compressive strain plots.

FIG. 22B are the results of low-speed compression test experiments conducted on the three exemplary PBCTs at 75% H₂O depicted as compressive stress vs compressive strain plots.

FIG. 22C are the results of low-speed compression test experiments conducted on the three exemplary PBCTs at 65% H₂O depicted as compressive stress vs compressive strain plots.

FIG. 22D are the results of low-speed compression test experiments conducted on tendon connective tissue analogs at 85% H₂O, 75% H₂O, 65% H₂O and on beef tendon and depicted as compressive stress vs compressive strain plots.

FIG. 23(A) is a photograph of a “dog bone” shaped sample used for studying the tensile strength of the exemplary PBCT at three different levels of hydration.

FIG. 23(B) shows the set-up for Instron 5900R 5584 with a 100N load cell and manual grip attachment, used for measuring the tensile strength of the exemplary PBCT.

FIG. 24A is a plot of results of tensile strength tests depicted as tensile stress versus tensile strain curves of the three exemplary PBCTs—cartilage, perimysium and tendon, at a hydration level of 85% H₂O.

FIG. 24B is a plot of results of tensile strength tests depicted as tensile stress versus tensile strain curves of the three exemplary PBCTs—cartilage, perimysium and tendon, at a hydration level of 75% H₂O.

FIG. 24C is a plot of results of tensile strength tests depicted as tensile stress versus tensile strain curves of the three exemplary PBCTs—cartilage, perimysium and tendon, at a hydration level of 65% H₂O.

FIG. 25A is the graphical representation of rheological characterization data for fresh samples of the three exemplary PBCTs—cartilage, perimysium and tendon with amplitude sweeps spanning from 0.1 to 10% shear strain.

FIG. 25B is the graphical representation of rheological characterization data for dehydrated and rehydrated samples of the three exemplary PBCTs—cartilage, perimysium and tendon with amplitude sweeps spanning from 0.1 to 10% shear strain.

FIG. 26A are the rheological fingerprints of the three exemplary PBCTs—cartilage, perimysium, and tendon, before dehydration (fresh sample) at 16% shear strain.

FIG. 26B are the rheological fingerprints of the three exemplary PBCTs—cartilage, perimysium, and tendon, after dehydration and rehydration at 16% shear strain.

FIG. 26C are the rheological fingerprints of the three exemplary PBCTs—cartilage, perimysium, and tendon, before dehydration at 25% shear strain.

FIG. 26D are the rheological fingerprints of the three exemplary PBCTs—cartilage, perimysium, and tendon, after dehydration and rehydration at 25% shear strain.

FIG. 26E are the rheological fingerprints of the three exemplary PBCTs—cartilage, perimysium, and tendon, before dehydration at 40% shear strain.

FIG. 26F are the rheological fingerprints of the three exemplary PBCTs—cartilage, perimysium, and tendon, after dehydration and rehydration at 40% shear strain.

FIG. 27A is the graphical representation of rheological characterization data before dehydration of the three exemplary PBCTs—cartilage, perimysium and tendon with temperature sweep spanning from 25° C. to 75° C. (heating).

FIG. 27B is the graphical representation of rheological characterization data for dehydrated and rehydrated samples of the three exemplary PBCTs—cartilage, perimysium and tendon with temperature sweep spanning from 75° C. to 25° C. (cooling).

FIG. 27C is the graphical representation of rheological characterization data for dehydrated and rehydrated samples of the three exemplary PBCTs—cartilage, perimysium and tendon with temperature sweep spanning from 25° C. to 75° C. (heating).

FIG. 27D is the graphical representation of rheological characterization data for dehydrated and rehydrated samples of the three exemplary PBCTs—cartilage, perimysium and tendon with temperature sweep spanning from 75° C. to 25° C. (cooling).

FIG. 28A are Scanning Electron Micrographs for the dehydrated and fractured exemplary PBCTs at 3000×.

FIG. 28B are Scanning Electron Micrographs for the dehydrated and fractured exemplary PBCTs at 10,000×.

FIG. 28C are Scanning Electron Micrographs for the dehydrated and fractured exemplary PBCTs at 30,000×.

FIG. 29A is a schematic showing the set-up for obtaining uniform thickness samples of PBCTs.

FIG. 30A are plots of the storage and loss compliances for the first and third harmonics as a function of the shear stress amplitude for PBCT perimysium.

FIG. 30B are plots of the storage and loss compliances for the first and third harmonics as a function of the shear stress amplitude for PBCT cartilage.

FIG. 30C are plots of the storage and loss compliances for the first and third harmonics as a function of the shear stress amplitude for PBCT tendon.

FIG. 30D are plots of the storage and loss compliances for the first harmonic highlighting how the first harmonic plot can be used to distinguish the three PBCTs.

FIG. 31 is a plot of the distortion ratio as a function of the rotation ratio for the three PBCTs, the inset shows the values of D as a function of R in a log-log scale.

FIG. 32A is a plot of stress versus strain to quantify plastic stress contributions for PBCT analog cartilage.

FIG. 32B is a plot of stress versus strain to quantify plastic stress contributions for PBCT analog perimysium.

FIG. 32C is a plot of stress versus strain to quantify plastic stress contributions for PBCT analog tendon.

FIG. 33 is a series of photographs of PBCTs pre- and post-hydration.

### DETAILED DESCRIPTION

The present disclosure is based in part on the surprising discovery that a dehydrated gel comprising a non-covalently interconnected polymer network of a hydrocolloid base and a dietary fiber additive is a highly convincing connective tissue analog for use in plant-based meat analogs. The connective tissue analogs described herein authentically mimic the performance and qualities of animal connective tissue in real meat products, in terms of the consumer's eating experience. The connective tissue analog compositions described herein encompass for example, perimysium, cartilage, and tendon analogs, and exhibit an appearance, texture, mouthfeel, and chewiness similar to those of animal-derived perimysium, cartilage, and tendon found in real meat products As such, when combined with a plant-based meat-like base, the connective tissue analogs described herein produce an unexpectedly authentic meat-like product. Further, in notable contrast to conventional methods of preparing plant-based meat substitutes or components thereof, the disclosed methods do not rely on an extrusion process. Put differently, the disclosed methods may be devoid of any extrusion or micro-extrusion step. Still further, the connective tissue analogs can be made substantially devoid of spun fibers, such as spun protein fibers

Thus, in one aspect the present disclosure encompasses a method of preparing a connective tissue analog which comprises: combining a hydrocolloid base and a dietary fiber additive to form a substantially homogenous mixture forming a gel base; hydrating the gel base to form a hydrated gel; and at least partially dehydrating the hydrated gel to obtain an at least partially dehydrated gel comprising a non-covalently cross-linked polymer network, thereby forming the connective tissue analog. The method thus includes but is not limited to, combining ingredients as described in detail below, hydrating the combination to form a gel, and at least partially dehydrating the gel. The resulting gel product can then be cast to form a sheet, and/or comminuted to form particles of various sizes as described below and illustrated in the examples.

In another aspect, the present disclosure provides a connective tissue analog compositions comprising one or more hydrocolloid bases, and one or more plant-based dietary fiber additives, which are combined, hydrated, and then at least partially dehydrated to produce a gel comprising a non-covalently cross-linked polymer network. The connective tissue analogs optionally may further comprise additional ingredients such as proteins, crosslinking agents, flavoring agents, texturizing agents, dietary fats, oils, preservatives, antioxidants, colorants, or any combination thereof. The connective tissue analog compositions may be substantially or completely devoid of spun fibers.

### I. Ingredients

The ingredients used in connective tissue analogs comprise at least a hydrocolloid base and a dietary fiber additive. The ingredients may also include other compounds, such as proteins, crosslinkers, flavoring agents, dietary fats, oils, preservatives, antioxidants, colorants, or any combination thereof. Suitable ingredients used in connective tissue analogs may be isolated or derived from plants, yeasts, bacteria, or any combination thereof, or may be synthetic. Ingredients used in connective tissue analogs may be substantially or completely devoid of any animal tissues or cells, including being devoid of any animal organs, pieces or parts, or animal blood, or any ingredients derived therefrom. In an alternative aspect, an ingredient may however be isolated or derived from animal eggs or milks. Such ingredients include, by way of non-limiting example, ovalbumin, casein, whey, or other proteins or fats obtained from eggs or milk.

The term “plant-based ingredient” as used herein refers to any ingredient that is isolated or derived from a plant source, or that is recombinantly produced in a microbial expression system such as in a yeast or bacteria expression system. In one aspect, the connective tissue analogs contain only plant-based ingredients. Suitable plant sources from which ingredients may be isolated or derived include but are not limited to, fruits, vegetables, nuts, seeds, oils, grains, wheats, legumes, beans, peas, and other edible materials obtained from plant leaves, flowers, roots, barks, and branches. The disclosure also expressly contemplates plant-based ingredients obtained from transgenic plants, i.e., genetically engineered plants containing one or more exogenous genes introduced into the genome, to create plants with new characteristics.

### Hydrocolloid and Hydrocolloid Base

A hydrocolloid is a substance like a polysaccharide or protein that can alter the rheology of a material and can form a gel in the presence of water. The connective tissue analogs comprise one or more hydrocolloids. When more than one hydrocolloid is used to form the hydrocolloid base, the relative amounts of these different hydrocolloids may impact the mechanical properties of the resultant hydrocolloid base, such as making it more elastic, brittle, or compressible. While any hydrocolloid may be used, the hydrocolloids used herein are preferably of plant origin, and may include one or more of a carrageenan, agar-agar, pectin, alginate, gellan, glucomannan, starch, modified starch, methyl cellulose, hydroxypropyl methyl cellulose, gelatin, or a combination thereof. The term “a carrageenan” encompasses but is not limited to kappa-carrageenan, iota-carrageenan, lambda-carrageenan, and any combination thereof. Glucomannan as used herein is a water-soluble polysaccharide and encompasses glucomannan from any plant source including Konjac. Konjac is currently the more widely used source of glucomannan.

In one aspect, the hydrocolloid base may include one or more additional hydrocolloids, which may comprise carboxymethyl cellulose, methyl cellulose and hydroxypropyl methyl cellulose, guar gum, locust bean gum, tara gum, glucomannan, gum tragacanth, gum ghatt, gum Arabic, gellan gum or combinations thereof. In another aspect of the instant disclosure, any of the one or more hydrocolloid bases may be included as one or more additional hydrocolloids. In some other aspect, any of the one or more additional hydrocolloids may be included as the one or more hydrocolloid bases.

### Diery Fiber Additive

The dietary fiber additive can be of either plant or animal origin, including from a transgenic plant or animal. Animal fiber, mainly in the form of muscle fibers, are made of myofibrils. Plant-based fiber comprises various polysaccharides and lignins, which are resistant to enzymatic digestion of human being or animals. Any fiber can be used as the dietary fiber additive, but in an exemplary aspect the dietary fiber additive is of plant origin. The dietary fiber additive may comprise a polysaccharide or biopolymer such as but not limited to fibers derived from plants or transgenic plants, or plant products, such as from fruits, vegetables, grains, roots, barks, trunks, branches, leaves, nuts, and seeds. Examples include, but are not limited to, fibers derived from legumes (peas, soybeans, and other beans), oats, corn, rye, rice and barley, fruits such as apples, plums, and berries (e.g., strawberries, raspberries, and blackberries), and vegetables such as broccoli, carrots, green beans, cauliflower, zucchini, celery, potatoes, sweet potatoes, psyllium seed husk, oat bran, wheat bran and beet pulp, cellulose, sugar cane-based fibers. Fiber may comprise glucomannan (konjac), guar gum, gum Arabic, xanthan gum, gellan gum, psyllium, chitin, inulin, pectin, dextrin, starches, celluloses, hemicelluloses, lignins, citrus fiber extracts, or any combination thereof.

### Substantially Homogenous Mixture of Hydrocolloid and Dietary Fiber Additive

The hydrocolloid base and dietary fiber additive are combined to form a substantially homogeneous mixture. A substantially homogenous mixture is achieved wherein two or more ingredients or constituents are sufficiently mixed to form a composition such that multiple samples taken from different portions of the composition are substantially uniform in appearance and composition. The degree of homogeneity may be determined using methods commonly used in the art, as simple as visual inspection to determine when two ingredients have been sufficiently mixed so as not to show any obvious discontinuities in the texture or appearance of the mixture. Alternatively, or in addition, sieving or laser diffraction inspection of multiple samples can be used. In one aspect, the term “substantially homogenous mixture” indicates the homogeneity may not be less than about 90% in the mixture, or at least 90%, 91%, 92%, 93%, 94%, 95%, 96%, 97%, 98%, 99%, 99.5% or 100% homogeneity. In a substantially homogeneous mixture, the ingredients or constituents may be substantially evenly distributed throughout the mixture, either in their original physical or chemical states, or in modified physical and/or chemical states resulted from interactions among ingredients. The interactions among ingredients may comprise a van der Waals interaction, a dispersion interaction, a dipole-dipole interaction, a hydrogen-bonding interaction, a crosslinking interaction, or any combinations thereof. The ingredients or constituents used to form the substantially homogenous mixture may be in a dry state (less than about 5% water content), semi-dry state (about 5% to about 70% hydration), or a hydrated state (about 70% to about 100% hydration). The substantially homogenous mixture of the present disclosure may be achieved through combining, mixing, stirring, blending, rotating, folding, or any other physical maneuvers.

In various specific aspects, the components of the gel base may comprise, by way of non-limiting examples, and in weight ratio: 10 parts carrageenan, 1 part glucomannan, and 1 part gum Arabic, all in dry state; or, 12 g kappa carrageenan, 1.2 g konjac, and 1.2 g gum Arabic; or 8 g kappa carrageenan, 0.8 g konjac, and 0.8 g gum Arabic; or 20 parts protein, 1 part carrageenan, and 1 part gum Arabic; or 10 g kappa carrageenan, 10 g konjac, and 10 g rice protein; or 1-20 parts protein, 1 part carrageenan, 1 part glucomannan, and 1 part gum Arabic.

### Proteins

In some aspects, the components of connective tissue analogs described herein (as well as the plant-based meat-like base combined with a connective tissue analog to prepare a meat analog) may include a protein. For preparing a connective tissue analog, the hydrocolloid and dietary fiber additive may be further combined with one or more proteins. The addition of protein(s) to may provide a desired nutritional profile, and/or alter the mechanical properties of the connective tissue analogs thus formed. A protein may comprise a food grade proteinaceous material isolated or derived from animal or plant sources. The protein may include an isolated protein, a protein fraction, a protein-containing material, or a combination thereof. Of particular relevance to the current disclosure are plant-based proteins, such as those isolated or derived from vegetables, nuts, peas, beans, seeds, barks, leaves, trunks, or fruits. In some aspects of the current disclosure, proteins used are isolated or derived from pea, soy, rice, potato, chickpea, corn, sorghum, quinoa, fruits, vegetables, seaweed, bacteria, yeast, mushroom, oats, wheat, and other grains. Alternatively, proteins from animal sources may be used and include, but are not limited to, raw or frozen meat (e.g., chicken, beef, pork, seafood, lamb, venison, duck, buffalo), meat meals (e.g., chicken meal, beef meal), meat by-product meals (e.g., beef liver meal, chicken liver meal), and mechanically deboned meat. Proteins used herein also include those from eggs or dairy products, such as egg yolk, egg whites, caseins, lactoglobulins, lactalbumins, ovalbumins, and whey proteins.

In a connective tissue analog including a protein, the protein may be a pea protein, a soy protein, a rice protein, or any combination thereof. These plant-based proteins are isolated from their plant sources and may optionally be further treated to remove allergens and other sensitivity-provoking components, and as such are FDA GRAS (Generally Recognized as Safe) or approved food additives. In yet another aspect, connective tissue analogs containing plant-based proteins may be further fortified with essential minerals and/or vitamins, thus having a nutritional profile similar to those of animal meat. In various aspects of the present disclosure, a connective tissue analog comprises commercially available plant-based protein such as any of AXIOM® Oryzatein® Rice Protein, AXIOM® Oryzatein® Silk 80, AXIOM® Oryzatein® Silk 90, AXIOM®VegOtein P™ Pea Protein, Puritan's Pride® Soy Protein Isolate, and Myvegan Soy Protein Isolate. A protein may comprise gluten. Gluten refers to the purified protein product yielded from the purification of proteins stored in the endosperms of certain grains, by washing away the associated starch. Typically, gluten comprises gliadin in a mixture with glutenin.

A suitable protein may be isolated from a genetically modified plant or obtained through biosynthesis or bio-expression systems involving yeast or bacteria. In other aspects, a heme protein may be an animal-derived myoglobin or hemoglobin, which can also be usefully produced by recombinant expression in a microbial system, such as in a yeast genetically engineered with the gene for an animal-derived myoglobin or hemoglobin

### Gelling Agents

The substantially homogeneous mixture optionally comprises a gelling agent. Alternatively, a gelling agent may be added in the step of hydrating the substantially homogeneous mixture. A gelling agent is a food ingredient used to thicken and stabilize food products. A gelling agent may comprise an inorganic ion, a metal ion, an organic ion, a sugar, a buffer agent, a salt, an acid, a base, a crosslinking agent, or any combinations thereof. The inclusion of the gelling agent may facilitate the transformation of the substantially homogeneous mixture into a three-dimensional inter-connective matrix comparable to the complex 3D structure in animal meat tissues.

Selection of the gelling agent depends on the ingredients in the substantially homogeneous mixture. For example, when the hydrocolloid base is pectin, a sugar may be used as the gelling agent. When konjac gum is part of the mixture, an alkaline buffer with pH over 9 may facilitate the gelling process.

A crosslinking agent is a chemical capable of facilitating the formation of bonds/links between different molecules. The crosslinking agent may be added to induce or catalyze the formation of the three-dimensional inter-connective matrix within the mixture. The crosslinker may be an organic acid, such as alginic acid or citric acid; an aldehyde, such as cinnamic aldehyde or glutaraldehyde; a phenol compound, such as tannic acid, gallic acid or ferulic acid; or a dietary enzyme, such as a transglutaminase or a laccase. On the other hand, the crosslinking agent may not be necessary, as crosslinking can be achieved through hydration, gelling and other processes described herein, devoid of any crosslinking agent.

### Other Ingredients

The connective tissue analog may also comprise other ingredients, such as a flavoring agent, a dietary fat, a colorant, a pH modifier, a preservative, a dispersant, or anything beneficial for the mixture thus formed.

A flavoring agent is a food ingredient to impart aroma or taste to the food. In one aspect, the flavoring agent may be a natural flavoring agent, such as those isolated, extracted or derived from plants, herbs, spices, nuts, fruits, vegetables, animals, or microbial fermentations. Essential oils and oleoresins are two examples of natural flavorings. In another aspect, the flavoring agent may be a synthetic chemical flavor that imitate natural flavors. Some examples of the synthetic flavoring agents include alcohols that have a bitter and medicinal taste, esters render fruity taste, ketones and pyrazines provide caramel flavors, and phenolic compounds have a smoky flavor. In yet another aspect, the flavoring agent added to the connective tissue analog is a combination of more than one natural flavoring agent, more than one synthetic flavoring agent, or natural and synthetic flavoring agents. It is discovered that inclusion of flavoring agent in the mixture may render a unique aroma or taste desirable for the final plant-based meat analog. The quantity of flavoring agents used may be at the lowest level necessary to achieve the intended flavoring effect.

The connective tissue analog may further comprise a dietary fat. Dietary fat refers to the fats and oils found naturally in animal and plant foods, and mainly made up of fatty acids. There are two types of fatty acids: saturated and unsaturated fat. In some aspects, fats may be combined with the connective tissue analogs, or even infused throughout to mimic adipose tissue.

The connective tissue analog may also comprise a food grade coloring agent. “Food grade” as used herein refers to any compounds or compositions suitable for human and/or animal consumption. Suitable food grade colorants as used herein refers to any food grade compounds or compositions that impart a color change to the substantially homogeneous mixture. Examples of food grade colorants include, but are not limited to, caramels, iron oxide, red blood cells, and other organic or inorganic dye or pigments such as turmeric, riboflavin, quinoline yellow, sunset yellow FCF, carminic acid, allure red AC, brilliant blue FCF, chlorophyll, green S, fast green FCF, brilliant black BN or brilliant black PN, brown HT, carotene, annatto extracts, lycopene, beet red, anthocyanins or grape skin extract or blackcurrant extract, titanium dioxide, iron oxide, tannic acid, and tannins. These colors or dyes, along with their corresponding lakes, and certain natural and derived colorants, may be suitable for use in various aspects of the present disclosure.

The connective tissue analog may further comprise a pH modifier, an antimicrobial agent, an antioxidant, a preservative, a dispersant, or any combination thereof. A pH modifier is an edible acid or base that can modify the pH of the mixture. For example, when konjac gum is in the mixture, an alkaline base may be used as the pH modifier to facilitate the gelling process. An antimicrobial, an antioxidant, and a preservative perform similar function for preventing the growth or proliferation of microorganisms in food products, or to minimize the product degradation due to expose to air or microorganisms, including but not limited to bacteria and fungi. They may be desirable in the current disclosure, to render the connective analogs a reasonable shelf-life. Food grade preservatives or antioxidants may include benzoates, sorbates (potassium sorbate, calcium sorbate and sodium sorbate), propionates, parabens, chlorobutanol, phenol, calcium propionate, sodium nitrate, sodium nitrite, Na2EDTA, vitamin E (tocopherol), vitamin C (ascorbic acid), and citric acid. The use of preservatives or antioxidants should be carefully balanced to prevent hypersensitivity. A dispersant is an additive to provide a uniform mixture of particles and to prevent clumping and setting. The dispersants suitable for the present disclosure, may include but are not limited to starch, alginic acid, polyvinylpyrrolidone, guar gum, kaolin, bentonite, cellulose, sodium starch glycolate, isomorphous silicate, and microcrystalline cellulose.

### II. Connective Tissue Analogs

An average cut of animal meat typically contains muscle tissues, fats, and perimysiums, or connective tissues (the two terms used interchangeably in the present disclosure). Naturally occurring connective tissue in animals, such as perimysium, makes up the pale elastic material lying visibly between muscle tissues, on/between bones, or between muscle tissues and bones. Connective tissue includes tendons, ligaments, cartilage, perimysium, elastin-like connective tissue, or collagen-containing sheets. Connective tissues are mainly made of collagen, elastin, their derivatives, or combinations, in various physical forms and densities. Collagen holds or connects muscle tissues together. Perimysium comprises collagen-containing sheets in the form of silvery films across the surface of muscle tissues. Initially very tough, collagen breaks down under heat or cooking, rendering meat a tender, silky mouthfeel. Elastin is primarily found in ligaments and surrounding muscles, is stretchy and very tough to chew. Unlike collagen, elastin does not break down when the meat is cooked.

“Connective tissue analogs”, also referred to herein as “connective tissue mimics”, are food compositions mimicking the naturally occurring connective tissues described above, in terms of texture, chewiness, mouthfeel and/or elasticity, but not made of collagen or elastin of animal origin. In one aspect, a connective tissue analog comprises an at least partially dehydrated gel comprising at least a hydrocolloid base and a dietary fiber additive. The gel may be cast in a sheet form or comminuted into particles. The hydrocolloid base may include any of the hydrocolloids described herein. The dietary fiber additive may include any of the dietary fiber additives described herein. The at least partially dehydrated and comminuted gel also may include one or more of an additional hydrocolloid, a protein, a crosslinker, or at least one of flavoring or fat to form the substantially homogenous mixture, as described above and below in relation to the substantially homogenous mixture. In some aspect, the at least partially dehydrated and comminuted gel is devoid of spun protein fibers. Further, the at least partially dehydrated gel when comminuted into particles may comprise particles having an average width or diameter or as described elsewhere herein, such as but not limited to about 0.5 mm up to about 2.0 mm, 2.5 mm or 3.0 mm.

In one aspect, the connective tissue analogs/mimics can be used as food products themselves, suitable to be consumed by human beings or animals. Alternatively, these analogs may be combined with other components or food compositions to impart chewiness, mouthfeel, or elasticity to the final products.

In yet another aspect, the connective tissue analogs may be crosslinked to other food compositions with or without the help of crosslinking agents, and forming an inter-connective matrix mimicking the complex tissue arrangements in animal-based food products, such as meat. In yet other aspects, there may be fat deposits combined with the connective tissue analogs, or even infused throughout to mimic adipose tissue.

### III. Food Compositions

Food compositions are the final edible products ready to be consumed by human beings and/or animals. They may comprise various components or ingredients, each imparting a desired feature or characteristics to the products, such as nutrition, flavor, taste, texture, mouthfeel or chewing experience.

Food compositions contemplated herein include meat analogs comprising the connective tissue analog as the sole component, or as one of two or more components. Non-limiting examples of meat analog compositions include compositions mimicking ground meat, meatloaf mix, steaks, pinwheels, sausages, salami, jerky, bacon, pork boneless rib meat, chicken cutlets, tenders, drumsticks, or hams. The food compositions described herein may be formulated to mimic any real meat product, such ground meat, ground meat patties, ground meat meatballs, meat steaks, meat sausage, meat jerky strips, or any combination thereof. In some aspects the food compositions described herein may be formed as any such product formed from real beef or poultry. The present disclosure contemplates, for example, plant-based food compositions in the form of ground beef, a ground beef patty or slider, a ground beef meatball, a beef sausage or hot dog, a cut of beef, corned beef, or a dried beef strip. The meat alternative formulation described herein may alternatively be prepared in the form of other real meat products such as meat (beef, chicken or turkey) nuggets or strips, meat loaf or meat cake forms, canned seasoned meat, sliced meat, sausage of any size, or processed meats such as salami, bologna, lunch meat and the like. The meat alternative formulation, after cooking, may provide the color, the flavor, and the texture of cooked meat which is pleasurable and palatable to the consumer. Meat analog compositions may comprise a plant-based meat-like base combined with a connective tissue analog to impart the chewiness and mouthfeel of a real animal meat to the meat analog compositions. The plant-based meat-like base is a base material or composition of plant origin that may have a nutritional profile and/or taste and/or texture similar to real animal meat. Non-limiting examples of a plant-based meat base or composition may include plant proteins and/or fibers, such as proteins isolated from soy, rice, peas, beans nuts, corn, wheat, gluten, and animal proteins such as milk and egg.

In some aspects, the meat analog composition comprises a heme protein, a plant-based protein, a hydrocolloid base, a plant-based fiber, an additional plant-based protein, and a second additional plant-based protein. In another aspect, the analog composition comprises a heme protein, a plant-based protein, a hydrocolloid base, a plant-based fiber, and an additional plant-based protein. In a further aspect, the present disclosure provides meat alternative formulations which include a heme protein, a plant-based protein, an additional plant-based protein, a hydrocolloid base, and a plant-based fiber. In another aspect, the meat alternative formulation comprises a heme protein, a plant-based protein, a hydrocolloid base, a plant-based fiber, an additional plant-based protein, a second additional plant-based protein, and a fat. In another aspect, the meat analog composition comprises a heme protein, a plant-based protein, a hydrocolloid base, a plant-based fiber, an additional plant-based protein, a second additional plant-based protein, a fat, and a binder. In an additional aspect of the present disclosure, the meat analog compositions consisting of (a) a heme protein; or (b) a non-heme protein; or (c) a plant-based protein and any combination thereof; (d) a hydrocolloid base; (e) a dietary fiber; (f) an additional plant-based protein; (g) a second additional plant-based protein; (h) a fat; (i) a binder; (j) a flavor enhancer; and (k) water.

As used herein, ‘heme protein’ refers to a protein which comprises or is configured to bind to a heme prosthetic group. Heme prosthetic groups typically comprise one or more highly conjugated rings complexed to an iron. For example, a heme prosthetic group (which may be referred to interchangeably as ‘heme’ or ‘heme moiety’) may denote iron (e.g., Fe⁺², Fe⁺³, or Fe⁺⁴) bound to a porphyrin ring. Examples of heme moieties include, but are not limited to, heme a, heme b, heme c, heme d, heme d1, heme I, heme s, heme o, heme m, and siroheme. In some cases, a heme moiety comprises a porphyrin, porphyrinogen, corrin, corrinoid, chlorin, bacteriochlorophyll, corphin, chlorophyllin, bacteriochlorin, or isobacteriochlorin moiety complexed to an iron ion. A heme protein may possess one or several iron porphyrins.

The heme protein may be expressed in and/or purified or isolated from a plant, an animal, or a microbe (e.g., a bacterial or yeast expression system). In one example the heme protein is expressed in Pichia pastoris. The heme protein may comprise one or more of a mammalian (e.g., bovine) myoglobin and/or hemoglobin produced in a yeast fermentation system.

A meat analog as contemplated herein may comprise the combination of a connective tissue analog as described herein, and a plant-based meat-like base material or composition, thereby forming a plant-based meat substitute sold in a form such as “ground meat”, burgers/patties, or other forms, for example comparable to Impossible® Burger (from Impossible™ Foods), Beyond Burger® (from Beyond Meat®), Veggie Chik Patty® (from Morningstar Farms®), and Plant-Based Patties from Good & Gather™. Other examples of a meat analog products that may include a connective tissue analog as provided herein are Veggie Meal Starters® from Morningstar Farms®, such as Veggie CHIK′N Nugget, Veggie Popcorn CHIK′N, Veggie CHIK′N Strips, Veggie Grillers®, Veggie Buffalo, and Beyond Meat® products such as Beyond Beef® Crumbles, Beyond Beef® Ground Beef, and Beyond Beef® Sausage.

In some aspects, the amount of a connective tissue analog combined with a plant-based meat-like base is, in percentage form, as referred to herein an “inclusion rate”, from about 0.1 to about 10 wt %, about 0.2 to about 5 wt %, about 0.3 to about 4 wt %, about 0.4 to about 3 wt %, about 0.5 to about 2 wt %, about 0.5 to about 1.5 wt %, about 1.0 to about 2.0 wt %, about 1.5 to about 2.0 wt %, about 1.5 to about 2.5 wt %, about 2.0 to about 3.0 wt %, about 2.5 to about 3.0 wt %, about 2.5 to about 3.5 wt %, about 3.0 to about 4.0 wt %, about 3.5 to about 4.5 wt %, about 4.0 to about 5.0 wt %, about 0.1 to about 0.5 wt %, about 0.5 to about 1.0 wt %, about 1.0 to about 1.5 wt %, about 1.5 to about 2.0 wt %, about 2.0 to about 2.5 wt %, about 2.5 to about 3.0 wt %, about 3.0 to about 3.5 wt %, about 3.5 to about 4.0 wt %, about 4.0 to about 4.5 wt %, about 4.5 to about 5.0 wt %, less than about 5.0 wt % of the meat analog product, less than about 4.0 wt %, less than about 3.0 wt %, less than about 2.5 wt %, less than about 2.0 wt %, less than about 1.5 wt %, less than about 1.0 wt %, or less than about 0.5 wt % of the meat analog product. Specifically, the inclusion rate may be about 0.1 wt %, about 0.2 wt %, about 0.3 wt %, about 0.4 wt %, about 0.5%, about 0.6 wt %, about 0.7 wt %, about 0.8 wt %, about 0.9 wt %, about 1.0 wt %, about 1.2 wt %, about 1.5 wt %, about 1.7 wt %, about 2.0 wt %, about 2.5 wt % or about 3.0 wt %. For example, in some specific aspects the inclusion rate is preferably between about 0.5 wt % to about 2 wt %. It is noted that including too high a percentage of a connective tissue analog in certain meat analogs may provide an undesirably chewy meat analog, whereas in other meat analog products such as in sausage or jerky analogs, a relatively higher degree of toughness or chewiness may be desirable. Thus, the inclusion rate will depend on the particular meat analog product in which the connective tissue analog is included.

### IV. Methods of Preparing

To make a connective tissue analog, a dietary fiber additive is added to one or more hydrocolloid base(s) and mixed to form a substantially homogenous mixture as described elsewhere herein. Additional hydrocolloid bases and/or dietary fiber additives and/or ingredients as disclosed herein may be incorporated and mixed effectively to form the substantially homogenous mixture. The substantially homogenous mixture may consist essentially of one or more hydrocolloid base(s) and one or more dietary fiber additives. In other aspects, the substantially homogenous mixture may consist essentially of or comprise one or more hydrocolloid base(s), one or more dietary fiber additives and one or more proteins, a crosslinker, a flavoring and/or a dietary fat, which are mixed sufficiently to form a substantially homogenous mixture. The substantially homogenous mixture is then hydrated to form a gel, followed by at least partial dehydration and then at least partial rehydration before being added to, or at least partial rehydration upon being added to a plant-based meat analog product. The process may further comprise casting of the gel in hydrated form into a sheet form, and/or comminuting, sifting, sizing, packaging, storing, or any combination thereof, and in any order suitable.

### Combining

A “substantially homogenous mixture” is described herein above. The ingredients/components that form the substantially homogenous mixture are preferably in solid and dry form, such as powders, lyophilized powders, particles, flours, sheets, cubes, and blocks. Combining the ingredients may be achieved through any commonly used means such as blending, stirring, whisking, rotating, breaking, pounding, grinding, milling, rolling, chopping, cutting, pulverizing, or any other physical means or maneuvers to allow the even distribution of ingredients in the mixture. The tools or instrumentations used in the combining may include, but not limited to scales to measure out the ingredients, mixing bowls for holding and mixing the ingredients, and stir bars, whisk wires or mixers to facilitate the combining to form the substantially homogenous mixture.

### Hydrating

Hydrating generally refers to the process of introducing an aqueous liquid to a dry phase. Hydrating the substantially homogeneous mixture may be achieved by introducing to the mixture a hydration agent, such as water in any form and at any temperature, another aqueous solvent, a gelling agent, or any combination thereof. Hydration is achieved when a viscous, sticky composition, i.e., a gel is produced. The hydration agent may be a water, an ionized water, a buffered water, a non-water solvent, a gelling agent, or any combination thereof. The water used may be a tap water, a distilled water, and a filtered water, such as those from millipore filtration. The water can be cold water, hot water, or introduced to the mixture as steam. The gelling agent may be an aqueous or a non-aqueous solution or liquid, comprising an inorganic ion, an organic ion, a crosslinking agent, a sugar, a salt, an acid, or a base, or anything that may facilitate the formation of a gel. Further, the hydration agent may be treated to reach a desired temperature, such as heating to a temperature above room temperature, boiling to a steam, or chilled to below room temperature.

Specifically, hydrating the substantially homogenous mixture may be achieved by adding the hydration agent, mixing, stirring, heating, cooling, setting, any combinations thereof, or any other means or maneuvers to allow dispersing of the substantially homogenous mixture to the hydration agent and gelling of the mixture. The tools and instrumentations in hydrating may comprise volumetric flasks to measure out the hydration agent, stir bar, whisk wire or mixers to facilitate mixing and hydrating, and oven/heater to heat up the hydration agent, or refrigerator/freezer to cool down the hydration agent.

It will be understood that the selection of the hydration agent and amount used in the hydrating step will vary with the nature and the amount of the various ingredients in the substantially homogenous mixture, especially the hydrocolloid bases and/or the additional hydrocolloids. For example, a mixture with predominantly carrageenan may gel when hydrated between 0.5 to 3% w/w, whereas agar may gel when hydrated between 1-2% w/w. Many hydrocolloids may be dispersed into cold water and may become thinner with heat. glucomannan and cellulosic gums may be dispersed in hot water, and then thicken with heat. Further, depending on the hydrocolloids in the substantially homogenous mixture, hydrating may require heating above 85° C. to ensure gel formation. Some other hydrocolloids in the substantially homogenous mixture may require the presence of other ingredients to form gels, such as ions in the solution, which also can affect the hydration temperature. Pectin requires the presence of sugar to gel, and konjac gum can form gels at a buffered water with pH>9.

### Casting

The method of making may include casting the gel obtained through hydration to form smaller gel pieces. Casting may comprise milling, rolling, comminuting, grinding, chopping, cutting, pulverizing, any other means to reduce the size of the gel, or a combination thereof. For example, casting of the gel may include rolling and cutting the gel into one or more monolithic forms, or one or more specific shapes. In another aspect, to create a perimysium analog, the gel can be cast as a sheet form. Yet another aspect is to cast the gel into small enough pieces that do not require further comminution. The tools and instrumentations suitable for casting may include rollers, knives, cutters, grinders, and mixers.

### Dehydrating

The method of making may include at least partially dehydrating, i.e., removing at least a portion of water from the gel. Without being bound by theory, it is believed that dehydrating the gel results in formation of a non-covalently cross-linked polymer network mimicking the complex tissue arrangements in animal connective tissue, thus forming a connective tissue analog. After the gel has been formed, the gel may also be subjected to desiccation, which further increases the crosslinking in the gel, with or without the help of a crosslinking agent. Dehydrating and/or desiccating the gel may be accomplished in a number of systems, such as any oven, any dryer such as but not limited to a hot air food dryer machine or convective dryer, belt food drying machine and microwave dryer, a dehydrator, a desiccator, an air fryer, a cooker, a smoker, a microwave oven, a freeze dryer, or any other means for removing moisture from the gel.

In some non-limiting examples, the gel is dehydrated in a convective hot air dryer under a temperature in a range from about 25° C. to about 150° C., about 25° C. to about 50° C., about 50° C. to about 75° C., about 75° C. to about 100° C., about 100° C. to about 125° C., about 125° C. to about 150° C., about 30° C. to about 40° C., about 40° C. to about 50° C., about 50° C. to about 60° C., about 60° C. to about 70° C., about 70° C. to about 80° C., about 80° C. to about 90° C., about 90° C. to about 100° C., about 110° C. to about 120° C., about 120° C. to about 130° C., about 130° C. to about 140° C., about 140° C. to about 150° C., about 30° C., about 40° C., about 50° C., about 60° C., about 70° C., about 80° C., about 90° C., about 100° C., about 110° C., about 120° C., about 130° C., about 140° C., about 150° C., at least about 30° C., at least about 40° C., at least about 50° C., at least about 60° C., at least about 70° C., at least about 80° C., at least about 90° C., at least about 100° C., at least about 110° C., at least about 120° C., at least about 130° C., at least about 140° C., or at least about 150° C.

In some aspects, the gel may be dehydrated in a convective hot air dryer in a range from about 1 hour to about 72 hours, about 1 hour to about 12 hours, about 4 hours to about 24 hours, about 12 hours to about 24 hours, about 24 hours to about 36 hours, about 36 hours to about 48 hours, about 48 hours to about 60 hours, about 60 hours to about 72 hours, about 1 hour to about 6 hours, about 6 hours to about 12 hours, about 12 hours to about 18 hours, about 18 hours to about 24 hours, about 24 hours to about 30 hours, about 30 hours to about 36 hours, about 36 hours to about 42 hours, about 42 hours to about 48 hours, about 48 hours to about 54 hours, about 54 hours to about 60 hours, about 60 hours to about 66 hours, about 66 hours to about 72 hours, at least about 1 hour, at least about 6 hours, at least about 12 hours, at least about 18 hours, at least about 24 hours, at least about 30 hours, at least about 36 hours, at least about 42 hours, at least about 48 hours, at least about 54 hours, at least about 60 hours, at least about 66 hours, or at least about 72 hours.

In various aspects, at least partially dehydrating the gel to form the dehydrated gel may include exposing the gel to dehydrating conditions for a period of time sufficient for at least about 75%, at least about 80%, at least about 81%, at least about 82%, at least about 83%, at least about 84%, at least about 85%, at least about 86%, at least about 87%, at least about 88%, at least about 89%, at least about 90%, at least about 95%, at least about 97.5%, at least about 99%, at least about 99.5%, or about 100% of the moisture content to be removed; or for at least about 75%, at least about 90%, at least about 95%, at least about 97.5%, at least about 99%, at least about 99.5%, or about 100% reduction of water activity of the composition. In this context, percentage dehydration refers to the relative moisture content or relative water activity of the at least partially dehydrated gel, compared to a starting level of hydration in a hydrated gel, as measured using standard methods known in the art for measuring either moisture content or water activity of a composition. A highly dehydrated gel results in a connective tissue analog that is highly shelf stable and sterile.

In many embodiments, the gel may be dehydrated in a convective hot air dryer at any of the temperatures described above for any period of time described above. For example, dehydrating the gel effective to form the dried gel having a polymer-like web (i.e., a non-covalently cross-linked polymer network) may include dehydrating the gel with convective drying in a temperature range from about 40° C. to about 50° C. in a time range from about 12 hours to about 24 hours. The time and temperature of dehydration may be based upon the size and shape of the gel being dehydrated.

### Comminuting

The method of making may also include, before dehydrating the gel, comminuting the gel effectively to form gel particles. The gel may be broken and separated into smaller particles, and then the smaller particles may be dehydrated. In some aspects the method of making also may include, after dehydrating the gel, comminuting the gel effectively to form particles. Comminuting the gel, whether hydrated or dehydrated, effectively to form particles may include one or more of grinding the dried gel under a grinder with a sharp blade, cutting the gel manually, and/or grinding, milling, chopping, or pulverizing with industrial-sized equipment. Particles produced by grinding or cutting tend to have very irregular shapes, which may add to the authenticity of the connective tissue analogs formed. As noted above, in some processes, the particles may be formed when the material is in the hydrated gel state, prior to dehydration, which may even result in faster drying times. Alternatively, the gels may be comminuted after partial dehydration, to provide better control or consistency of the end product. The particles may be produced with different shapes and sizes, may be uniform or irregular, and may be sorted into different groups based on size, and/or shape.

In some aspects, comminuting the gel effectively to form particles may include comminuting the gel effectively to form particles having a maximum width or diameter in a range from about 0.1 mm to about 10 mm, about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.5 mm, about 0.1 to about 0.3 mm, about 0.75 mm to about 2 mm, about 0.75 mm to about 2.5 mm, about 0.75 mm to about 3 mm, about 1 mm to about 2 mm, about 2 mm to about 3 mm, about 3 mm to about 4 mm, about 4 mm to about 5 mm, about 5 mm to about 6 mm, about 6 mm to about 7 mm, about 7 mm to about 8 mm, about 8 mm to about 9 mm, about 9 mm to about 10 mm, less than about 10 mm, less than about 9 mm, less than about 8 mm, less than about 7 mm, less than about 6 mm, less than about 5 mm, less than about 4 mm, less than about 3 mm, less than about 2 mm, less than about 1.5 mm, less than about 1 mm, less than about 0.5 mm, about 0.25 mm. about 0.5 mm, about 0.75 mm, about 1 mm, about 1.25 mm, about 1.5 mm, about 1.75 mm, about 2 mm, about 2.5 mm, about 3 mm, about 4 mm, about 5 mm, about 6 mm, about 7 mm, about 8 mm, about 9 mm, or about 10 mm.

Depending on the desired connective tissue being mimicked, certain sizes and/or shapes may be preferred. For example, perimysium may be mimicked using sheet particles having a maximum width or diameter up to about 2 mm. Small particle sizes are also useful for texturization of the burger material.

### Sizing

In some aspects the method of making may include removing particles below or above a certain size from the comminuted material, i.e., the process of sizing. The step of sizing may be implemented by sifting the analog particles through meshes with different sized pores, and thus obtain a polydispersed connective tissue analog with an upper and/or a lower cutoff size limit. In one aspect, the connective tissue analog particles obtained from comminuting are sifted through a 0.75 mm mesh, to remove particles smaller than 0.75 mm. In another aspect, the analog particles are sifted through a 3.0 mm mesh, so anything bigger than 3.0 mm can be discarded. In yet another aspect, the analog particles are sifted through a 0.75 mm mesh first, then those left on the mesh are further subject to a mesh with 3.0 mm pore, thus obtaining a polydispersed connective tissue analog with particle sizes between 0.75 mm and 3.0 mm.

Thus, after the steps comprising at least mixing, hydrating and dehydrating, and optional steps of casting, comminuting and sizing, a connective tissue analog in the form of at least partially dehydrated and comminuted gel is obtained, and may be in the form of particles or sheets with a specific size range.

### Packaging and Storing

The method of making may also comprise a step of safely packaging and storing the connective tissue analog obtained through the above steps. The analog may be packaged using routine procedures into a container or a bag suitable for holding food and facilitating its stability. In one aspect, the container or bag may have a setup to prevent air or water diffusion into the connective tissue analog. The container or bag used may also possess a setup to prevent microorganisms, such as bacteria entering into the container or bag. In one aspect, the container or bag suitable for holding food may be a one of disposable, airtight, zippered, sealable, or with vacuum sealing. In another aspect, the packaged connective tissue analog may be stored under room temperature, in a refrigerator, or in a freezer. The packaged and stored connective tissue analog may be ready to use at any time.

### Combining

The thus obtained connective tissue analog can be used as a food product itself, such as a chewy or crispy snack. In another aspect, the connective tissue analog may be further processed and combined with other food compositions to form a final food product. In one aspect, the analog is combined with a plant-based meat-like base, thus forming a final food product in the form of a meat analog product, such as a burger patty analog product, a sausage analog product, or a jerky analog product. The method of making such food product may comprise providing a connective tissue analog, preferably in particle or sheet form, and combining effectively the connective tissue analog with a plant-based meat-like base to form the meat analog product. The step of combining may comprise steps of adding the connective tissue analog to the plant-based meat-like base, then optionally dispersing, mixing, or blending with whisk wire, stir bars or in a mixer.

### Rehydrating

The thus formed meat analog product may be allowed to stay at room temperature or in a fridge for a certain period of time, such as overnight, to allow at least partial in situ rehydration of the connective tissue in the meat analog product. The rehydration may help render the meat analog product with a flavor profile consistent throughout the product. In another aspect, the connective tissue analog in at least partially dehydrated form may be at least partially rehydrated with an aqueous solution, before adding to a food composition. This ex-situ rehydration may be controlled to reach the desired water percentage in the at least partially rehydrated connective tissue analog. In some aspects the rehydrated analog may contain water percentage of at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%. In some other aspect, the rehydration process is not desired. The at least partially rehydrated connective tissue analog may be combined with the plant-based meat-like base in a range from about 0.1 to about 10 wt % of the plant-based meat-like base, about 0.2 to about 5 wt %, about 0.3 to about 4 wt %, about 0.4 to about 3 wt %, about 0.5 to about 2 wt %, about 0.5 to about 1.5 wt %, about 1.0 to about 2.0 wt %, about 1.5 to about 2.5 wt %, about 2.0 to about 3.0 wt %, about 2.5 to about 3.5 wt %, about 3.0 to about 4.0 wt %, about 3.5 to about 4.5 wt %, about 4.0 to about 5.0 wt %, about 0.1 to about 0.5 wt %, about 0.5 to about 1.0 wt %, about 1.0 to about 1.5 wt %, about 1.5 to about 2.0 wt %, about 2.0 to about 2.5 wt %, about 2.5 to about 3.0 wt %, about 3.0 to about 3.5 wt %, about 3.5 to about 4.0 wt %, about 4.0 to about 4.5 wt % , about 4.5 to about 5.0 wt %, less than about 5.0 wt %, less than about 4.0 wt %, less than about 3.0 wt %, less than about 2.5 wt %, less than about 2.0 wt %, less than about 1.5 wt %, less than about 1.0 wt % , or less than about 0.5 wt %.

Alternatively, in another aspect, the connective tissue analog may be at least partially rehydrated in situ, i.e., upon combining with a hydrated plant-based meat-like base or other hydrated composition, such that the connective tissue in a dehydrated form is thus rehydrated. This in-situ rehydration may be controlled to reach the desired water percentage in the at least partially rehydrated connective tissue analog. In some aspects the rehydrated analog may contain water percentage of at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%.

In some aspects the connective tissue analog, in either rehydrated form or non-rehydrated form, is combined with a plant-based meat-like base to form a meat analog product having about 0.5 wt % to about 2 wt % of the connective tissue analog. In some aspects, the connective tissue analog is added to a plant-based meat-like base to a concentration of about 0.5 wt %, about 1.0 wt %, about 1.5 wt %, or about 2 wt %. . It will be understood that the inclusion rate may vary according to the meat analog product being prepared.

### Crosslinking

In some aspects, the method of making may involve crosslinking. The connective tissue analog may be crosslinked to other components in the final food product. In one aspect, a transglutaminase may be used to enzymatically crosslink the connective tissue analog to other ingredients, such as proteins, in the final product. The crosslinking thereby may mimic the complex tissue arrangements in real animal meat. Furthermore, fat deposits may be combined with the connective tissue analogs, or even infused throughout the final food product to mimic adipose tissue in animal meat.

The method of making a meat analog suitable for human or animal consumption may comprise cooking, baking, frying, grilling, smoking, or any temperature-elevating process to cook the food products combined with the connective tissue analogs. For example, a meat analog product in the form of a burger patty and which comprises a connective tissue analog, such as a tendon, cartilage, or perimysium analog, may be cooked more or less the same way as an animal meat burger patty would normally be cooked.

A connective tissue analog may thus be made using non-animal ingredients, such as hydrocolloid bases and food additives of plant origin. The ingredients may further comprise any one or more of a protein, a crosslinking agent, a flavoring agent, a dietary fat, a colorant, a pH modifier, an antimicrobial agent, an antioxidant, a preservative, a dispersant, or any other constituents with beneficial effect. The making of the connective tissue analog may be initiated by mixing the ingredients effectively to form a substantially homogeneous mixture. The method of making is followed by steps comprising at least hydrating and dehydrating, and optional steps of casting, comminuting, and sizing. The connective tissue analog is obtained in the form of at least partially dehydrated and comminuted gel and may be in the form of particles or sheets with a specific size range or shapes. The steps may optionally further comprise extrusion, but advantageously the methods of making a connective tissue analog do not rely on and may be entirely devoid of extrusion or micro-extrusion.

### V. Instrumentation

Various processes and steps of making the present disclosure may be implemented by various tools and instrumentation, suitable for benchtop scale, kitchen scale, or industrial scale manufacture. Table 1 lists some exemplary instrumentation suitable to carry out the disclosure at a lab benchtop or in a kitchen.

TABLE 1
EXEMPLARY INSTRUMENTS FOR BENCHTOP OR KITCHEN USE

| PROCESS | For Benchtop Scale | For Kitchen Scale |
|---|---|---|
| Mixing | Wedderburn scale GM-1100 | KDigital multi-use scale to 5000G |
| | Ainsworth Microbalance | Metal bowls |
| | Glass beaker (various sizes) | |
| Hydrating | Millipore MilliQ Direct-8UV Ultrapure | Filtered Water |
| | (Type 1) water system | Induction heater, Polyscience |
| | Magnetic stir bar | “Control Freak” |
| | Corning PC-420D hotplate/stirrer | Wire whisk |
| | Wire whisk | KitchenAid mixer with paddle |
| | | attachment |
| Setting and | Plastic weigh boats (for cartilage or | Silpats (for sheets) |
| Gelling | tendon mimics) | Large sheet pan trays |
| | Glass table-top (for spreading sheets, | Silicone molds (for blocks) |
| | in making perimysium mimics) | S/S Roasting racks |
| Cutting | Benchtop knife | Meat grinder, optional for various |
| | | sizes |
| | | Kitchen knife for hand cutting |
| Dehydrating | Presto dehydrator (static) | Rational ICC Combi Oven MODEL |
| | GoWise dehydrator and air-fryer (rotary) | SCC WE 620 |
| | desiccator | Excalibur 9 tray dehydrator |
| | | desiccator |
| Grinding/ | Quellance electric coffee grinder | Coffee grinder Ditting Swiss style |
| comminuting | Atlas pasta maker, for cutting pieces | variable |
| | Vermicelli cutter, for cutting sheets | KitchenAid mixer with linguine and |
| | | fettuccine attachments |
| Sizing | Various size plastic meshes | Rotatap system |
| | Custom 3D printed meshes | Custom 3D printed mesh inserts |
| | Food saver vacuum packer | |

### DEFINITIONS

Unless defined otherwise, all technical and scientific terms used herein have the meaning commonly understood by a person skilled in the art to which this disclosure relates. The following references provide one of skill with a general definition of many of the terms used in the present disclosure: Dictionary of Food Ingredients (Igoe et al, 2011); The Cambridge Dictionary of Science and Technology (Walker ed., 1988); Essentials of Food Science (Vickie A. et al, 2013), The Professional Chef (2011), A Consumer's Dictionary of Food Additives (Winter, 2009), and Merriam-Webster Dictionary and Thesaurus (2020). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “comprising” means “including, but not necessarily limited to”; and specifically indicates open-ended inclusion or membership in a so-described combination, group, series, and the like. The terms “comprising” and “including” as used herein are inclusive and/or open-ended and do not exclude additional, unrecited elements or method processes. The term “consisting essentially of” is more limiting than “comprising” but not as restrictive as “consisting of.” Specifically, the term “consisting essentially of” limits membership to the specified materials or steps and those that do not materially affect the essential characteristics of the claimed invention. Unless expressly indicated otherwise, all instances of “comprising” are intended to encompass “consisting essentially of” and “consisting of” embodiments.

The term “suitable for human or animal consumption” specifically means fit as a food preparation for human or animal ingestion and excludes use of the compositions for purposes such as prosthetic or medical uses, or human or animal hygiene.

The term “hydrogel-like mechanical properties” as used herein describes the mechanical properties of the envisaged dehydrated and rehydrated plant based connective tissue analogs. Using a micromechanical testing device like the Instron Universal testing device or similar device, at some slow compression speeds (exemplified by about 0.01 mm/sec—2 mm/sec) a connective tissue analog with hydrogel-like mechanical properties exhibits (in a stress-strain curve) a linear region followed by a non-linear region that increases to a stress maxima and then dips to a minima followed by a non-linear increase before terminal failure. This behavior changes at fast compression speeds (for example, 50 mm/sec exhibiting an exponential increase to terminal failure.

The term “hydrogel-like rheological properties” as used herein comprises rheological properties of the envisaged dehydrated and rehydrated plant based connective tissue analogs wherein the storage modulus (G′) is greater than the loss modulus (G″) across the linear viscoelastic region and G′ and G″ increase with decreasing gaps and with decreasing water content.

The term “glucomannan” as used herein refers to that water-soluble polysaccharide commonly obtained from the Konjac plant but also available from other plant sources.

As various changes could be made in the above-described analogs and methods without departing from the scope of the invention, it is intended that all matter contained in the above description and in the examples given below, shall be interpreted as illustrative and not in a limiting sense.

### EXAMPLES

The publications and descriptions above are provided solely for their disclosure before the filing date of the present application. Nothing herein is to be construed as an admission that the present disclosure is not entitled to antedate such disclosure by virtue of prior invention.

The following examples are included to demonstrate the disclosure. It should be appreciated by those of skill in the art that the compositions, methods, and steps disclosed in the following examples represent techniques discovered by the inventors to function well in the practice of the current disclosure. Those of skill in the art should, however, in light of the present disclosure, appreciate that many changes could be made in the disclosure and still obtain a like or similar result without departing from the spirit and scope of the current disclosure, therefore all matter set forth is to be interpreted as illustrative and not in a limiting sense.

As noted, a connective tissue analog may be prepared to mimic specific connective tissues, such as elastin, ligament, tendon, collagen, or perimysium. Working examples presented below provide exemplary embodiments and aspects for each of these specific connective tissue analogs. These examples also demonstrate how the current disclosure progresses from proof of concept and comparison (with their animal product counterparts), to optimization and realization.

### General Preparation Steps

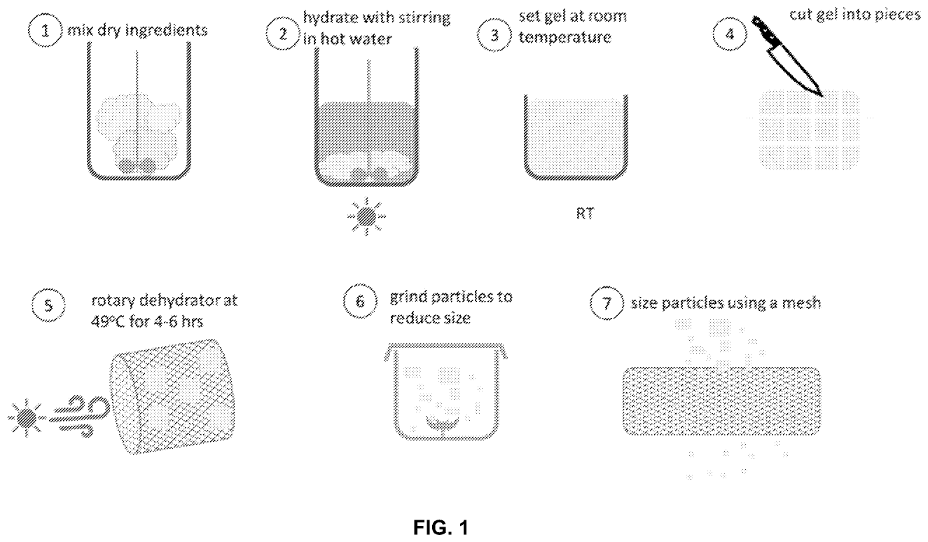

FIG. 1 provides an overview of the general process used for the preparation of connective tissue analogs described herein. The process broadly (and described in more detail in the examples outlined below) comprises the steps of combining the ingredients, hydrating the combined ingredients, gelling, cutting, at least partially dehydrating the gel, grinding, and sizing. One step, preferably the first step of the process, comprises combining/mixing the ingredients as described herein sufficiently to obtain a substantially homogenous mixture. The ingredients are preferably in a solid, dry form such as powders, lyophilized powders, particles, and blocks. The next step, preferably the step after combining/mixing, comprises hydrating the substantially homogenous mixture obtained from the mixing step. The hydrating may be achieved by stirring, blending, or otherwise adding water or an aqueous fluid to the substantially homogenous mixture. The water or aqueous fluid can be at room temperature, or at a temperature higher than ambient air, such as at a temperature anywhere between about 30.0-99.9° C. The hydrating step may further comprise a heating step after adding water or aqueous fluid to the substantially homogenous mixture. Following hydrating, the resulting composition is allowed to set for a period at room temperature, until a gel is formed. Following gelation, the obtained gelled composition is dehydrated, for example dehydrated at 49° C. for 6-24 hours, until an at least partially dehydrated gel is obtained. The partially dehydrated gel may be comminuted and is then rehydrated, thereby obtaining an a non-covalently cross-linked polymer network exhibiting elasticity, chewiness, and mouthfeel similar to animal connective tissue. The steps suitable for practicing the current disclosure may further include crosslinking, under the presence or absence of a crosslinking agent. The steps may optionally further comprise extrusion, but do not rely on, and preferably exclude extrusion or micro-extrusion.

### Example 1. Elastin-Type Connective Tissue Analog, Use of Soy Protein

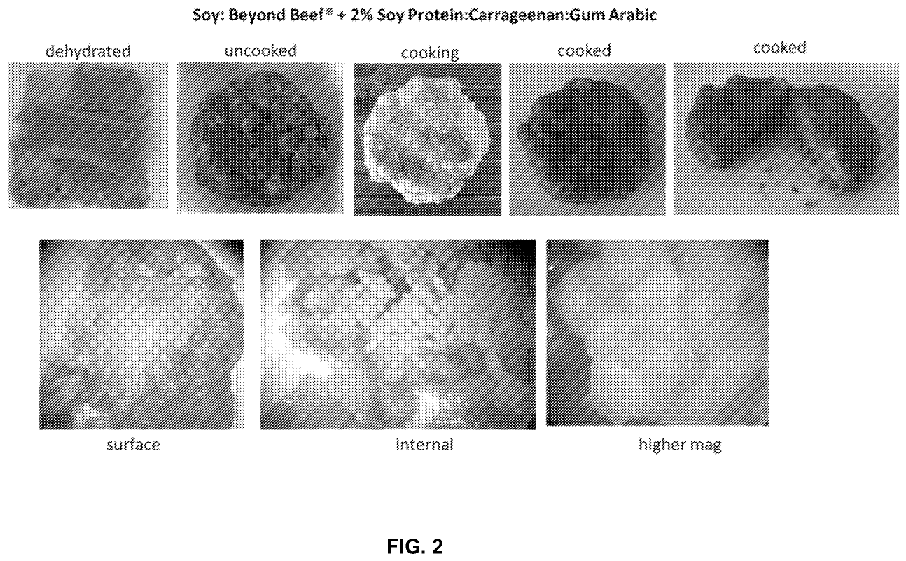

In this example, the ingredients used were soy protein, carrageenan, and gum Arabic in a weight ratio of 20:1:1. The ingredients were mixed thoroughly to form a substantially homogenous mixture. The mixture was added to 100 ml of water, heated to 70° C., stirred using a benchtop Corning PC-420D hotplate/stirrer, then set to form a gel. This gel was dehydrated overnight at 46° C. The obtained dehydrated product was an inter-connective matrix analogous to the natural connective tissue elastin. This elastin analog was then subjected to comminution by feeding briefly into a food processor on high for approximately 30 seconds. The end-product was then sieved to remove both very fine particles (<0.5 mm), and large pieces (>2 mm). The thus-obtained elastin-type connective tissue analog was in the form of particles with particle sizes ranging from about 0.5 mm to about 2 mm and can be further combined with other food compositions to make a final food product. For example, a burger patty analog product was made by combining 20 grams of Beyond Beef® patty analog composition with 400 mg of the above elastin-type connective tissue analog containing small (˜0.5 mm) and medium (˜1 mm) sized particles. The thus-obtained burger patty analog product was refrigerated overnight to allow for the elastin analog to rehydrate at least partially in situ. The patty product was then cooked on an open grill set on high for 3 minutes each side, inspected and then sampled. FIG. 2 are the photos taken during the process, including some microscope pictures of surface and internal of the product to provide details. These photos showed that the elastin-type connective tissue analog was noticeable in the patty analog product. Sample tasting showed the elastin analog provided a distinctly elastic bounce to the patty analog product, and actually breaks up with chewing just like the real animal elastin tissue.

### Example 2. Elastin-Type Connective Tissue Analog, Use of Pea Protein

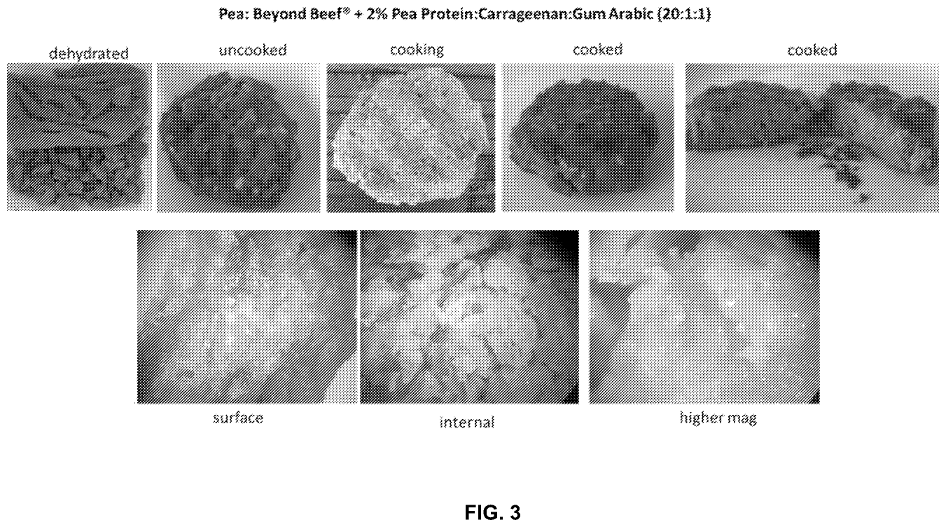

Following the same steps of Example 1, another elastin-type connective tissue analog was made with isolated pea protein, κ-carrageenan, and gum Arabic in the same weight ratio of 20:1:1. The obtained elastin-type connective tissue analog had a very bouncy mouthfeel as judged by a panel of sensory testers, providing a pleasant elasticity to the burger patty, with less breakage during chewing. FIG. 3 are the photos taken during the process, including some photomicrographs of the surface and internal regions to provide details.

### Example 3. Collagen-Type Connective Tissue Analog

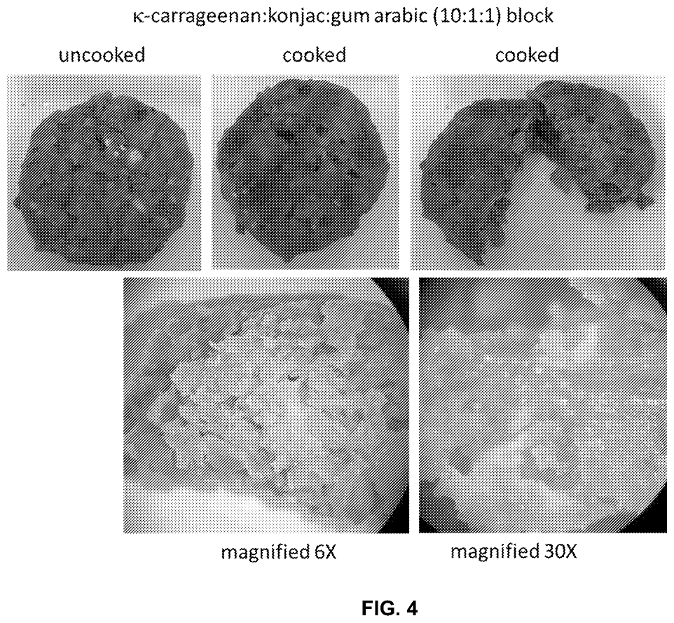

A mixture of κ-carrageenan, konjac glucomannan, and gum Arabic in a weight ratio of 10:1:1 was found to have a mouthfeel similar to cartilage when hydrated and allowed to gel. This gelled mixture was dehydrated as described in Example 1 and broken down in a food processor to small pieces. The resulting collagen connective tissue analog was combined with a burger patty analog composition at 1% w/w final inclusion (200 mg analog in a 20 g burger patty). A burger patty analog product was prepared as in Example 1. FIG. 4 were the photos taken during the process, including some microscope pictures with different magnifications to provide details. The collagen-type connective tissue analog provided the burger analog product with a bouncy and robust resilience at first bite, with a burst similar to a real cartilage breaking apart and required 3 to 5 chews to break down fully.

### Example 4. Perimysium-Type Connective Tissue Analog

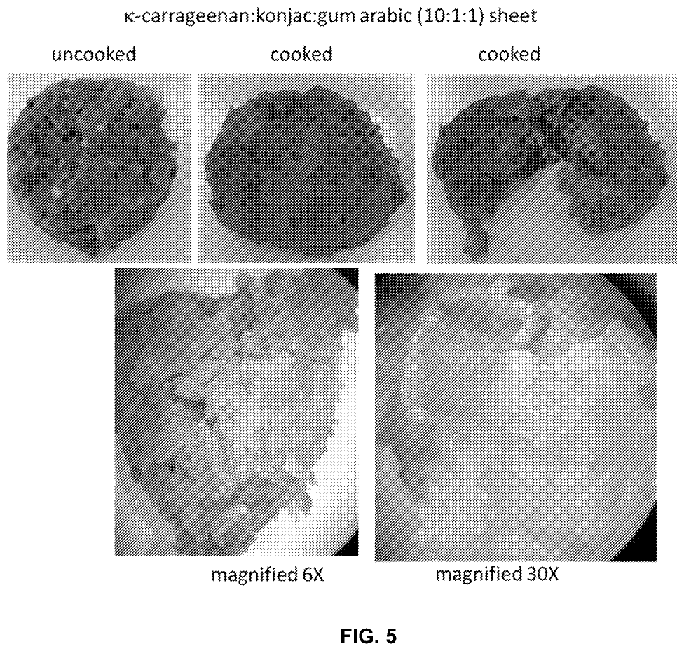

The same gelled mixture of Example 3 (containing κ-carrageenan, konjac glucomannan, and gum Arabic in the weight ratio of 10:1:1) was cast into a sheet before dehydration. The sheet was dehydrated similarly as in Example 1 to obtain a perimysium-type connective tissue analog. The analog was cut into small pieces and combined with a burger patty analog composition at 1% w/w inclusion, and thus obtained a burger patty analog product. This perimysium-type connective tissue analog provided a very interesting mouthfeel, similar to a sheet of connective tissue, and even provided the distinctive slide between the teeth during oral processing. FIG. 5 were the photos taken during the process, including some microscope pictures with different magnifications to provide details.

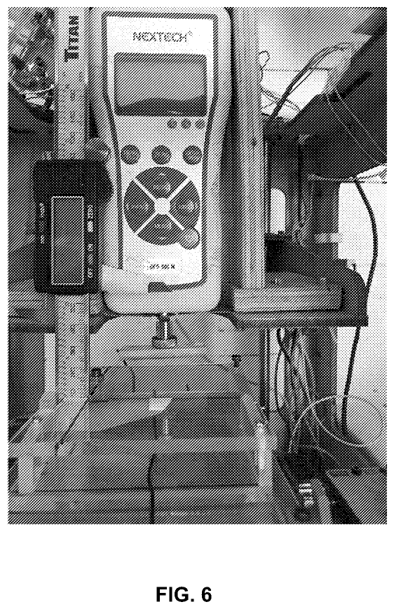

After the success of these proof-of-concept examples (Examples 1-4), a comparison study was designed and carried out to further prove that the obtained connective tissue analogs were comparable to and mimicking their animal meat counterparts in consumer experience. Specifically, real beef perimysiums and their plant-based analogs were subjected to a modified force gauge analysis, wherein the compression force of these samples was measured and analyzed as an indicator of the sample's behavior during a first chewing bite. The measurement was conducted on a custom-made compression measurement rig setup as shown in FIG. 6 to simultaneously measure force and distance using the calipers.

### Example 5. Comparison Sample, Cartilage Analogs/Mimics

Dry ingredients used were 12 g k-carrageenan, 1.2 g konjac glucomannan and 1.2 g gum Arabic. These dry ingredients were processed through the steps listed below to make the cartilage analog sample.
1. The dry ingredients were mixed to form a substantially homogenous mixture;
2. 400 ml of water was heated to a temperature of 70° C. or higher, while stirring using a Corning PC-420D hotplate/stirrer. Upon reaching the desired temperature, the substantially homogenous mixture from Step 1 was slowly added while whisking in clumps where necessary. Magnetic stirrer initially, then manual stirring was applied to prevent burning of the bottom of the sample;
3. The mixture was hydrated until a smooth uniform texture was achieved. This took at least about 5 minutes, with constant stirring with a wire whisk, while taking care to not pump too much air into the mixture to prevent bubble formation;
4. The hydrated mixture from Step 3 was poured into a Tupperware® container, and cooled to the room temperature completely, and set to allow gelling properly, thus obtained a gel;
5. The gel from Step 4 was removed from the container, and cut it into pieces, about 1-2 cm cubes. These cubes were large enough to prevent falling through the gratings in the dehydrator after they dried. The cutting step also helps to “tear” the gel and make irregular edges to facilitate grinding/comminuting later, as neat cubes are harder to break down;
6. The gel pieces from Step 5 were put into a rotary dehydrator (GoWise dehydrator and air-fryer) at 49° C. for at least 4-6 hours to completely dehydrate the gel pieces. Duration of dehydration was adjusted according to the amount of gel;
7. The dehydrated gel pieces from Step 6 were ground to reduce the pieces into particles with irregular shapes;
8. The particles obtained from Step 7 were sized, by first sifting through a 0.75 mm mesh to remove super fine particles, then through a 2.5 mm mesh, thus obtained the cartilage analog in the form of particles sized between 0.75 mm to 2.5 mm for further testing.

### Example 6. Comparison Sample, Perimysium Analogs/Mimics

Dry ingredients used were 8 g κ-carrageenan, 0.8 g konjac glucomannan and 0.8 g gum Arabic. These dry ingredients were processed as described below to make the perimysium analog sample.
1. The dry ingredients were mixed to form a substantially homogenous mixture;
2. 400 ml of water was heated to a temperature of 70° C. or higher, while stirring using the Corning PC-420D hotplate/stirrer. Upon reaching the desired temperature, the substantially homogenous mixture from Step 1 was slowly added while whisking in clumps where necessary. Magnetic stirrer initially, then manual stirring was applied to prevent burning of the bottom of the sample;
3. The mixture was hydrated until a smooth uniform texture was achieved. This took at least about 5 minutes, with constant stirring using a hand whisk, while taking care to not pump too much air into the mixture to prevent bubble formation;
4. The hydrated mixture from Step 3 was poured onto a smooth glass surface (may also use marble, stainless surfaces, or into trays), and allowed to cool to room temperature and set to a gel;
5. The gel of Step 4 was removed from the smooth surface, and cut into large pieces, about 20-30 cm, to fit into a dehydrator, such that air could flow between pieces;
6. The large gel pieces from Step 5 were fed into a stationary dehydrator at 49° C. for at least 4-6 hours to completely dehydrate the gel pieces. Dehydration period should be adjusted according to the amount of gel.
7. The dehydrated gel pieces from Step 6 were cut in a bladed coffee grinder to reduce their size and create pieces with irregular shapes.
8. The pieces from Step 7 were sized by first sifting through a 0.75 mm mesh to remove super fine particles, then through a 2.5 mm mesh, thus obtained pieces sized between 0.75 mm to 2.5 mm as the perimysium analog samples for comparison testing.

### Example 7. Sample Preparation, Tendon Analogs/Mimics

Dry ingredients were 10 g κ-carrageenan, 10 g konjac glucomannan and 10 g rice protein. These dry ingredients were processed through the steps below to make a tendon analog sample for comparison test.
1. The dry ingredients were mixed to form a substantially homogenous mixture;
2. 400 ml of water was heated to a temperature of 70° C. or higher, while stirring using a Corning PC-420D hotplate/stirrer. Upon reaching the desired temperature, the substantially homogenous mixture from Step 1 was slowly added while whisking in clumps where necessary. Magnetic stirrer initially, then manual stirring was applied to prevent burning of the bottom of the sample;
3. The mixture was hydrated until a smooth uniform texture was achieved. This took at least about 5 minutes, with constant stirring using a hand whisk, while taking care to not pump too much air into the mixture to prevent bubble formation;
4. The hydrated mixture from Step 3 was poured into a Tupperware® container, and cooled to the room temperature completely, and set to allow gelling properly, thus obtained a gel;
5. The gel from Step 4 was removed from the container, and cut into 1-2 cm cubes. These cubes were large enough to prevent them from falling through the gratings in the dehydrator after they were dry. The cutting step also helps to “tear” the gel and make irregular edges to facilitate grinding/comminuting later, as nice neat cubes were harder to break down;
6. The gel pieces from Step 5 were put into a rotary dehydrator (GoWise dehydrator and air-fryer) at 49° C. for at least 4-6 hours to completely dehydrate the gel pieces. Dehydration duration was adjusted according to the amount of gel in the dehydrator;
7. The dehydrated gel pieces from Step 6 were ground to reduce the pieces into particles with irregular shapes;
8. The particles obtained from Step 7 were sized, by first sifting through a 0.75 mm mesh to remove super fine particle, then through a 2.5 mm mesh, thus obtained the tendon analogs in the form of particles sized between 0.75 mm to 2.5 mm for further testing.

### Example 8. Comparison with Natural Connective Tissues

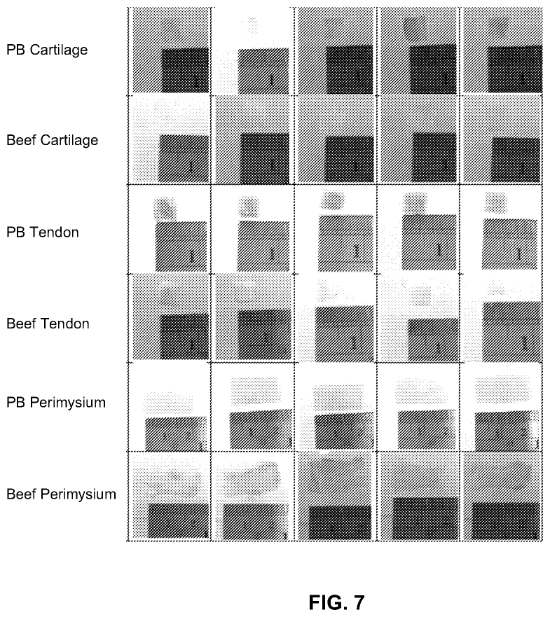

Connective tissue analog samples obtained from Examples 5-7, i.e., the cartilage analog, the perimysium analog and the tendon analog, were tested against real beef connective tissues of cartilage, perimysium, and tendon, respectively. The real beef samples were bought from Beast & Cleaver in Ballard, Wash. Both real beef and plant-based samples were combined with commercially available Impossible Foods® burger patty compositions and left overnight at refrigerated temperatures for rehydration. The following day, these mixtures were shaped into burgers and cooked at high temperature for 6 minutes (3 min on each side). The samples were then extracted from the burger, precisely cut, and tested with the custom-made compression force measurement rig shown in FIG. 6. The surface onto which the pressure was applied was crucial to ensure a proper comparison and needed to be equivalent for each sample measured. Therefore, tendon and cartilage samples were cut with a size of 5 mm×5 mm. Perimysium samples were cut into a size of 10 mm×20 mm, due to their thinner nature, and to make sure the measurements were representative. Images of these samples are presented in FIG. 7.

For compression force measurements, a custom-made rig (shown in FIG. 6) was designed by mounting a Nextech DFS 500N force meter onto the z-axis assembly of a 3D printer (MakerBot Thing-O-Matic). The z-axis was activated with a custom-made Arduino device. A clear acrylic support was designed for the placement of the samples, and the attachment of a Titan digital caliper. The caliper was used for accurately measuring and displaying the initial thickness of a sample and its variation throughout the measurement. These data were used to calculate the compression of the sample in percentage by the equation below.

$$Compression ( \% ) = 100 \times \frac{Thickness}{Initial Thickness}$$

During the experiment, the z-axis was slowly lowered by pressing a button on the Arduino device. The compression of the sample was recorded with a digital camera, allowing correlation of the compression and the force used to achieve this compression. The measurement was stopped when compression of the sample was no longer possible. For each connective tissue type, measurements were conducted on 5 different samples (replicates). To give an order of magnitude, a 50N force applied on a 5 mm×5 mm surface (25 mm²), as during the measurements of tendon and cartilage samples, was equal to a pressure of 20 bar (290 psi). A 50N force applied on a 10 mm×20 mm surface (200 mm²), as during the measurements of perimysium samples, was equal to a pressure of 2.5 bar (36 psi).

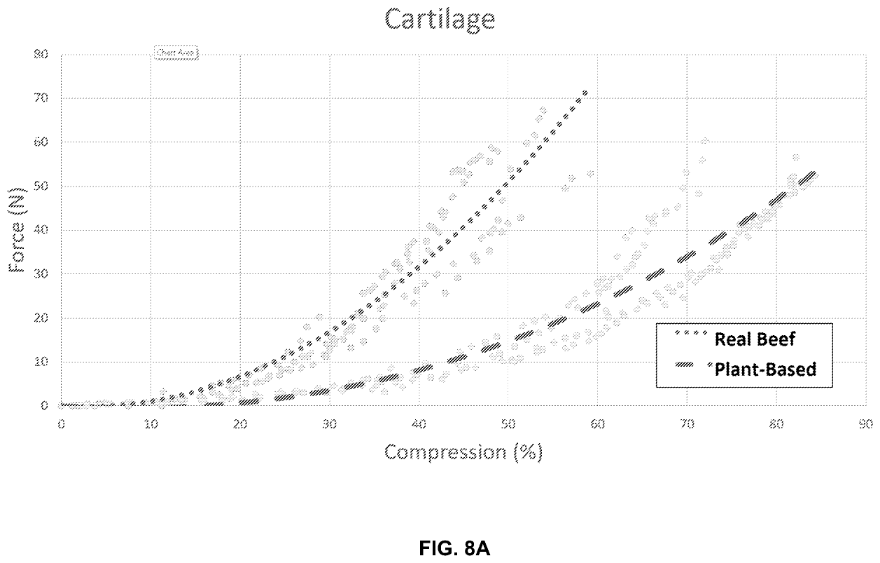

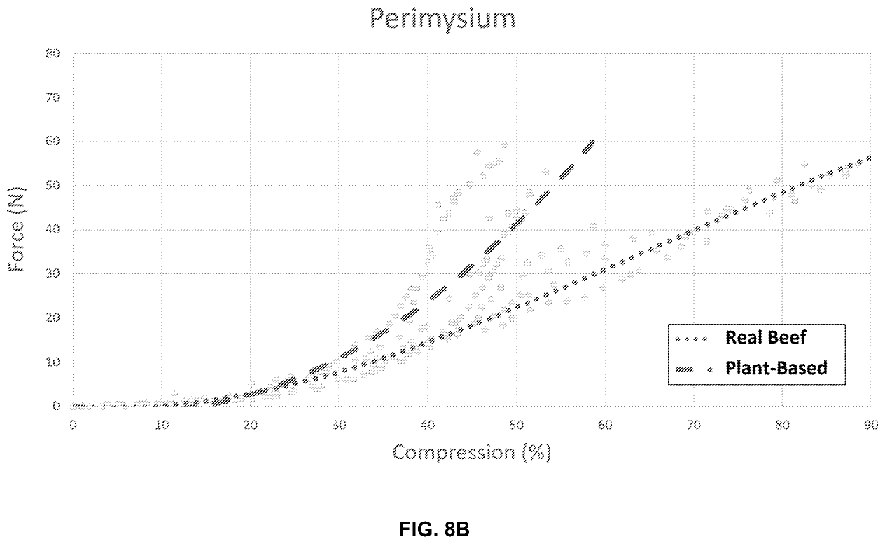

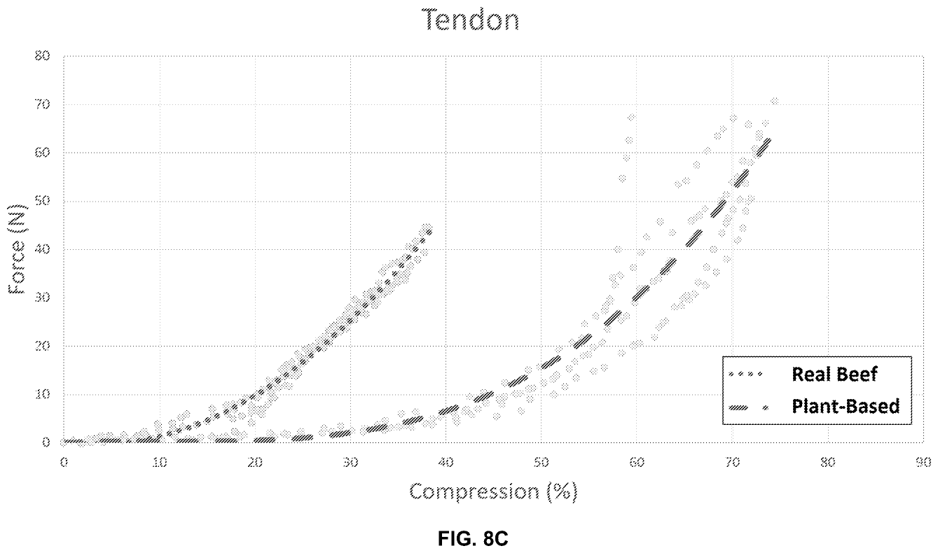

FIG. 8A-C present results of the compression measurements for cartilage samples (FIG. 8A), for perimysium samples (FIG. 8B), and for tendon (FIG. 8C). The defined clusters of data for each sample type revealed good reproducibility of the results, which validated the measurement method used. Concerning the tendon, plant-based samples appeared much stiffer than real beef samples. In fact, real beef samples were almost two times more compressed than their plant-based equivalents, when using the same compression force. Similar observations were made about cartilage samples. Concerning the perimysium, although the required force necessary to compress the samples by up to 25% seemed equivalent, the plant-based perimysium samples were much stiffer than real beef perimysium at higher compression ratios. Overall, plant-based samples appeared much stiffer than real beef samples for all perimysium types measured, although cartilage samples were stiffer than tendon samples in all cases. It was also important to note that plant-based samples were initially thinner than real beef samples, and a greater hydration may reduce the differences measured.

These results revealed some differences in mechanical properties of real beef perimysium and plant-based perimysium. It appeared that plant-based alternatives were stiffer than their real beef equivalents. Nevertheless, it was interesting to note that for both plant-based and real beef samples, the tendon was stiffer than the cartilage at high compression ratios. In this sense, plant-based samples did mimic the real beef samples. These results also confirmed that the connective tissue analogs as described herein did introduce heterogeneous textures to the plant-based meat mimics, a feature that is expressly contemplated intended by the current disclosure, and has not been achieved by any products currently on the market. Thus, these comparison results demonstrated that the plant-based connective tissue analogs of the present disclosure were successful in mimicking their animal perimysium counterparts by showing comparable compression-force profiles, thus bringing out similar texture, chewiness, and mouthfeel to the animal perimysium.

### Example 9. Particle Size Optimization, Experimental Design

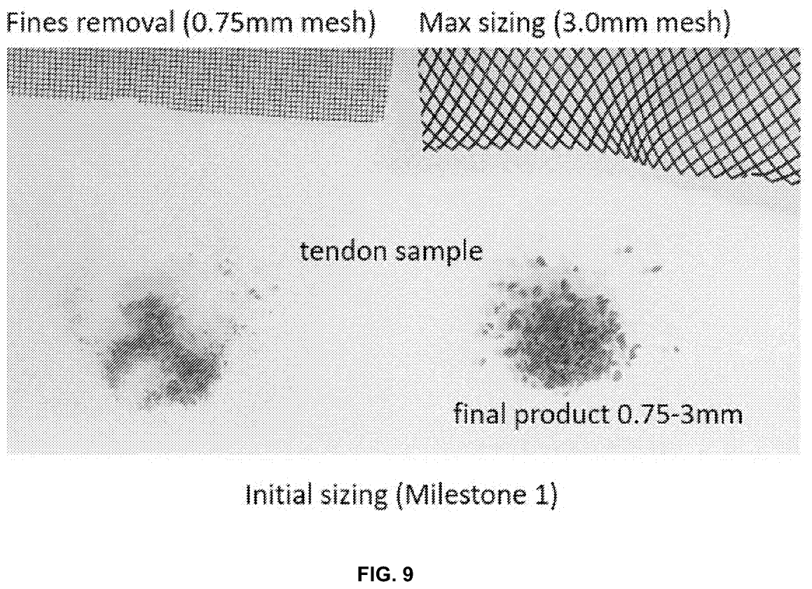

Experiments were designed to find the optimal size of connective tissue analogs that, when combined with meat analogs, may deliver the most authentic gristle texture, chewiness, and/or mouthfeel. For this purpose, the cartilage, perimysium, and tendon analogs from Examples 5-7 were further sifted through additional meshes in Step 8 to obtain a poly-dispersed connective tissue analog with an upper cutoff limit of different sizes. Specifically, the connective tissue analogs from Examples 5-7 were first sifted through a 0.75 mm mesh to remove particles smaller than 0.75 mm as in Step 8, then were sifted through either 1.5 mm, 2.0 mm, 2.5 mm or 3.0 mm meshes to obtain the polydispersed samples. FIG. 9 shows the tendon analogs in particle form obtained through the sifting process. These analogs were then combined with the Impossible Burgerepatty composition in the same way as described in Example 8. The final burger patty analog products were tested to determine which sizes of each connective tissue type provided the best eating experience.

### Example 10. Particle Size Optimization, Cartilage Analog/Mimic

Optimized composition was determined based on the cartilage analog prepared in Example 5, wherein ingredients were carrageenan, konjac, and gum Arabic in a 10:1:1 weight ratio with a 3% w/w carrageenan to water as the starting concentration for hydration. Nothing was modified except at Step 8, after the dehydrated gel pieces were sifted through a 0.75 mm mesh to remove super fine particles, they were either sifted through a 3.0 mm, a 2.5 mm, or a 2.0 mm sized mesh. Thus, three cartilage analog samples were obtained, with particles sized between 0.75 to 3.0 mm, between 0.75 to 2.5 mm, and between 0.75 mm to 2.0 mm, respectively. The three sized samples were combined with the Impossible Burger® patty composition at a 2% w/w inclusion percentage to determine the maximum optimal size.

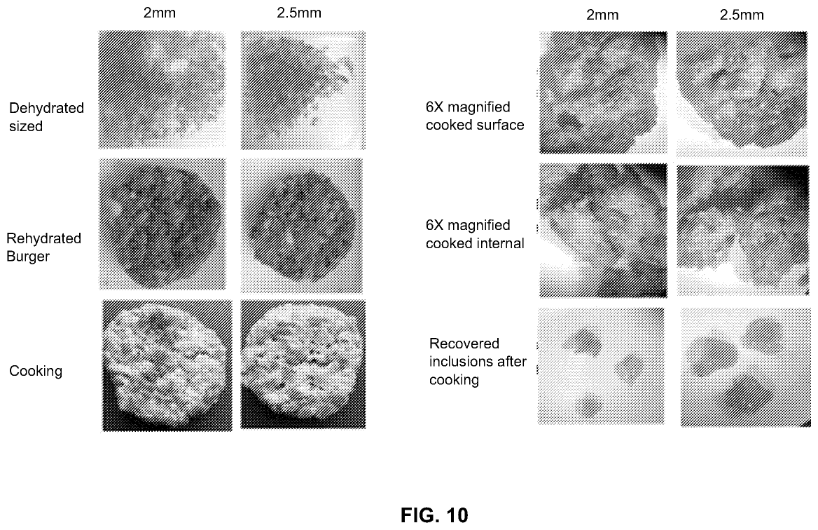

FIG. 10 shows the performance of cartilage analogs with maximum sizes of 2.0 mm and 2.5 mm in the final burger analog products, and also showed that the relative size did not impact the visual appearance significantly, either on the surface, or inside, before or after cooking the burger patty analogue product. That is, there was very little discernable difference between the 2.0 mm and 2.5 mm sized cartilage analogs in the burger patty analog product. The impact on mouthfeel, however, was noticeably different between the two, with the 2.0 mm size being too small and thus diminishing the effect of the texture enhancement. Much less “pop” and bounciness were noticed. It was difficult to tell the difference between the 2.5 mm and the 3.0 mm samples, however, as both performed well in the burger patty analog product to enhance the mouthfeel. Therefore, it was concluded that cartilage analogs with particles sized between 0.75 mm to 2.5 mm provided the best performance, in terms of the mouthfeel.

### Example 11. Particle Size Optimization, Perimysium Analog/Mimic

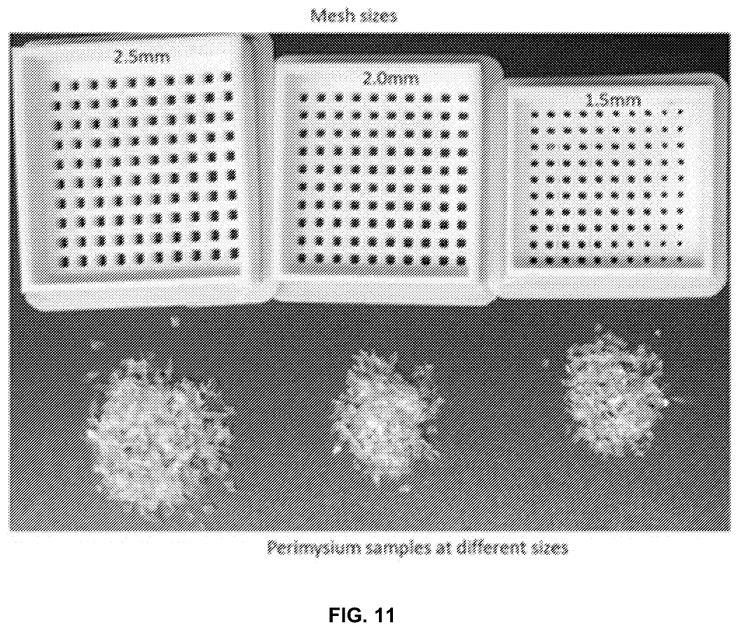

Optimized composition was determined based on the perimysium analog prepared in Example 6, wherein the ingredients were k-carrageenan, konjac glucomannan, and gum Arabic in a 10:1:1 weight ratio, with a 2% w/w k-carrageenan to water as the starting concentration. The perimysium analog was made accordingly to the same steps as in Example 6, except in Step 7 the dehydrated sheets were cut on a vermicelli pasta cutter, rather than in the bladed coffee grinder. This produced much fewer fine particles (thus less waste) and comminuted the dehydrated sheets into interesting sizes and shapes, after multiple passes. Further, as in Step 8 of Example 6, the obtained comminuted dehydrated sheets were sifted through first a 0.75 mm mesh, then a 2.5 mm mesh (as in Example 6), or a 2.0 mm mesh, or a 1.5 mm mesh. Thus, three perimysium analog samples were obtained with sizes between 0.75 to 2.5 mm, between 0.75 to 2.0 mm, and between 0.75 mm to 1.5 mm, respectively, as shown in FIG. 11.

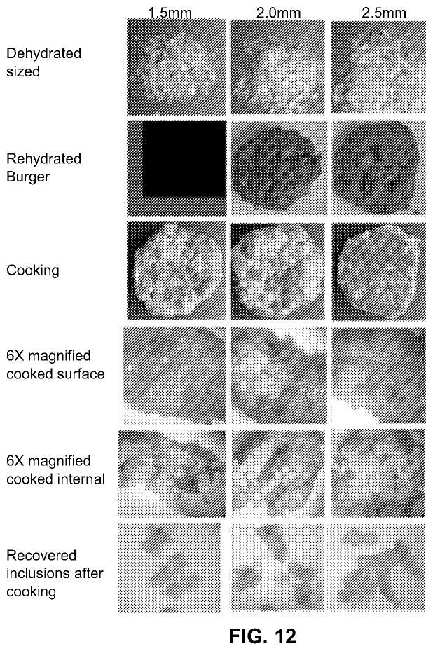

These perimysium samples were combined with the Impossible Burger® burger patty analogue composition as in Example 8. As shown in FIG. 12, the final burger patty analog products did not show much difference visually. But the mouthfeel assessment revealed that perimysium analogs with maximum size at 1.5 mm and 2.0 mm had only a minimal impact on mouthfeel, whereas the 2.5 mm sized pieces provided much more pleasurable and pronounced chewing slide effects. Thus, perimysium analogs sized between 0.75 mm to 2.5 mm provided the best mimicking effect of real animal perimysium.

### Examples 12. Particle Size Optimization, Tendon Analog/Mimic

Optimized composition was determined based on the tendon analogs prepared in Example 7, wherein the ingredients were Rice Protein (Naked Rice™ protein), k-carrageenan, and konjac glucomannan in a 1:1:1 weight ratio and with a 2.5% w/w κ-carrageenan to water as the starting hydration concentration. Processes were the same as Example 7, except in Step 8 after fine particle removal with 0.75 mm mesh, the dehydrated gel pieces were further sifted through a mesh with either 1.5 mm, 2.0 mm, or 2.5 mm holes. Thus, three tendon analog samples were obtained with particles sized between 0.75 mm to 1.5 mm, between 0.75 mm to 2.0 mm, or between 0.75 mm to 2.5 mm.

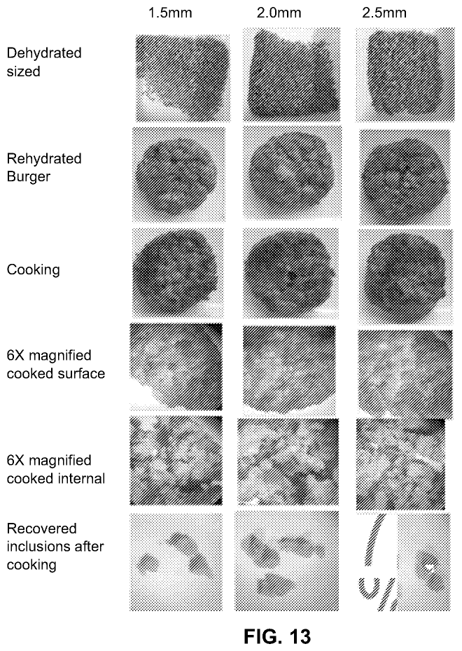

These tendon analogs were combined with the Impossible Burger® burger patty analogue composition as in Example 8. As shown in FIG. 13, the rice protein provided a much more subtle color to the final burger patty analog products. Upon cooking, the rice protein also did not produce the “burnt onion skin” appearance, a drawback when using pea protein. Upon integration and cooking, the tendon analogs provided bouncy and chewy mouthfeel, and the chewy inclusions were not readily broken down with chewing or biting, thus mimicking natural animal tendons.

There was no significant difference in the visual appearance among the three different sizes (as shown in FIG. 13). However, the size did significantly impact mouthfeel. The tendon analogs with 1.5 mm maximum size was barely noticeable in the final burger patty analog products, with 2.0 mm size slightly more pronounced, and 2.5 mm size even more pronounced (though visually less appealing). Thus, the tendon analogs made from rice protein, κ-carrageenan and konjac glucomannan, and with particles sized between 0.75 mm to 2.0 mm provided the best-balanced performance in terms of visual appearance, mouthfeel, and chewing experience.

### Example 13. Rice Protein Optimization, Tendon Analogs/Mimics

For tendon analogs, use of rice protein instead of pea protein could avoid the undesired “burnt onion” appearance once combined with plant-based meat-like bases. To optimize the tendon analog formula, the rice protein was further studied, in which the Naked Rice™ protein used in Example 12 was replaced by three rice proteins from Axiom® Foods, i.e., Original 80 (also called Conventional Oryzatein® 80), Oryzatein® Silk 80 (hereafter Silk 80) and Oryzatein® Silk 90 (hereafter Silk 90). The same steps as in Example 7 (using 0.75 mm and 2.0 mm meshes in Step 8) were followed to obtain three tendon analogs made from the three different rice proteins and combined with Impossible Burger® burger patty analogs.

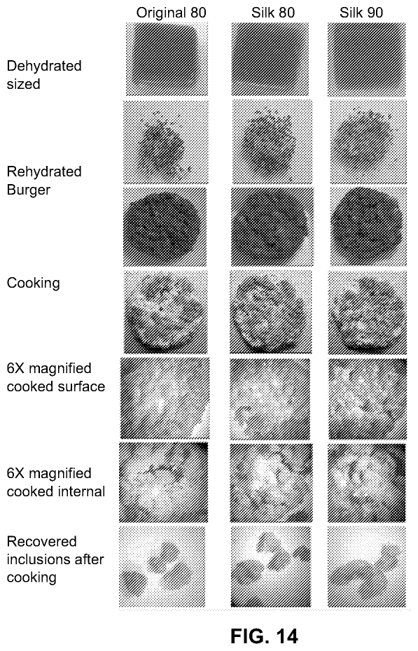

As shown in FIG. 14, apart from the initial color being slightly different, there were no other appreciable differences among three tendon analogs made from Original 80, Silk 80 and Silk 90 rice proteins. All tendon analogs combined well with the Impossible Burger® patty analogue composition, in both uncooked and cooked forms. All had some browning at the surface, but not remarkable. Once cooked, all three tendon analogs presented the same coloration as the Impossible Burger® burger patty analogue composition, and thus were quite difficult to identify. Mouthfeel for all three analogs was also similar, presenting as chewy, bouncy and not readily breaking down upon chewing. Thus, the three rice proteins were equally suitable for making tendon analogs.

### Example 14. Bulk Gel Dehydration/rehydration Analysis

An important aspect of this disclosure is a multi-step hydration, dehydration and subsequent rehydration of the connective tissue analog. Rehydration characteristics are important determinants of the texture and mouthfeel of the final product. These characteristics can also vary greatly with the method of preparation of the PBCTs.

To test the dehydration/rehydration characteristics, bulk gels for the three exemplary PBCTs—cartilage, perimysium and tendon analogs were prepared as described below but under different conditions (bench-scale and pilot-scale). The pilot scale version was in essence a scaled-up version of the bench-scale method, with the same steps and proportions as used to prepare the bench-scale sample. Table 2 provides the dry ingredient composition of the three connective tissue analogs.

TABLE 2
DRY INGREDIENTS FOR THE PLANT
BASED CONNECTIVE TISSUE (PBCT)

| Ingredients (g) for | | | |
|---|---|---|---|
| inclusion with 200 g | | | |
| water | Cartilage | Perimysium | Tendon |
| κ-carrageenan | 6 | 4 | 5 |
| Glucomannan | 0.6 | 0.4 | 5 |
| Gum Arabic | 0.6 | 0.4 | 0 |
| Rice protein | 0 | 0 | 5 |

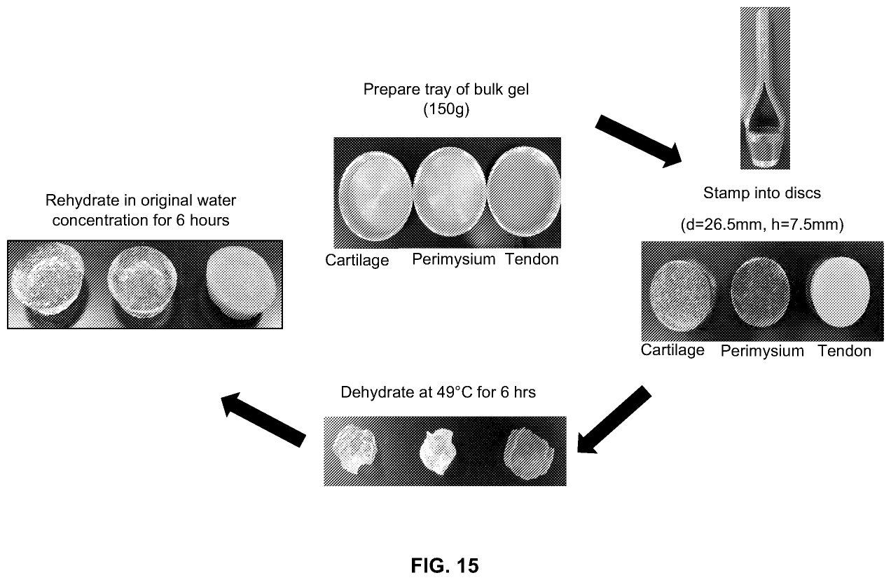

Briefly, the dry ingredients were weighed and mixed for a single batch formulation of each of the cartilage, perimysium and tendon analogs. 200 ml (200 g) of water (per provided dry formulation in Table 2) was heated in a beaker on a hot plate to 70° C. with stirring. Dry ingredients were added slowly over the course of 2.5 minutes with continuous stirring, scraping the sides of the beaker and breaking up any clumps with a metal whisk. Stirring was continued for another 2.5 minutes after the addition of all the ingredients. 150 g of each of the gels was poured into separate 6″ metal cake pans and allowed to set for 1 hr. The gels were cut into cylinders of dimensions d=26.5 mm, h=7.5 mm, with a metal punch (about 12 per tray). The cylinders were removed from the trays and weighed to determine the fresh weight. Six of each of the bulk gels were used for initial testing with a Instron instrument as provided in Example 14. The remaining six were dehydrated at 49° C. for 6 hours, flipping the discs over after 2 hrs and again after 4 hrs. The dehydrated gels were stored overnight in a Tupperware container. The dehydrated gel discs were weighed in the morning to calculate the amount of water lost. The gels were then rehydrated in 200 ml of water for 6 hrs. The hydration characteristics and mechanical properties of the dehydrated and rehydrated gels were tested using the Instron instrument. FIG. 15 show photographs taken at each step of the bench-scale gel dehydration/rehydration procedure for the three exemplary connective tissue analogs. The comparative hydration data for bench-scale and pilot-scale gels is provided below in Table 3.

TABLE 3
HYDRATION RATIO (AVERAGE OF N SAMPLES (STANDARD
DEVIATION)) OF BENCH-SCALE AND PILOT SCALE
CONNECTIVE TISSUE ANALOG SAMPLES

| | Bench- | Bench- | Bench- | | | |
|---|---|---|---|---|---|---|
| | scale | scale | scale | Pilot-scale | Pilot-scale | Pilot-scale |
| Parameter | Cartilage | Perimysium | Tendon | Cartilage | Perimysium | Tendon |
| (Av(SD)) | N = 18 | N = 18 | N = 18 | N = 12 | N = 12 | N = 12 |
| Initial | 23.688 | 35.779 | 11.816 | 17.074 | 24.815 | 7.378 |
| hydration ratio | (0.553) | (1.056) | (0.451) | (0.811) | (1.348) | (0.519) |
| (g water:g | | | | | | |
| PBCT) | | | | | | |
| Rehydration | 17.074 | 24.815 | 7.378 | 17.289 | 19.180 | 6.397 |
| ratio | (0.811) | (1.348) | (0.519) | (3.083) | (2.118) | (0.476) |
| (g water:g | | | | | | |
| PBCT) | | | | | | |
| Percent | 73.2 | 70.2 | 65.4 | 54.0 | 56.4 | 55.3 |
| hydration from | (2.9) | (2.8) | (3.5) | (6.4) | (5.8) | (3.5) |
| original (%) | | | | | | |

As seen from the data in Table 3, dehydrated plant based connective tissues samples (PBCT), when rehydrated in original water concentration for 6 hours did not achieve full rehydration to their original water concentration. However, freshly prepared bench-scale samples had higher initial hydration ratios and higher rehydration ratios than pilot-scale samples. Similarly, bench-scale samples reabsorbed more of their original water in 6 hours than pilot-scale samples. For both bench-scale and pilot samples, the highest hydration ratios were observed for perimysium, followed by cartilage and then tendon. For bench-scale samples, cartilage re-absorbs the most water, followed by perimysium and then tendon; for pilot samples, perimysium re-absorbs the most water, followed by tendon and then cartilage.

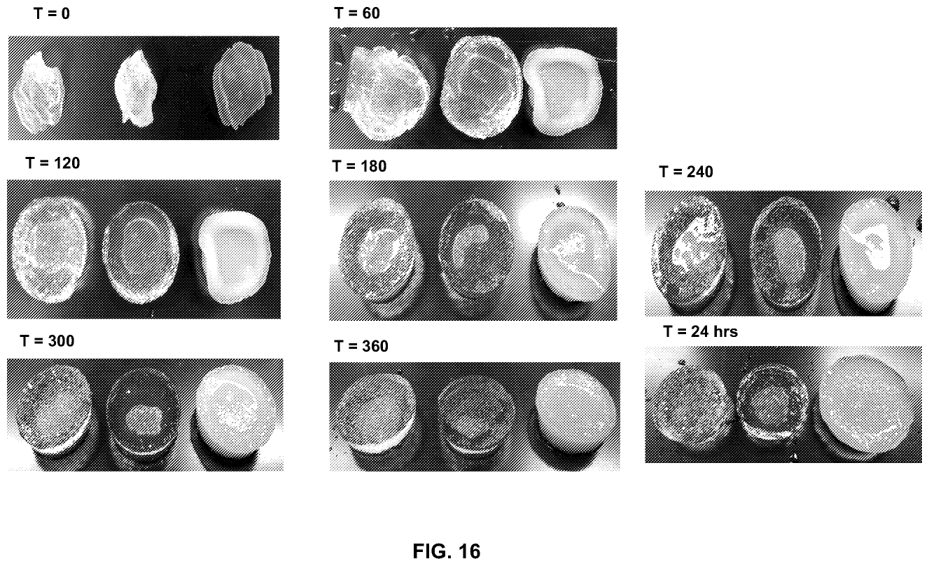

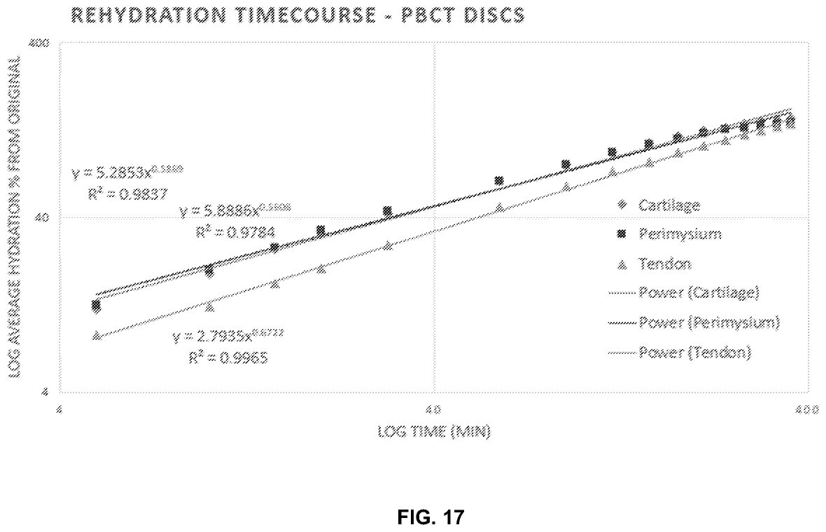

FIG. 16 provides photographs taken at regular intervals during the rehydration process of bench-scale connective tissue samples. A plot of the log average hydration % from original vs log time (min) for bench-scale samples (FIG. 17 and Table 4) suggests that rehydration follows a power law distribution.

TABLE 4
PERCENT HYDRATION OF EXEMPLARY PBCTS.

| Result | Cartilage (n = 4) | Perimysium (n = 4) | Tendon (n = 4) |
|---|---|---|---|
| Coefficient | 5.2853 | 5.8886 | 2.7935 |
| Power | 0.5869 | 0.5606 | 0.6722 |
| Time to 100% | 150 | 156 | 205 |
| hydration (min) | | | |
| Hydration from | 170 | 137 | 260 |
| original at | | | |
| 24 hrs (%) | | | |

There is no difference in the rehydration rates between cartilage and perimysium analog discs, both have a faster rehydration rate than the tendon analog disc. After 24 hours in excess water, the connective tissue gels swell above their original water concentrations: tendon absorbs—260%, cartilage—170%, and perimysium—137% of water in comparison to its initial hydration level.

### Example 15. Mechanical Testing

Compression characteristics are important determinants of the desirability of meat analogs since the first step of consumption is compression during bite-down. Instruments like Instron Universal testing machines are used to provide constant or variable compression. The small to large strain deformation behavior can be collected ranging from the linear region to failure in a compression, tension or puncture configuration. The linear region Young's Modulus can be calculated and additional measures including non-linear pre-failure behavior and non-linear modulus, maximum force and strain at failure, minimum force and strain after failure, and force and strain at terminal failure all can be obtained. Compression speeds of but not limited to 0.01 mm/s to about 50 mm/s may be used.

For these tests, PBCTs were prepared essentially as in Example 14. The hydrogels were poured into a petri dishes (85 mm diameter; 10 mm height) while still hot then compressed with glass and allowed to cool to room temperature. Samples were dehydrated then rehydrated with excess water overnight . Cylinders were cut from the gel using a circular cookie cutter (12 mm diameter; ˜7 mm height). Compression tests were carried out on an Instron 5900R 5584 with a 1kN load cell at 25° C. and a rate of 10 mm/min using Bluehill Universal software. The maximum compressive stress is reported as the average (standard deviation) (n=10)—see Table 5.

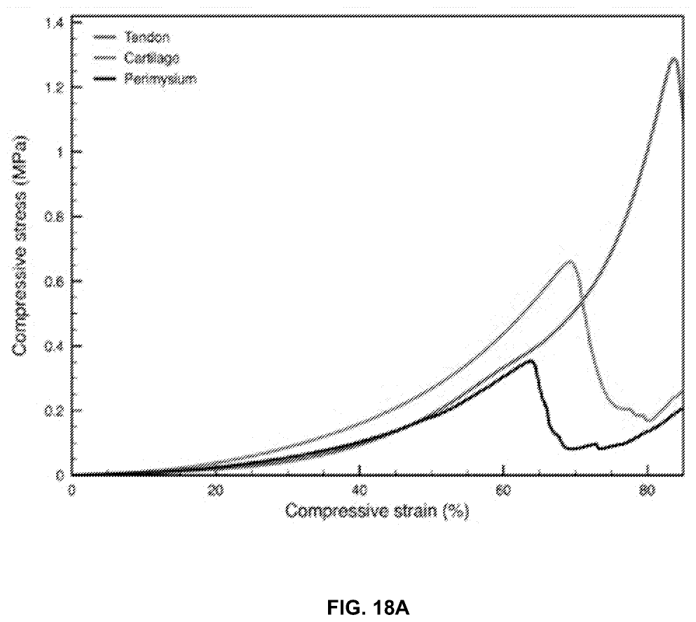

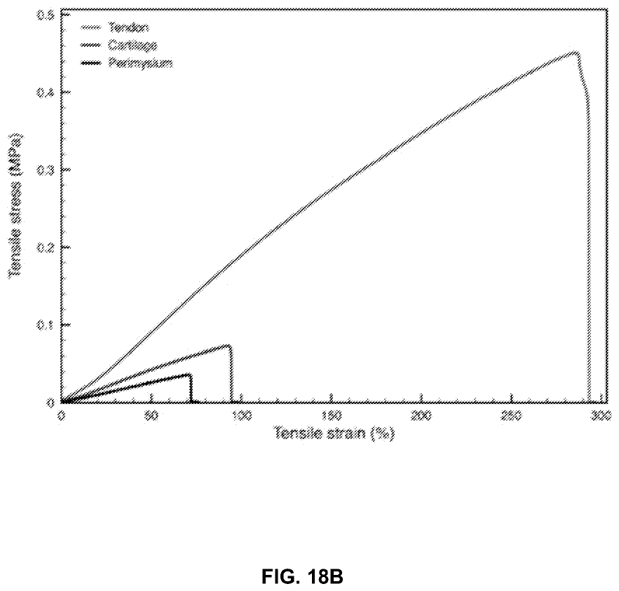

The plant-based connective tissues were characterized using compressive and tensile tests. The relationship between compressive stress and compressive strain was exponential (FIG. 18A). Cartilage and perimysium could be compressed to between 60 and 70% of their initial heights before fracturing while tendon fractured after 80% displacement. Tendon had a significantly greater maximum compressive stress than cartilage and perimysium (Table 5). The same trend was observed for maximum tensile stress (tendon>>cartilage>perimysium). However, the relationship between tensile stress and tensile strain was almost linear (FIG. 18B). Cartilage and perimysium were more brittle than tendon stretching to less than 100% of their initial length before breaking. Alternatively, tendon could be stretched to almost three times its initial length. The Young's Modulus of the plant-based connective tissues was calculated between 5 and 20% tensile strain (Table 5). Tendon had the largest Young's Modulus and perimysium had the smallest.

TABLE 5
COMPRESSIVE AND TENSILE PARAMETERS OF PLANT-BASED
CONNECTIVE TISSUE (reported as average (SD))

| | Maximum | | |
|---|---|---|---|
| | Compressive | Maximum Tensile | Young's |
| | Stress (kPa) | Stress (kPa) | Modulus (kPa) |
| Cartilage | 660 (26) | 77 (11) | 82 (10) |
| Perimysium | 353 (24) | 36 (8) | 44 (5) |
| Tendon | 1263 (405) | 455 (34) | 144 (6) |

### Example 16: Comparison of Constant Speed Compression Characteristics of Connective Tissue Analog Samples Produced at Bench-scale and Pilot-scale

Further tests were done with bench-scale and pilot-scale samples prepared essentially as provided in Example 14 to determine compression parameters. The pilot scale version was in essence a scaled-up version of the bench-scale method, with the same steps and proportions as used with the bench-scale sample. Compression characteristics were measured using the Instron 5900R 5584 with a 1 kN load cell at 25° C. for two different rates of 0.01 mm/s (low) and 50 mm/s [high, (50 mm/s represents the typical closing velocity of the jaw and teeth on bite down)] using Bluehill Universal software. Tests were done to 70% compressive strain or a maximum force of 450N. The top and bottom platen of the Instron 5900R 5584 were lined with sandpaper to prevent sample slips.

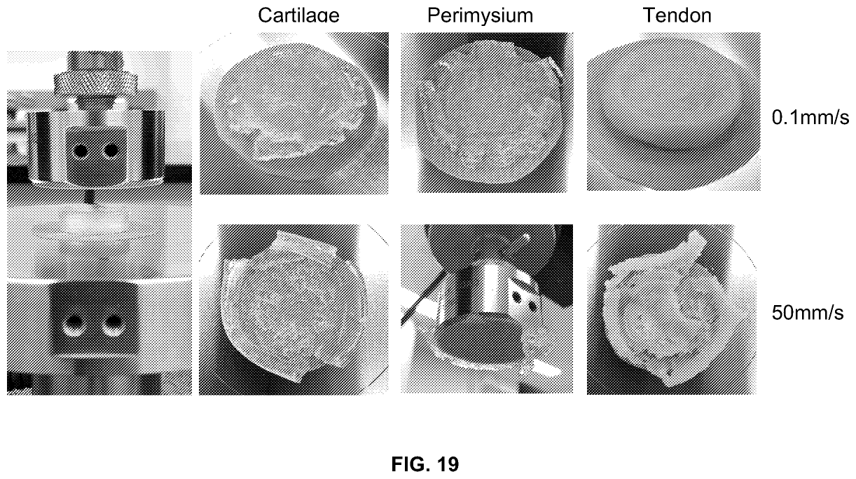

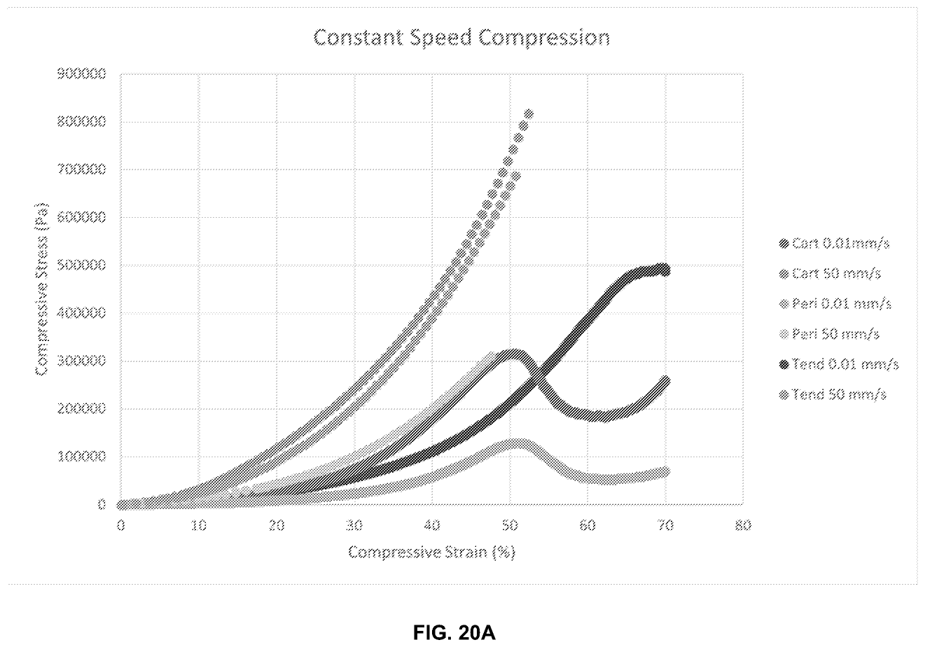

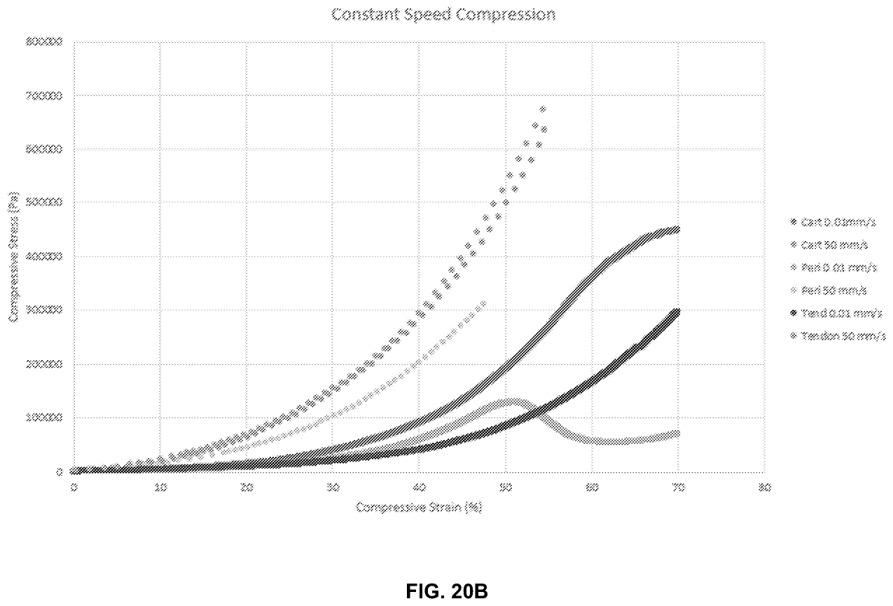

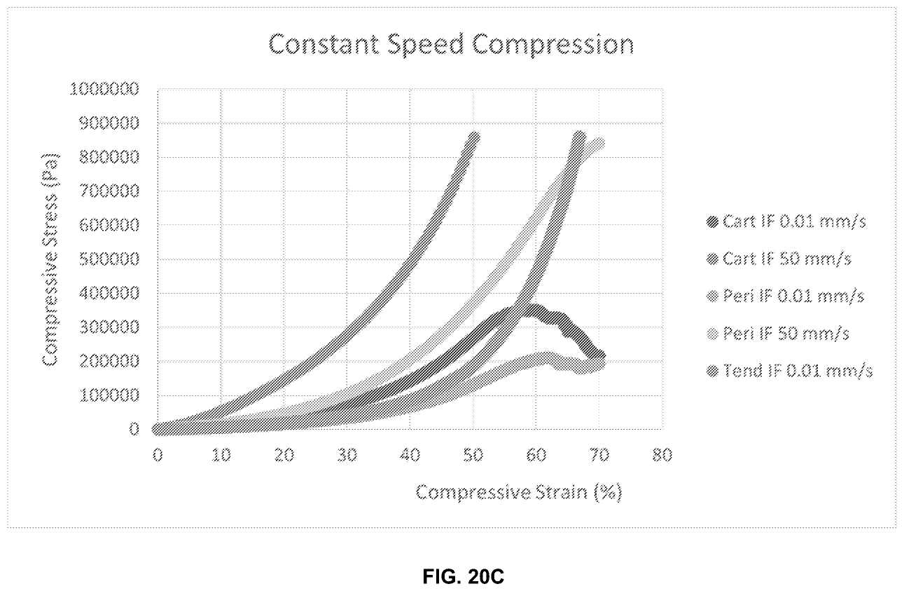

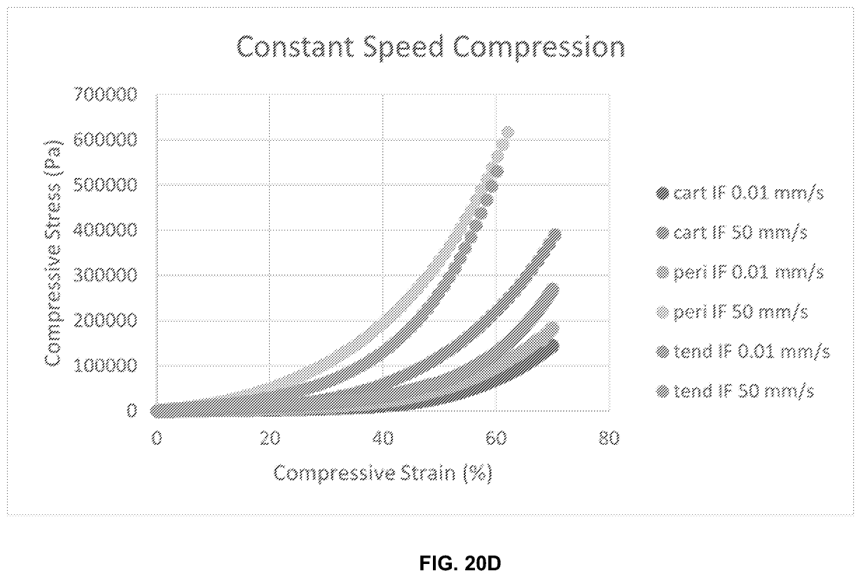

Young's Modulus quantifies the relationship between tensile/compressive stress (force per unit area) and axial strain (proportional deformation) in the linear elastic region of a material, and was calculated from the linear slope of the stress vs strain curve, from 5%-20% compressive strain as shown in Table 6. FIG. 19 shows the deformation seen at fast and slow speed compression for cartilage, perimysium, and tendon analogs respectively. FIG. 20 shows the compressive stress versus strain curves from constant speed compression experiments used to calculate the Young's Moduli for (A) bench-scale fresh cartilage, perimysium and tendon analog gels, (B) bench-scale rehydrated cartilage, perimysium and tendon analog gels, (C) pilot-scale fresh cartilage, perimysium and tendon analog gels, (D) pilot-scale rehydrated cartilage, perimysium and tendon analog gels.

TABLE 6
YOUNG'S MODULUS FOR FRESH AND REHYDRATED GELS [reported
as average (SD), calculated from the (linear) slope of
stress vs. strain curve from 5%-20% compressive strain).

| | | Com- | | | | |
|---|---|---|---|---|---|---|
| | | pression | | Cartilage (C) | Perimysium | Tendon (T) |
| Gel | | Speed | N | Modulus* | (P) Modulus* | Modulus* |
| Preparation | Scale | (mm/s) | (C, P, T) | (kPa) | (kPa) | (kPa) |
| Fresh | Bench | 0.01 | 6, 7, 7 | 175.2 (19.6) | 54.6 (9.0) | 166.0 (14.0) |
| Fresh | Bench | 50 | 8, 7, 7 | 709.6 (169.0) | 279.5 (44.8) | 566.5 (53.0) |
| Dehydrated/ | Bench | 0.01 | 7, 8, 7 | 66.7 (13.6) | 45.4 (16.7) | 50.7 (6.1) |
| rehydrated | | | | | | |
| Dehydrated/ | Bench | 50 | 8, 7, 7 | 265.7 (81.0) | 150.4 (54.6) | 262.0 (88.1) |
| rehydrated | | | | | | |
| Fresh | Pilot | 0.01 | 4, 4, 4 | 239.8 (23.0) | 100.3 (7.4) | 110.8 (8.0) |
| Fresh | Pilot | 50 | 4, 3, 3 | 771.1 (129.3) | 276.5 (14.5) | 445.6 (39.8) |
| Dehydrated/ | Pilot | 0.01 | 4, 4, 4 | 19.2 (1.8) | 29.4 (5.4) | 222.3 (70.1) |
| rehydrated | | | | | | |
| Dehydrated/ | Pilot | 50 | 4, 4, 4 | 44.9 (6.6) | 52.0 (11.4) | 164.9 (11.0) |
| rehydrated | | | | | | |

Results show that for all samples low speed compression (0.01 mm/s) have lower moduli than high speed compression (50 mm/s) and fresh gels have higher moduli than dehydrated/rehydrated gels. For fresh gels (bench-scale and pilot-scale) the modulus for cartilage is greater than the modulus for tendon which is greater than the modulus for the perimysium. Similarly, for bench-scale dehydrated/rehydrated gels, the modulus for cartilage is greater than the modulus for tendon which is greater than the modulus for the perimysium. However, for pilot-scale dehydrated/rehydrated gels, the modulus for tendon was found to be greater than the modulus for perimysium, which is greater than the modulus for cartilage, thereby effectively reversing the trend seen with fresh samples.

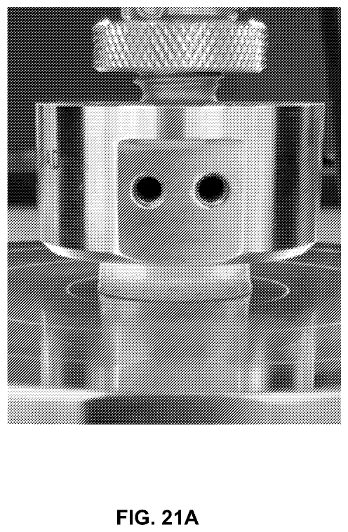

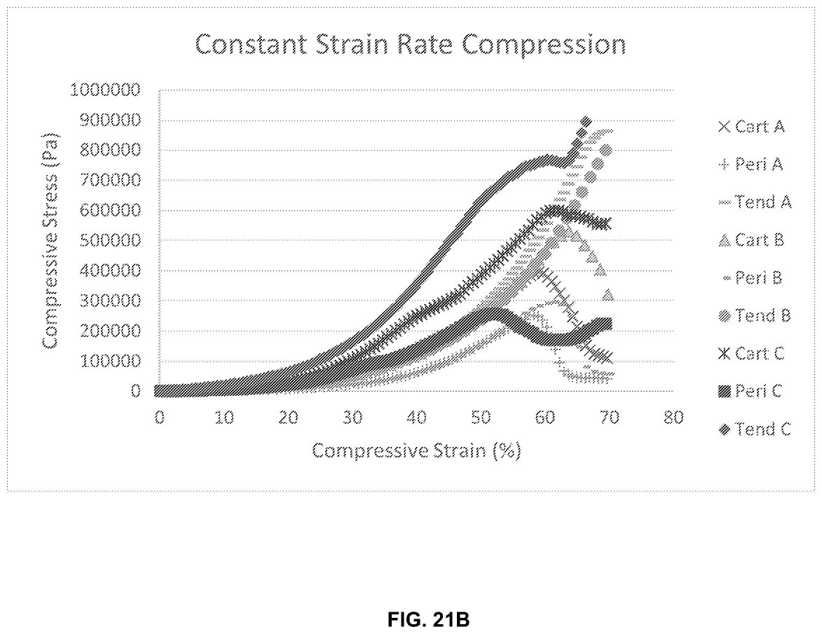

These experiments were repeated for bench-scale fresh samples using the Instron 5900R 5584 wherein the sandpaper on the top and bottom platen was replaced with a drop of sunflower oil at both surfaces. Coating the Instron platens with oil creates a (nearly) frictionless environment between the surfaces and causes slip, while sandpaper creates friction between the surfaces and prevents slip. FIG. 21(A) shows the Instron compression set-up with oil coated platens and FIG. 21(B) shows the compressive stress versus strain curves for constant rate compression of fresh gels when the platen is lubricated with oil. The results show that all three exemplary PBCTs exhibit hydrogel-like mechanical properties at low compression speeds under these conditions.

### Example 17. Compression Test at Different Hydration Levels, of Rehydrated Connective Tissue Analogs

Compression characteristics can vary dramatically at different level of hydration. As such the next step was to determine the compression characteristics and other mechanical properties of the differentially hydrated samples.

Plant based connective tissue analogs (PBCT) were prepared as previously shown in Example 14 except that the warm gel, post stirring, was poured into an aluminum plate, compressed slightly with glass, and allowed to cool at room temperature. Cylinders (1.5 cm in height and 1 cm in diameter) were cut from the slab using a cookie cutter. Cylindrical samples were dehydrated at 50° C. for 8 hrs and then rehydrated in excess water. The gels were removed from the water when they reached the desired water concentration as provided below:
a) 85% H₂O—1 g PBCT dry weight/6 g H₂O
b) 75% H₂O—1 g PBCT dry weight/3 g H₂O
c) 65% H₂O—1 g PBCT dry weight/2 g H₂O

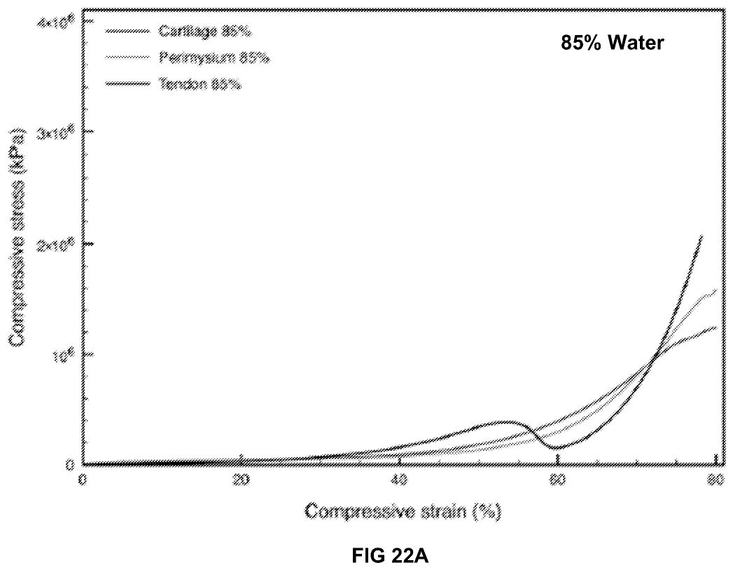

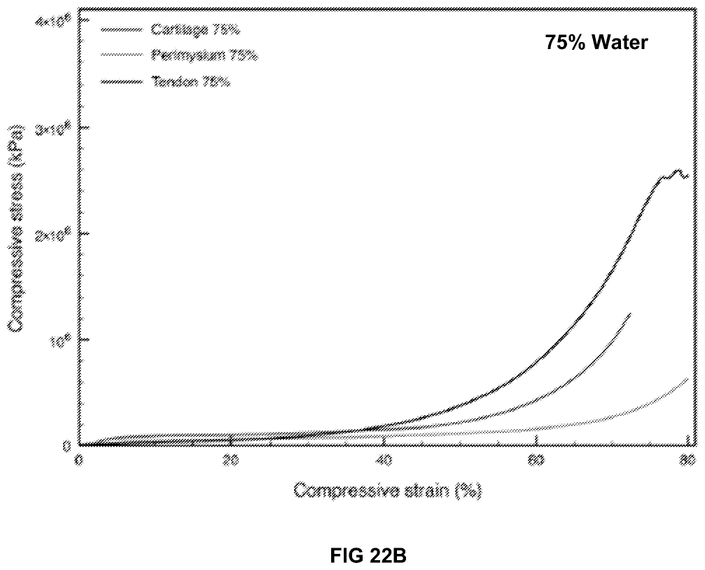

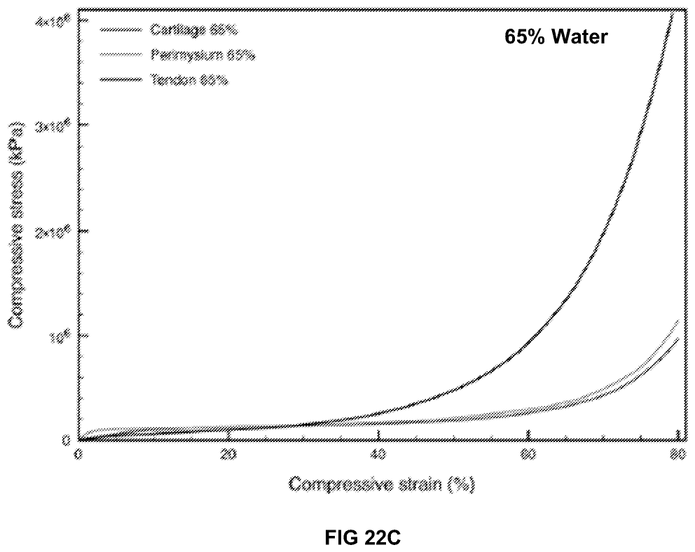

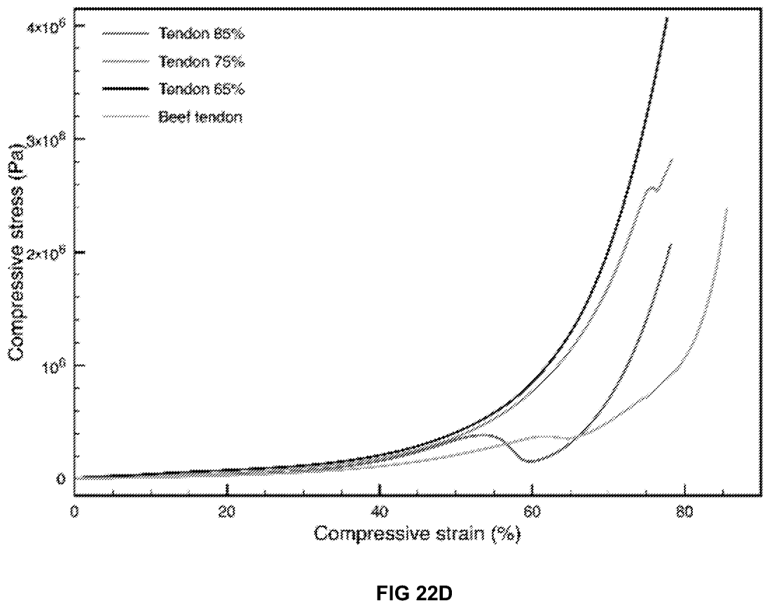

Samples were compressed at 10 mm/min with 10-13 repeats per PBCT and per water concentration. FIG. 22(A-C) shows plots of compressive stress vs compressive strain data of the three exemplary PBCTs at different levels of hydration. Compression tests were performed using the Instron 5900 5584 with a 1 kN load cell at 25° C. at a rate of 10 mm/min using Bluehill Universal software. Young's modulus was calculated as before using segment from 5% to 20% of the plots. Table 7 provides the calculated Young's Moduli [Average (standard deviation)].

TABLE 7
YOUNG'S MODULI (kPa) FOR PBCTs
AT DIFFERENT HYDRATION LEVELS

| | |
|---|---|
| Connective tissue | Young's Modulus (kPa) Average(SD) |

| analog | 85% H₂O | 75% H₂O | 65% H₂O |
|---|---|---|---|
| Cartilage | 170(26) | 191(50) | 349(92) |
| Perimysium | 123(25) | 129(40) | 170(78) |
| Tendon | 164(9) | 242(14) | 351(28) |

As seen earlier, tendon analogs had a significantly greater maximum compressive stress than cartilage and perimysium analogs. Results also show that tendon analogs had the lowest error because it retained its cylindrical shape best upon dehydration. It is conceivable that errors may be lower if the cylinders are cut after the slabs are dehydrated. FIG. 22(D) provides a comparison of PBCT tendon and beef tendon. Beef tendon can be compressed to higher levels in comparison to PBCT tendon analogs.

### Example 18. Tensile Strength of Rehydrated Connective Tissue Analogs With Different Hydration Levels

Tensile strength is an important mechanical property of connective tissue useful for measuring the modulus under tension, which is helpful for making conclusions about the network structure. The tensile strength, like compression, also changes with the level of hydration of the sample PBCT.

Plant based connective tissue analogs (PBCT) were prepared as previously shown in Example 14 except that the warm gel, post stirring, was poured into an aluminum plate with a 3 mm raised border, compressed slightly with glass and allowed to cool at room temperature. The sheets of gels thus obtained were dehydrated for 4 hr at 50° C. and then rehydrated to their desired water concentration as provided below:
a) 85% H₂O—1 g PBCT/6 g H₂O
b) 75% H₂O—1 g PBCT/3 g H₂O
c) 65% H₂O—1 g PBCT/2 g H₂O

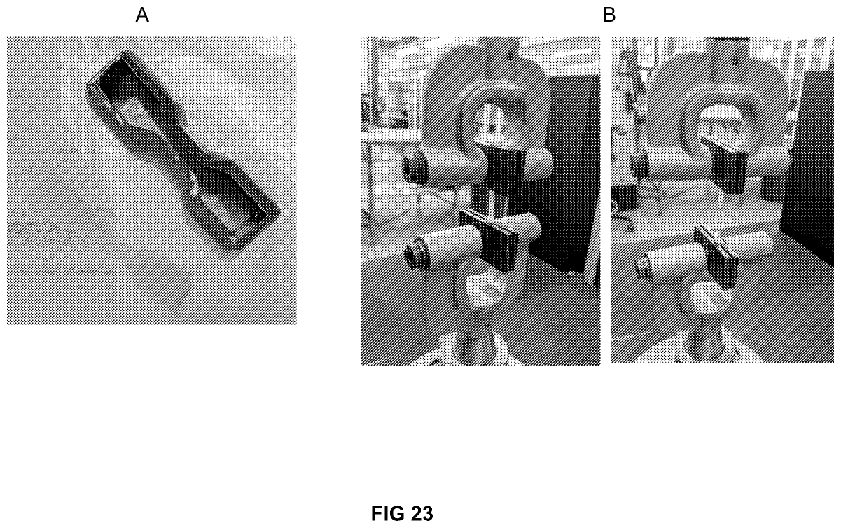

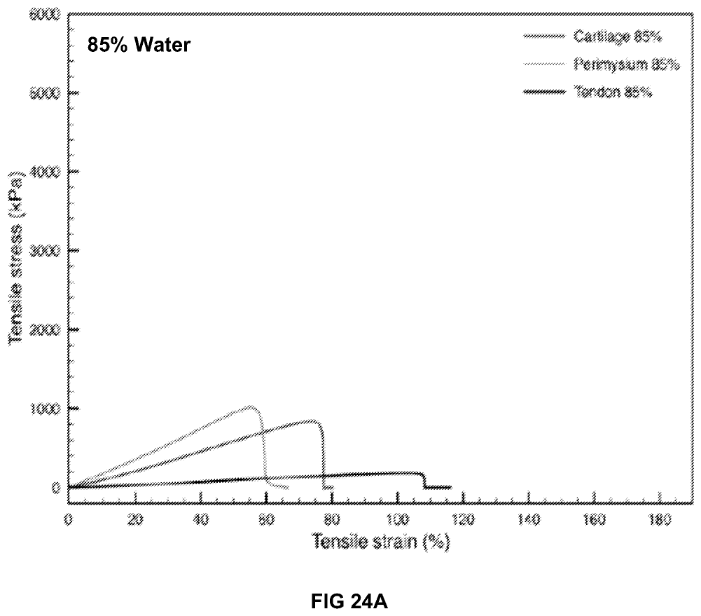

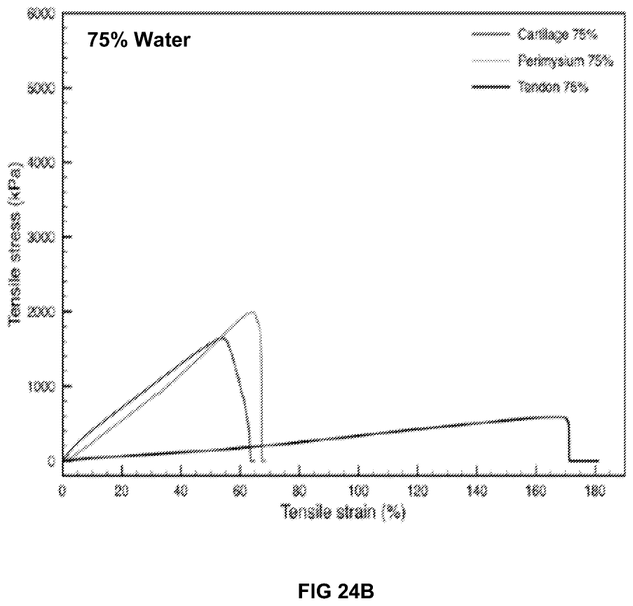

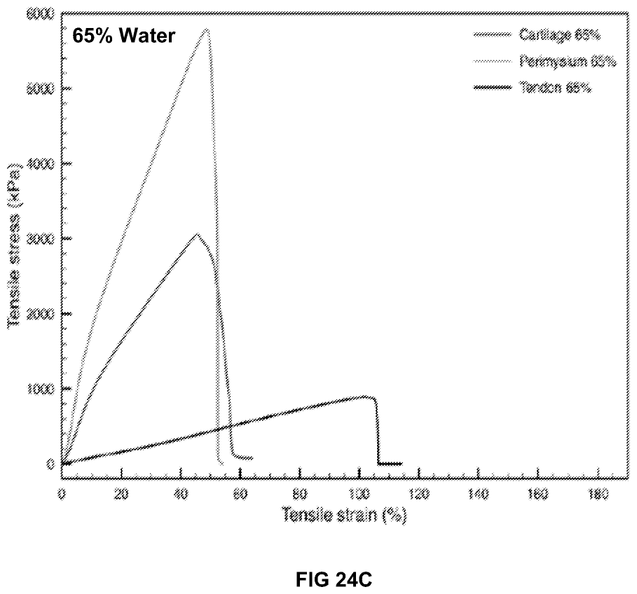

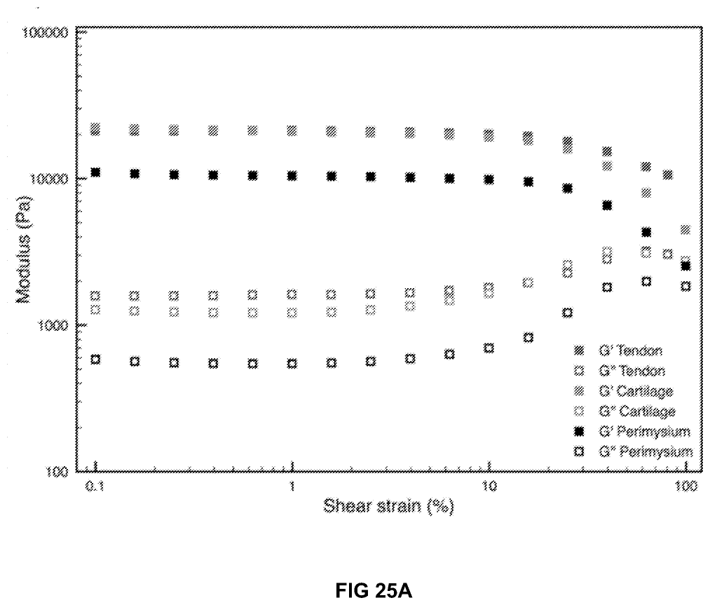

“Dog bones” of 20 mm length and 3 mm width were cut from the sheets. Tension tests were carried out on an Instron 5900R 5584 with a 100N load cell and manual grips at 25° C. (as shown in FIG. 23) and a rate of 10 mm/min using Bluehill Universal software. The maximum tensile stress and Young's Modulus were calculated from plots of tensile stress vs tensile strain as shown in FIG. 24(A-C) and reported as the average [(standard deviation), (n=10)] in Table 8 and Table 9. Modulus was calculated using segment from 5% to 15% tensile strain.

TABLE 8
TENSILE TESTS - MODULUS (KPa) FOR PBCT
WITH DIFFERENT HYDRATION LEVELS

| Connective tissue | Modulus (kPa) Average(SD) | | |
|---|---|---|---|
| analog | 85% H₂O | 75% H₂O | 65% H₂O |
| Cartilage | 1100(200) | 3100(600) | 11000(5000) |
| Perimysium | 2000(400) | 3100(700) | 14000(3000) |
| Tendon | 150(30) | 310(40) | 750(70) |

TABLE 9
TENSILE TESTS - MAXIMUM TENSILE STRESS (kPa)
FOR PBCT WITH DIFFERENT HYDRATION LEVELS

| Connective tissue | Maximum tensile stress (kPa) Average(SD) | | |
|---|---|---|---|
| analog | 85% H₂O | 75% H₂O | 65% H₂O |
| Cartilage | 800(100) | 1700(400) | 4000(800) |
| Perimysium | 1000(100) | 2100(500) | 6000(2000) |
| Tendon | 190(10) | 600(50) | 900(80) |

These data show that the Modulus and error both increase with decreasing water concentration. The same trend, as with compression, was observed for maximum tensile stress (tendon>cartilage>perimysium). However, the relationship between tensile stress and tensile strain was almost linear unlike for compression. As shown in FIG. 24, cartilage and perimysium were more brittle than tendon stretching to less than 100% of their initial length before breaking. Tendon could be stretched to almost three times its initial length.

### Example 19. Rheological Characterization of Exemplary Plant-based Connective Tissue

Rheological characteristics of connective tissue help determine how the analogs deform and flow under different conditions for instance with heating and cooling. For rheological characterization, using a rheometer or similarly designed rheological property measurement equipment, the small and large strain oscillatory shear properties of materials can be measured, including elastic and loss modulus, creep behavior and creep compliance, recovery behavior and recovery time and residual stress. As an example of one such measurement and analysis, a constant stress can be applied (so called creep test) followed by a cessation of applied stress (so called recovery test). This data can be combined with Instron testing data to calculate physical properties such as axial modulus, shear modulus, Poisson's ratio, permeability and poroelastic time (as detailed in Lopez-Sanchez et al., Biomacromolecules, 15 (6), pp 2274-2284 (2014). For these measurements compression speeds of, but not limited to, 0.33 to 33 μm/s and axial compression of, but not limited to 10-100 μm per compression cycle and oscillatory strain within the linear viscoelastic region and frequencies of, but not limited to, 0.01 to 1000 Hz may be used. Rheological data for exemplary PBCTs is provided below.

To perform these experiments PBCT samples were made essentially as in Example 18. Discs were cut from the sheet of plant-based connective tissue using a Craftright Precision Craft Knife. Rheological characterization was carried out on an Anton Paar Modular Compact Rheometer MCR502 with a 50 mm sandpapered (P80) parallel plate geometry at 25° C. using RheoCompass software. Amplitude sweeps were measured at a frequency of 1 Hz. Further rheological characterization was carried out on a Thermo Scientific HAAKE MARS Modular Advanced Rheometer System with a 35 mm serrated parallel plate geometry using RheoWin software. Temperature sweeps were measured at a rate of 0.1° C./s, shear stress of 10 Pa and frequency of 1Hz. All rheological characterization was performed in triplicate and repeated on samples that were dehydrated then rehydrated overnight with excess water.

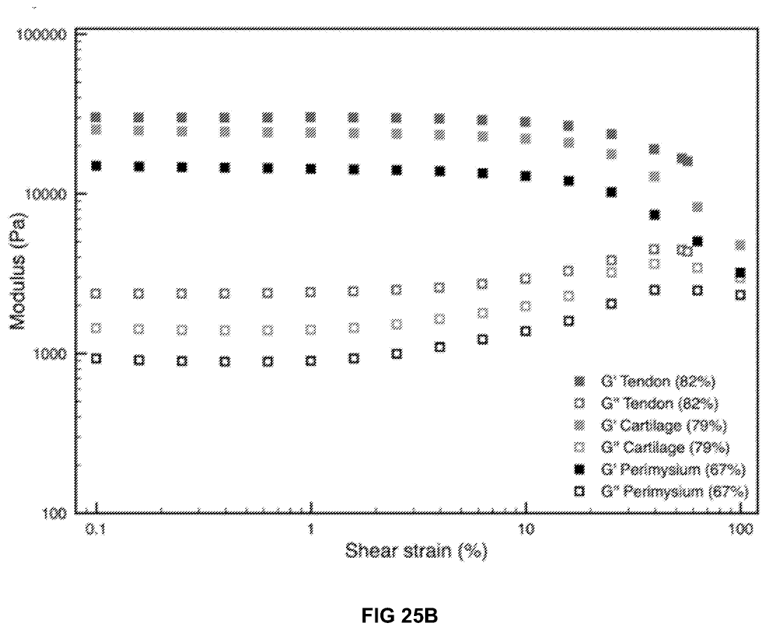

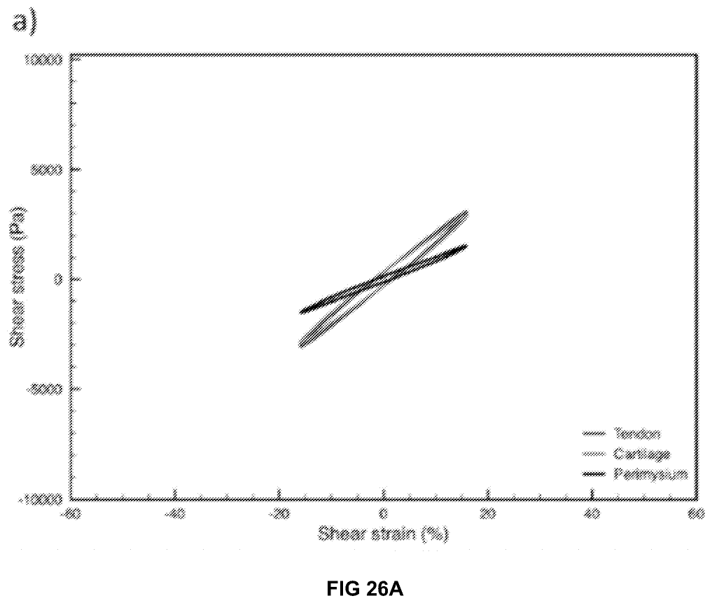

Overall, a broad linear viscoelastic region, spanning from 0.1 to 10% shear strain, was observed in the amplitude sweeps of the PBCTs (FIG. 25A). Across this region, G′ was greater than G″ indicating viscoelastic solids. The magnitude of both G′ and G″ was the same for tendon and cartilage. This similarity was unexpected since tendon is three times as concentrated as cartilage. However, the concentration of kappa carrageenan is the same. The magnitude of both G′ and G″ was lower for perimysium.

Rheological characterization was also used to determine the effect of dehydration and rehydration on the viscoelastic behavior of the plant-based connective tissues (FIG. 25B). The magnitude of both G′ and G″ was slightly larger following dehydration and rehydration. This stiffening may be attributed to a decrease in water concentration. Dehydrated tendon, cartilage and perimysium could only be rehydrated to 82, 79 and 67% of their initial water concentrations, respectively.

### Large Amplitude Oscillatory Shear

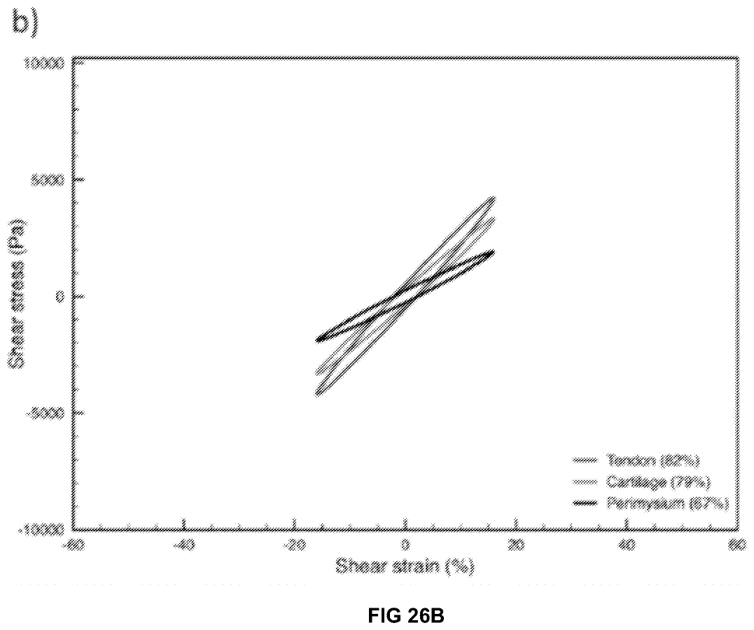

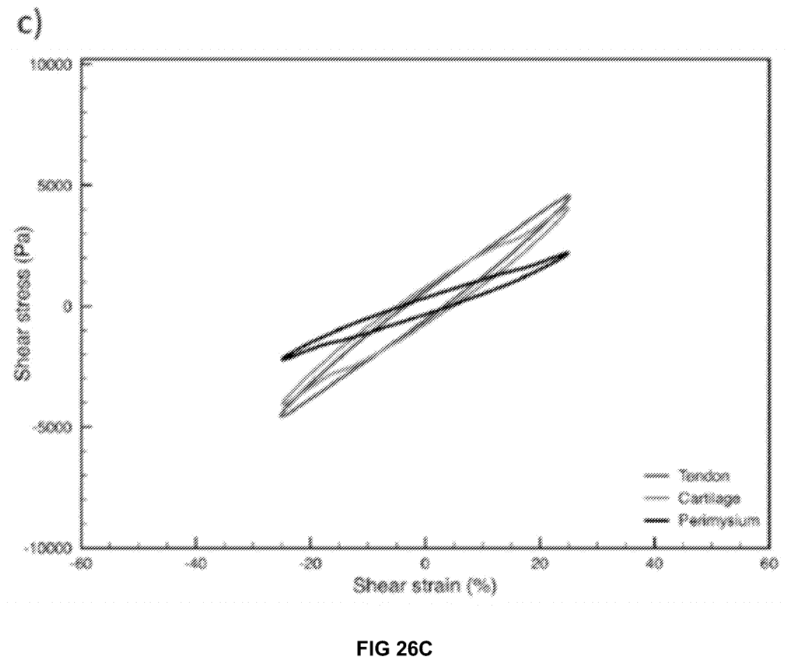

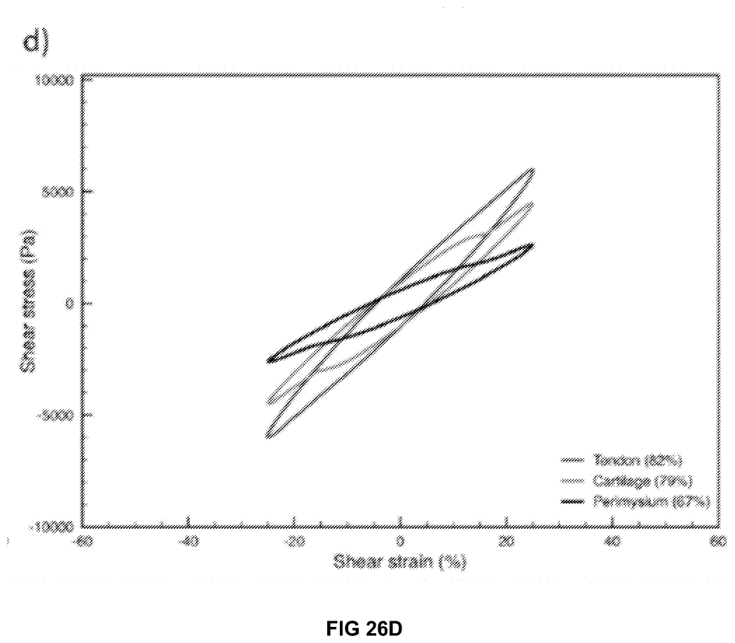

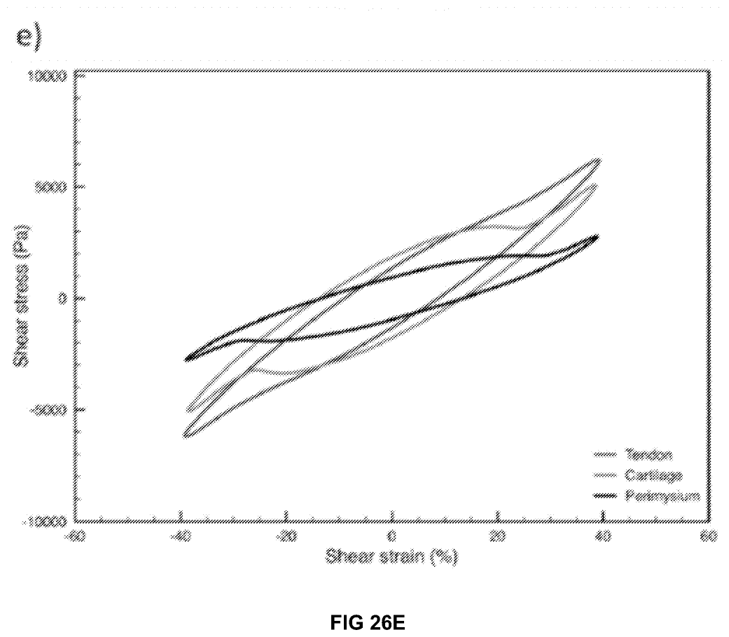

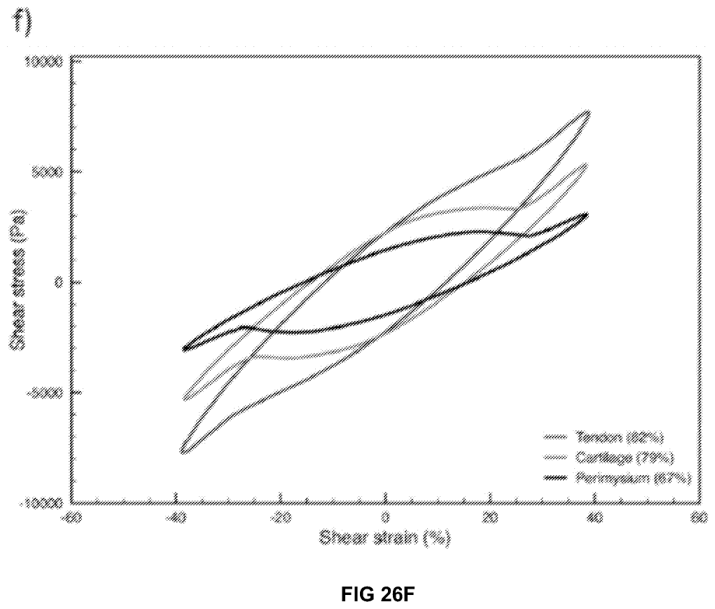

Due to the unexpected similarities across the linear viscoelastic region, the non-linear properties of the plant-based connective tissues were characterized using rheological fingerprinting. At 16% shear strain, the shape of the curves was elliptical indicating linear viscoelastic behavior (FIGS. 26A and 26B). The gradient of both the secant and the tangent were similar for tendon and cartilage but shallower for perimysium. This supports what was observed in the linear viscoelastic region of their amplitude sweeps (FIG. 25).

At 25% shear strain, the shape of the cartilage and perimysium curves was no longer elliptical indicating nonlinear viscoelastic behavior (FIG. 26C and 3D). However, the shape of the tendon curves was still elliptical. Tendon's greater resistance to non-linear deformation suggests it has a greater toughness than the other samples. The gradient of both the secant and the tangent was steepest for tendon and shallowest for perimysium. The same trend was observed at 40% shear strain (FIGS. 26E and 26F). Additionally, all curves were no longer elliptical. Above 40% shear strain slipping was observed.

### Effect of Temperature on Rheology

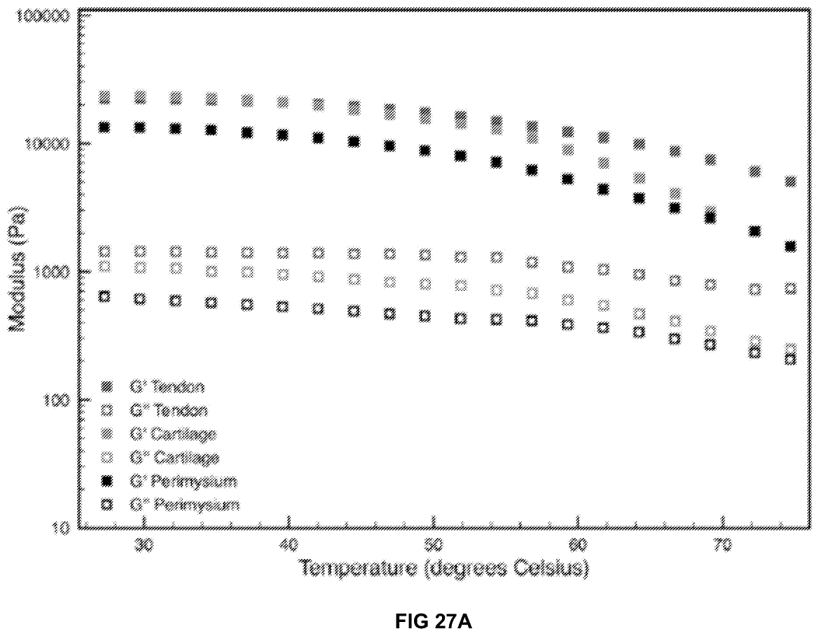

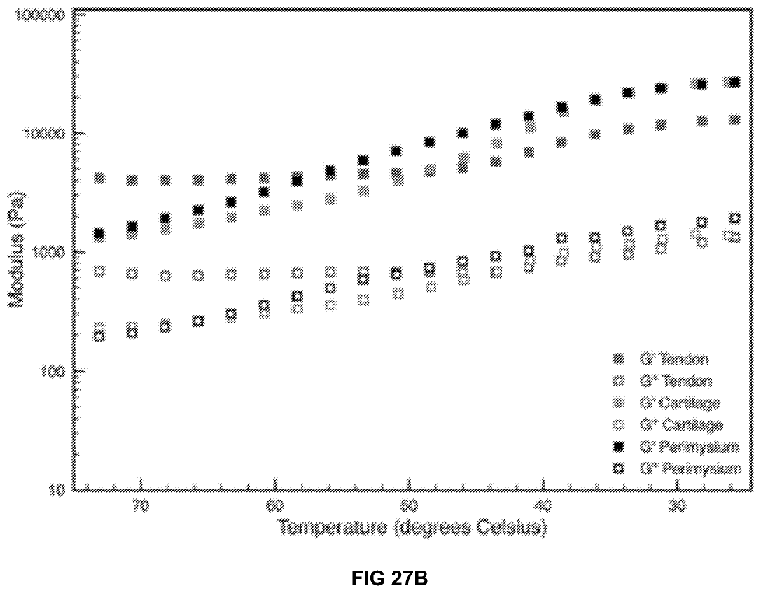

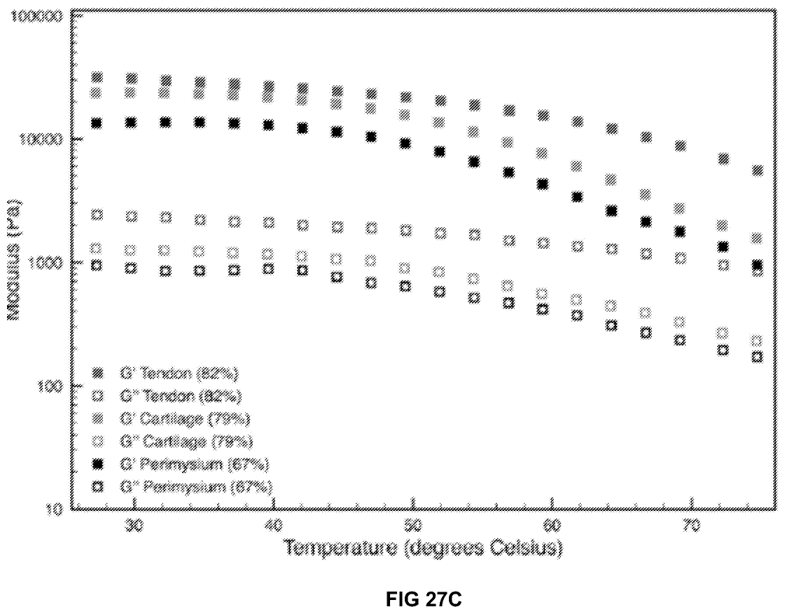

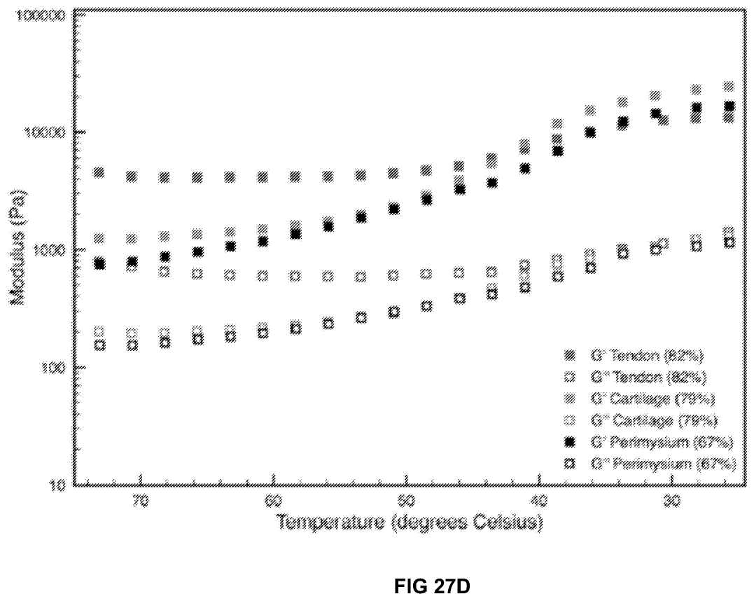

Rheological characterization was also used to determine the effect of temperature on the viscoelastic behavior of the plant-based connective tissues (FIG. 27A-D). Across the investigated temperature range, G′ remained greater than G″. The magnitude of both G′ and G″ decreased with increasing temperature but recovered with decreasing temperature. Interestingly, perimysium had a higher modulus following heating and cooling than tendon (FIGS. 27B and 27D).

To conclude small amplitude oscillatory shear measurements determined the storage modulus (G′) was greater than the loss modulus (G″) across the linear viscoelastic region, indicating hydrogels. The magnitude of both G′ and G″ was the same for tendon and cartilage, which was higher than that of perimysium. All samples remained hydrogels (i.e. G′ remained greater than G″) when heated from 25° C. to 75° C. The magnitude of both G′ and G″ decreased with increasing temperature but recovered with decreasing temperature. Further, dehydrated tendon, cartilage and perimysium could only be rehydrated to 82, 79 and 67% of their initial water concentrations, respectively. The magnitude of both G′ and G″ was slightly larger than they were before dehydration and rehydration. Large amplitude oscillatory shear measurements determined tendon was more resistant to non-linear deformation, suggesting it is tougher than cartilage and perimysium.

### Example 20. Scanning Electron Microscopy (SEM)

Scanning electron microscopy (SEM) was used to study the internal structure of the three exemplary PBCTs. Samples were dehydrated to avoid imaging water crystallization.

Dehydrated plant-based connective tissue prepared essentially as in example 17, were frozen in liquid nitrogen then fractured using tweezers. Samples were coated with iridium. Images of the fractured edge were collected using a JEOL JSM 7100F Field Emission Scanning Electron Microscope with an accelerating voltage of 4 kV.

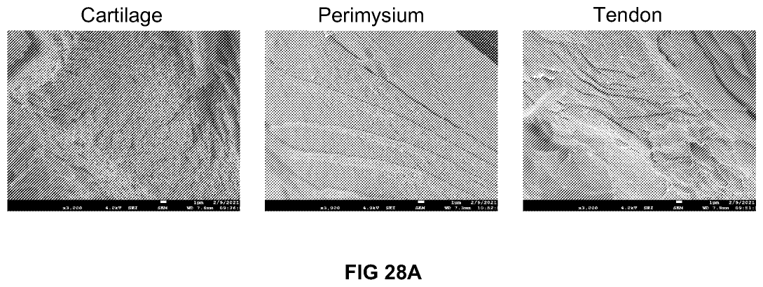

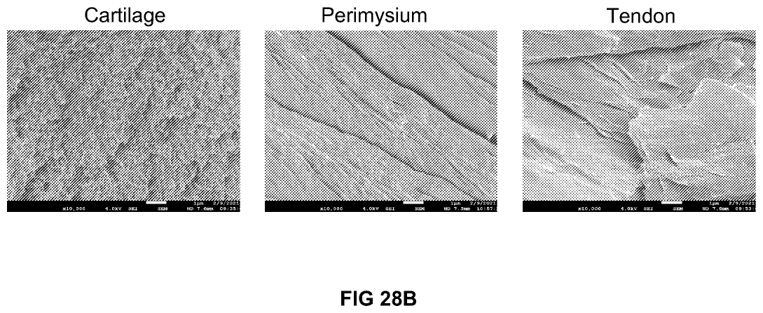

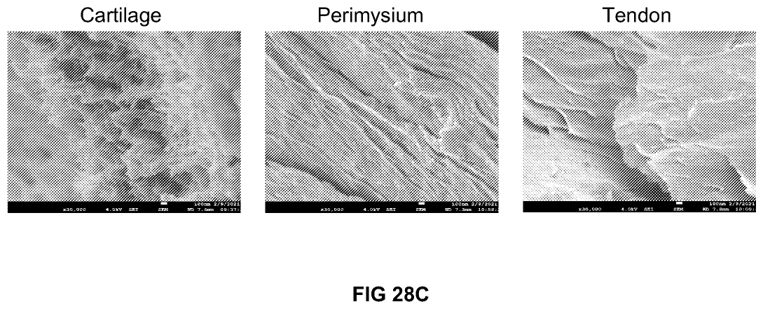

The SEM images taken at 3000×, 10,000× and 30,000× magnifications are shown in FIG. 28. Images of the fractured edge were similar for perimysium, cartilage, and tendon. Perimysium and cartilage have the same dry ingredients in the same ratios, but tendon does not. This similarity may therefore be a result of how the samples were prepared (compressed between glass and an aluminum plate). This method of preparation was necessary to ensure the accuracy and reliability of rheological and tensile measurements.

### Example 21. Non-linear Viscoelastic Behavior of Exemplary PBCTs

Non-linear viscoelastic behavior of exemplary PBCTs were studied by the analysis of the distortion and rotation of elastic Lissajous-Bowditch plots essentially as described in Ramlawi et al. (2021) Pseudo-linear large-amplitude oscillatory shear stress (LAOStress): A delicious gift from Afuega'l Pitu Spanish cheese, in: Proceedings of the 92nd Annual Meeting of The Society of Rheology. Society of Rheology, Bangor and further in Dimitriou et. al (2013) Describing and prescribing the constitutive response of yield stress fluids using large amplitude oscillatory shear stress (LAOStress). J. Rheol. 57,27, and Ewoldt, R. H., 2013. Defining nonlinear rheological material functions for oscillatory shear. J. Rheol. 57, 177-195. This study was used to investigate signatures under large amplitude oscillatory shear stress amplitude sweeps (LAOStress sweeps) that can be useful to differentiate the different PBCTs evaluated.

### Theoretical Basis

In a typical LAOStress experiment, the shear stress is imposed in a rotational shear rheometer according to:

σ(t)=σ₀ cos (ωt)

where σ₀ is the shear stress amplitude, ω is the frequency of the oscillation and t is the time

The resulting strain, γ(t, σ₀, ω), can be represented as a Fourier series, according to (Dimitriou et al., 2013, Describing and prescribing the constitutive response of yield stress fluids using large amplitude):

$$γ ( t ) = \overline{γ} ( ω , {σ}_{0} ) + {σ}_{0} {\sum }_{nodd} [ {J}_{n}^{′} ( ω , {σ}_{0} ) cos ( n ω t ) + {J}_{n}^{*} ( ω , {σ}_{0} ) sin ( n ω t ) ]$$

wherein J′ₙ and J″ₙ represent the storage and loss compliances for the n^{th} harmonic, respectively, and y̅ is the 0^{th} harmonic, which allows the description of a strain signal that is not centered around γ=0 (Ewoldt, 2013).

This allows to decompose the strain response as a sum of an apparent elastic strain, y′, and an apparent plastic strain, y″:

$${γ}^{′} ( t ) = {σ}_{0} {\sum }_{nodd} {J}_{n}^{′} ( ω , {σ}_{0} ) cos ( n ω t ) \\ {γ}^{″} ( t ) = {σ}_{0} {\sum }_{nodd} {J}_{n}^{″} ( ω , {σ}_{0} ) sin ( n ω t )$$

As demonstrated by Dimitriou et al. (2013), it is also possible to obtain local measurements for the compliance within an elastic Lissajous plot. The minimum-stress elastic compliance, J′_{M} is given by:

$${J}_{M}^{′} = \frac{d γ}{d σ} {\vert}_{σ = 0} = {\sum }_{nodd} {( - 1 )}^{( n - 1 ) / 2} {nJ}_{n}^{′}$$

and represents the elastic compliance when σ=0. The large-stress elastic compliance, J′_{L}, is given by:

$${J}_{L}^{′} = \frac{γ}{σ} {\vert}_{σ = {σ}_{0}} = {\sum }_{nodd} {J}_{n}^{′}$$

and represents the elastic compliance when σ=σ₀. A more through discussion can be found in Dimitriou et al. (2013) and Ewoldt (2013).

If J′_{L}≈J′_{M}, the elastic Lissajous plot is roughly elliptical, corresponding to a response within the linear viscoelastic regime. During the transition from linear to non-linear viscoelasticity, distortions in the elastic Lissajous plot can take place. One way to capture the distortion in the elastic Lissajous plot is by introducing the quantity D, given by (Ramlawi et al., 2021):

$$D = \vert \frac{{J}_{L}^{′} - {J}_{M}^{′}}{{J}_{L}^{′}} \vert$$

Another possible way to capture the transition from linear-to-nonlinear viscoelasticity is through the rotation of the elastic Lissajous plots, which is a function by the first harmonic metrics. Defining the complex compliance as

J*₁=\sqrt{(J′₁)²+(J*₁)²}

it is possible to quantify the rotation of the Lissajous plots as:

$$R = \vert \frac{\vert {J}_{1}^{*} \vert - \vert {J}^{*} \vert \vert}{\vert {J}^{*} \vert} \vert$$

where |J*| is the value of |J*₁| when the material is within the linear viscoelastic regime.

### EXPERIMENT AND RESULTS

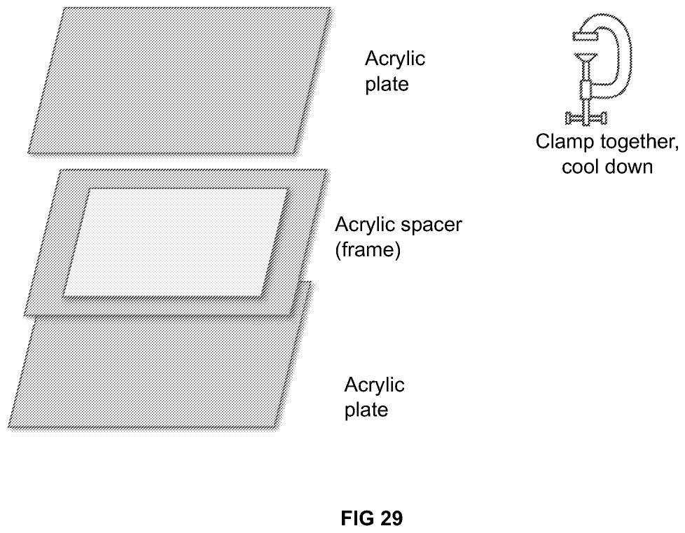

The three exemplary plant-based connective tissues (PBCTS)—cartilage, perimysium, and tendon, were formulated as previously described in Example 14, except that the gels were poured onto an acrylic plate, with a spacer plate mounted on top. A second acrylic plate was placed on top and the plate cassette placed between a clamp (schematic and photograph as shown in FIG. 29A). This ensured consistent thickness throughout the sample.

All experiments were conducted at 20° C. in a TA-DHR-3 stress-controlled rheometer, using 20 mm parallel plates with sandpaper to reduce wall slip effects. Bulk gel samples were cut in 20 mm disks using the corer tool, and the gap used in the rheometric experiments was set by the thickness of the samples, ensuring that a minimum normal load force of 0.5 N was measured by the rheometer's normal force transducer during the sample loading protocol. This was made to ensure full contact between the sample and the measuring geometry of the rheometer, thus reducing wall slip effects. All measurements reported herein correspond to stress-controlled oscillatory sweeps (LAOStress sweeps), with a constant frequency ω=0.5 rad/s. Eight co-sinusoidal cycles of shear stress were performed at each shear stress amplitude, and the results were calculated considering the last two cycles for each shear stress amplitude using Matlab.

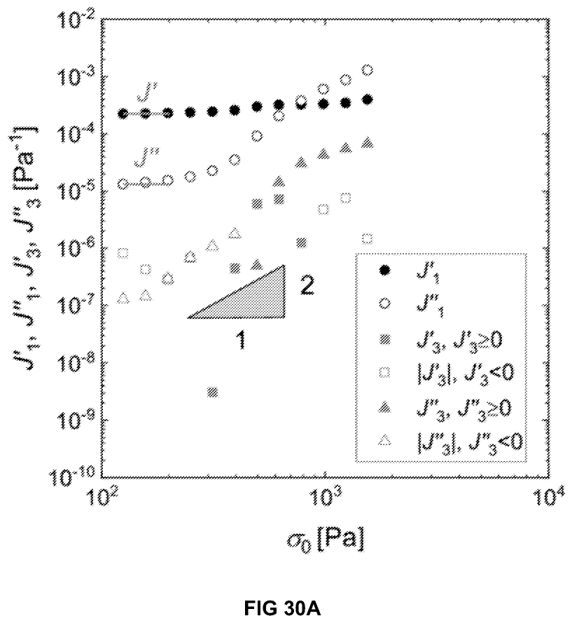

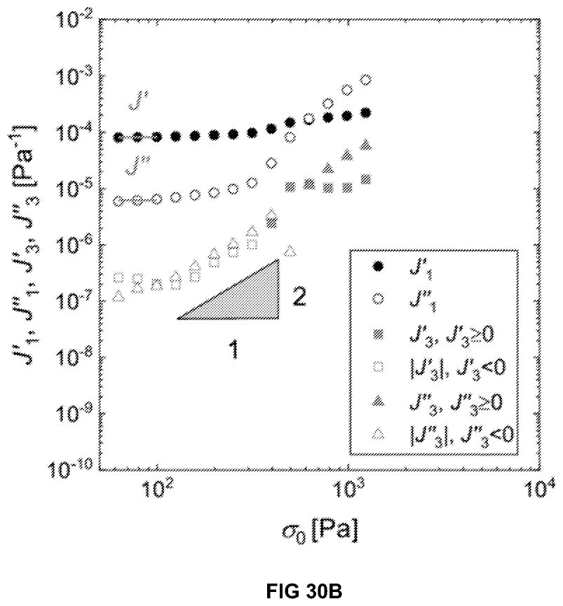

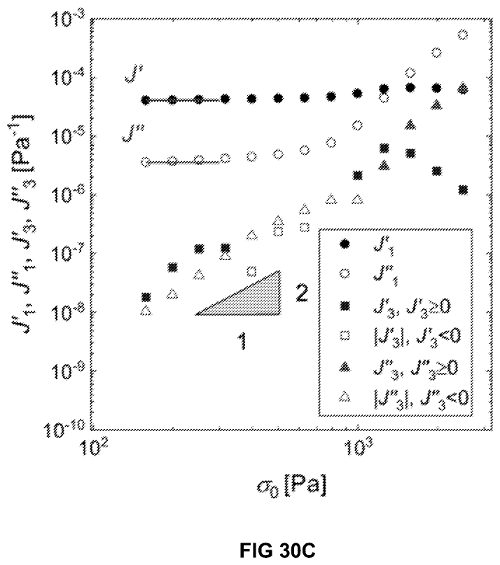

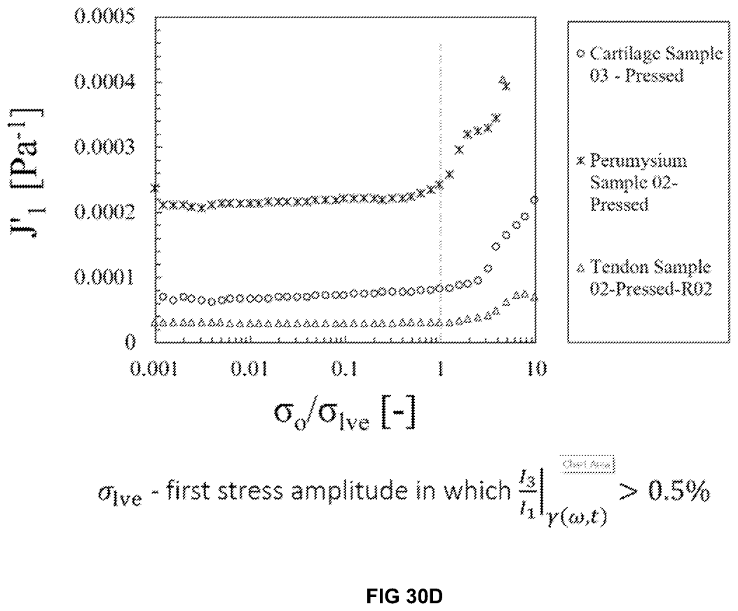

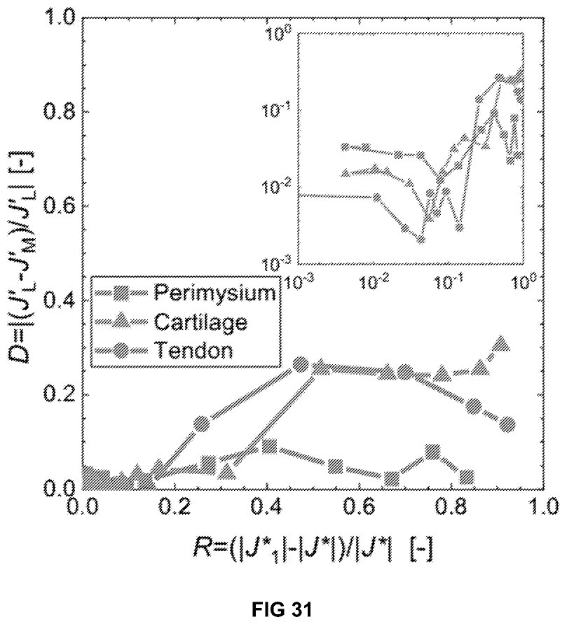

FIG. 30 shows the storage and loss compliances for the first and third harmonics as a function of the shear stress amplitude for the (A) perimysium, (B) cartilage and (C) tendon samples. Only the stress amplitudes in which the third harmonic compliances show an approximate scaling with the square of the shear stress amplitude (i.e., J′₃∝σ₀² and J′₃∝σ₀²) are reported. The values of J′ and J employed in the calculations of the rotation ratio, are illustrated by the red continuous lines. Results suggest that the first harmonic compliance can be used to differentiate the different PBCTs as the three samples yield at different stress amplitudes as further illustrated in FIG. 30D. Additionally, FIG. 31 illustrates the values of the distortion ratio as a function of the rotation ratio for the three PBCTs. It is interesting to note that all materials undergo more rotation that distortion, which suggests that the transition from linear-to-nonlinear viscoelastic behavior happens with a more significant contribution from first harmonic metrics. The inset in FIG. 31 shows the values of D as a function of R in a log-log scale, which magnifies the relationship between the distortion and rotation at low shear stress amplitudes, when the materials are within the SAOS (small amplitude oscillatory shear) and MAOS (medium amplitude oscillatory shear) regimes. The values of D for each one of the three PBCTs are distinctively different from one another when viewed in this log-log scale, suggesting that this can be a useful metric to differentiate the three PBCTs.

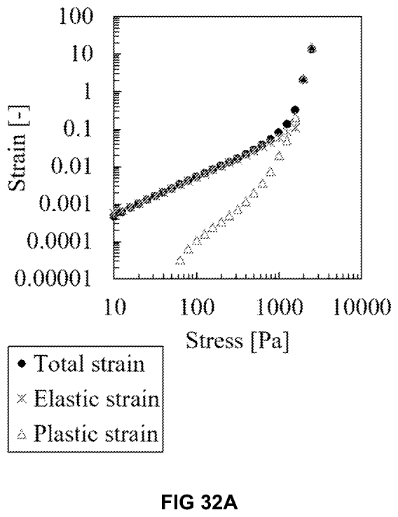

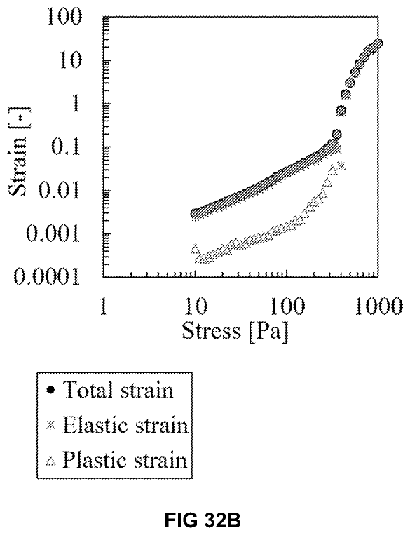

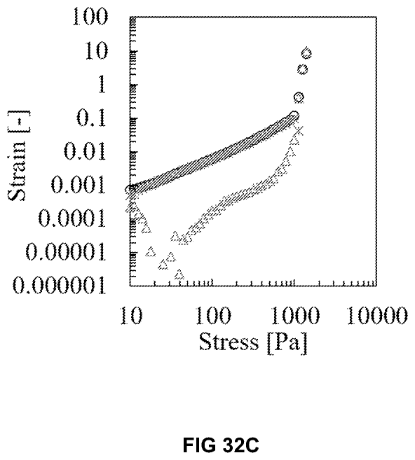

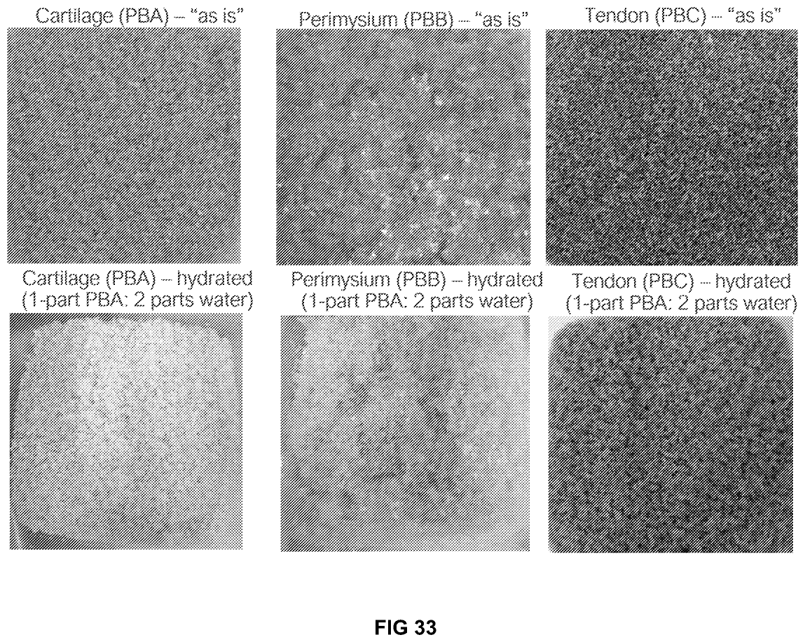

In plots of stress versus strain for the exemplary connective tissue analogs (FIG. 32) it is evident that the three PBCTs are elastic up to the yield point with small contributions from plastic strains.

### Example 22. Incorporation of PBCT's Into plant-based Meat Formulations

Several different sizes and incorporation levels of PBCTs in plant based meat analog are being tested using team evaluation, expert panels and sensory descriptive panelist are asked to pick-out the optimal products with the least grittiness and optimal texture.

Using commonly used fractionation technologies as highlighted in Examples 9-12, PBCTs of particle size ranging from about 0.75 mm, about 1 mm, about 1.5 mm, about 2 mm and about 2.5 mm (as determined by the cut-off limit of the mesh used) will be tested for incorporation into various meat analog formulations. Incorporation amounts of one or more pre-hydrated PBCTs to be tested will range from 0.5%, 1%, 1.5% and 2% and 3% by weight of the total product weight (see Table 9). Experiments are designed using one or more of the exemplary PBCTs in different ratios by weight of PBA—Cartilage, PBB—Perimysium and PBC—Tendon as shown below.

TABLE 10
Study design: % incorporation of pre-hydrated PBCTs into plant based
meat formulations (A - Cartilage, B - Perimysium, C - Tendon)

Control
Negative control (0% ingredient inclusion)
Individual Components
A (3%)
B (3%)
C (3%)
Two ingredient systems
A (1.5%) and B (1.5%)
A (1.5%) and C (1.5%)
B (1.5%) and C (1.5%)
Three ingredient systems
A (2%), B (0.5%), C (0.5%)
A (0.5%), B (2%), C (0.5%)
A (0.5%), B (0.5%), C (2%)
A (1%), B (1%), C (1%)

The specific steps used to hydrate and in what order, amounts and method of mixing will be optimized for each meat analog formulation. To be used in the formulations, the PBCT formulation comprising one or more of the PBCTs is hydrated with 2 parts water at ambient temperature and set aside for 5 minutes (see FIG. 32). Textured ingredients are added to the bowl of a stand mixer and mixed for 30 sec at speed 2 to combine. The PBCT formulation is then combined with the plant-based meat formulation of choice.

In some cases, combinations of pre-hydrated PBCTs as provide in Table 9 will be mixed with one or more components of the final product in a thermomixer and kneaded on reverse at speed 3 for 5 minutes. The mixture will then be incorporated into the meat analog formulation.

1. A method of preparing a connective tissue analog, the method comprising the steps of:
a) combining ingredients comprising a hydrocolloid base and a dietary fiber additive to form a substantially homogenous mixture;
b) hydrating the substantially homogenous mixture to form a hydrated gel;
c) at least partially dehydrating the gel to obtain an at least partially dehydrated gel comprising a non-covalently cross-linked polymer network, thereby forming the connective tissue analog.

2. The method of claims 1, wherein step (a) further comprises combining at least one of a protein, a crosslinking agent, a flavoring agent, a dietary fat, or a combination thereof.

3. The method of claim 1, wherein the hydrocolloid base comprises a carrageenan, κ-carrageenan, agar-agar, pectin, alginate, gellan gum, glucomannan, a modified starch, methyl cellulose, hydroxypropyl methyl cellulose, carboxymethyl cellulose, methyl cellulose, gelatin, guar gum, locust bean gum, tara gum, gum tragacanth, gum ghatt, gum Arabic, analogs or derivatives thereof, or any combination thereof and the dietary fiber additive comprises glucomannan, guar gum, gum Arabic, xanthan gum, a psyllium, a chitin, an inulin, a pectin, a dextrin, a starch, a cellulose, a hemicellulose, a lignin, a citrus fiber extract, analogs or derivatives thereof, or any combination thereof.

4. (canceled)

5. The method of claim 1, wherein the ingredients comprise in weight ratio, 1-10 parts a carrageenan and 0.1-10 parts glucomannan and optionally 0.1-10 parts gum Arabic.

6. The method of claim 1, wherein the ingredients further comprise a protein, wherein the protein is derived from wheat, pea, soy, potato, chickpea, rice, corn, bean, sorghum, quinoa, fruits, vegetables, seaweed, bacteria, yeast, mushrooms, any flour thereof, or any combination thereof, a crosslinking agent, wherein the crosslinking agent comprises a dietary enzyme, a transglutaminase, a laccase, or any combination thereof, or both.

7. The method of claim 1, wherein the ingredients comprise in weight ratio, 1-20 parts a protein, 0.1-10 parts a carrageenan, and optionally 0.1-10 parts gum Arabic and optionally 0.1-10 parts glucomannan.

8. (canceled)

9. The method of claim 1, wherein the substantially homogenous mixture is substantially devoid of spun protein fibers.

10. The method of claim 1, wherein step (b) further comprises the steps of adding a hydration agent, mixing while heating to a homogenous consistency, cooling, and setting to form a gel.

11. The method of claim 10, further comprising casting the hydrated gel into a sheet form or block form and optionally dehydrating the sheet or block form to form a dehydrated sheet form or a dehydrated block form.

12. The method of claim 11, further comprising comminuting the hydrated gel to form gel particles or comminuting the dehydrated sheet form or the dehydrated block form.

13. (canceled)

14. (canceled)

15. The method of claim 1, wherein the dehydrating the gel comprises subjecting the hydrated gel to a dehydration condition for a time sufficient to achieve about 10% up to about 100% dehydration of the gel.

16. The method of claim 15, wherein subjecting the gel to a dehydration condition comprises placing the gel in an oven, a dryer, a microwave oven, a freeze dryer, a smoker, a stove or range, a desiccator, an air fryer or any combination thereof.

17. The method of claim 1, wherein dehydrating the hydrated gel comprises convective drying in a temperature range from about 40° C. to about 50° C. for a time period of about 4 hours to about 24 hours.

18. The method of claim 12, wherein the comminuting comprises grinding, milling, rolling, chopping, cutting, pulverizing, breaking, pounding, abrading, rasping or any combination thereof.

19. The method of claim 1, wherein the gel particles have an average width or a diameter of about 0.1 to about 10 mm, about 0.2 mm to about 10 mm, about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.5 mm, about 0.1 to about 0.3 mm, about 0.5 to about 2 mm, about 0.75 to about 2 mm, about 0.75 to about 2.5 mm, about 0.75 to about 3 mm, about 1 mm to about 2 mm, about 2 mm to about 3 mm, about 3 mm to about 4 mm, about 4 mm to about 5 mm, about 5 mm to about 6 mm, about 6 mm to about 7 mm, about 7 mm to about 8 mm, about 8 mm to about 9 mm, about 9 mm to about 10 mm, less than about 10 mm, less than about 9 mm, less than about 8 mm, less than about 7 mm, less than about 6 mm, less than about 5 mm, less than about 4 mm, less than about 3 mm, less than about 2 mm, less than about 1.5 mm, less than about 1 mm, less than about 0.5 mm, about 0.25 mm. about 0.5 mm, about 0.75 mm, about 1 mm, about 1.25 mm, about 1.5 mm, about 1.75 mm, about 2 mm, about 2.5 mm, about 3 mm, about 4 mm, about 5 mm, about 6 mm, about 7 mm, about 8 mm, about 9 mm, or about 10 mm.

20. The method of claim 1, further comprising rehydrating the at least partially dehydrated gel to at least about 90 wt %, or to at least about 85 wt %, or to at least about 80 wt %, to at least about 75 wt %, to at least about 70 wt %, to at least about 65 wt %, to at least about 60 wt %.

21. The method of claim 1, wherein the hydrating or rehydrating comprises adding a hydration agent to the dehydrated or partially dehydrated gel, wherein the hydration agent is water, steam, a buffered water, a non-aqueous solvent, a gelling agent or any combination thereof, wherein the gelling agent comprises an inorganic ion, an organic ion, a crosslinking agent, a sugar, a salt, an acid, a base, or any combination thereof.

22-26. (canceled)

27. The method of claim 1, wherein upon rehydrating the at least partially dehydrated gel, the connective tissue analog has at least one of the following: a Young's Modulus ranging from about 50 kPa to about 500 kPa; hydrogel-like mechanical properties; and hydrogel-like rheological properties.

28. The method of claim 1, wherein the connective tissue analogs are made without an extrusion or micro-extrusion step.

29. A meat analog comprising the connective tissue analog of claim 1 combined with additional plant-based ingredients to form a plant-based meat product.

30. A connective tissue analog composition comprising an at least partially dehydrated and comminuted gel obtained from a gel formed by hydration of a substantially homogeneous mixture comprising a hydrocolloid base and a dietary fiber additive.

31-46. (canceled)

47. A method of preparing a meat analog composition for human or animal consumption, the method comprising:
a) obtaining at least a connective tissue analog comprising an at least partially dehydrated and comminuted gel obtained from a gel formed by hydration of a substantially homogeneous mixture comprising a hydrocolloid base and a dietary fiber additive; and
b) combining the connective tissue analog with a plant-based meat-like base to form the meat analog.

48-78. (canceled)

79. A plant-based connective tissue cartilage-like or connective tissue perimysium-like analog comprising, in weight ratio, 1-10 parts k-carrageenan, 0.1 -10 parts glucomannan and 0.1-10 parts gum Arabic or a plant-based connective tissue elastin-like analog comprising, in weight ratio, 1-20 parts protein, 0.1-1 part a carrageenan, and 0.1-1 part of gum Arabic; wherein the protein is soy protein, pea protein, or a mixture of soy protein and pea protein or a plant-based connective tissue tendon-like analog comprising, in weight ratio, 1 part rice protein, 1 part k-carrageenan and 1 part glucomannan.

80. (canceled)

81. The plant-based tendon analog of claim 79, wherein the rice protein comprises a protein selected from the group consisting of Oryzatein 80 (Original 80), Oryzatein Silk 80, Oryzatein Silk 90, and any combinations thereof.

82. The plant-based cartilage or perimysium analog, the plant-based connective tissue elastin-like analog, or the plant-based tendon analog of claim 79, in particle form.

83-86. (canceled)
